(19) United States
(12) Patent Application Publication
(10) Pub. No.: US 2015/0058744 A1
(43) Pub. Date: Feb. 26, 2015

(54) SYSTEMS AND METHODS FOR MANAGING GRAPHICAL USER INTERFACES

(71) Applicants: Ashvin Dhingra, Diamond Bar, CA (US); Brandon Miniman, Glen Mills, PA (US); Joshua Solan, Wayne, PA (US); Rohit Talati, Irvine, CA (US)

(72) Inventors: Ashvin Dhingra, Diamond Bar, CA (US); Brandon Miniman, Glen Mills, PA (US); Joshua Solan, Wayne, PA (US); Rohit Talati, Irvine, CA (US)

(21) Appl. No.: 13/973,955

(22) Filed: Aug. 22, 2013

(51) Int. Cl. G06F 3/0484

(52) U.S. Cl. CPC G06F 3/04842
USPC 715/747

(57) ABSTRACT

A system and method for managing graphical user interfaces is disclosed. In one aspect, the system is downloadable to a mobile device. The system provides a user with an interface for selecting a graphical user interface from a number of interfaces stored on a server. The available interfaces may include a number of different graphical and interface elements, and widgets. The system permits the downloading of an interface, and the application thereof to a user's device. The system is capable of integrating the downloaded interface with the underlying operating system. In another aspect, the system provides users with tools to customize the selected graphical user interface. In another aspect, an exemplary widgets, and combinations thereof with themes are disclosed.

Two Computer Program Listings, illustrating sample configuration files relating to the disclosed systems and methods, are attached hereto as Appendix A and Appendix B. The entire contents of Appendix A and Appendix B are incorporated by reference herein.

### FIELD OF INVENTION

This invention relates to systems and methods for managing and customizing graphical user interfaces on various devices.

### BACKGROUND

Recent years have seen a proliferation of computing devices into almost every aspect of human activity. Mobile devices, such as smartphones, tablets, ultrabooks, netbooks, and other portable computers now occupy a significant portion of the market previously dominated by mainframe and desktop computers. Many other devices, as varied as refrigerators, televisions, and personal fitness trackers now include computer processors.

While some computing devices require no user interaction, many others are designed to interact with users, frequently through interfaces of various forms. Moreover, even hidden computing devices, such as temperature sensors, frequently output data that will be presented to a user. Other devices, such as smartphones, naturally require robust graphical user interfaces to present users with information and to accept user inputs.

Originally, electronic devices included dedicated interfaces designed to accept a limited number of user inputs. For example, early handheld video games came with several physical buttons, such as directional arrows, to accept user commands, and provided output via several LEDs or an unsophisticated Liquid Crystal Display (“LCD”). Similarly, early cordless and cellular phones were able to accept instructions to dial a phone number via a keypad, but not much else. These phones could be, at best, expected to display the number being dialed, and would not provide other information. Over time, as computing technology improved, user interfaces became more robust, beginning with desktop computers and evolving with the significant shift to mobile computing occurring in the early part of the 21^{st} century.

While early computing devices were, in essence, dedicated hardware modules preconfigured for a certain number of inputs and outputs, many modern devices include general purpose computers that may be customized for specific operations and user requirements. On the component level, this trend has resulted in the inclusion of more microprocessors and less custom-purpose designed chips and electronics. Using microprocessors in electronic devices frequently saves design costs for the manufacturer and enables products to be updated or reconfigured through the application of firmware or software updates.

Devices that include microprocessors frequently also comprise several software components, each performing a separate function. For ease of explanation, software components are sometimes broken up into several “layers”, which together with the hardware, comprise the computing portion of the device. Referring to FIG. 1, which illustrates one embodiment of a computing device 100, layer 110 represents the hardware components, such as, for example, the microprocessor, cellular antenna, and touchscreen display. Layer 120 is the operating system, which includes drivers 130 used to make the OS work with the hardware. As illustrated in FIG. 1, lying on top of the OS layer 120 are GUI 140 and Applications 150. GUI 140 may be provided as part of the OS, or may be added to the device. Similarly, Applications 150 may come preinstalled with the device, or may be added by the user at their convenience. Both the GUI 140 and Applications 150 may be accessible by the user.

In order to facilitate interactions with a user, a computing system may include a Graphical User Interface (“GUI”) used to accept user inputs and output visual data to the user. GUIs may be provided via an Operating System (“OS”) or as a standalone software application. Examples of Operating Systems that provide GUIs include Microsoft Windows, Google's Android, and Apple's iOS.

While the GUIs in many modern Operating Systems provide a basic level of functionality, many users are not satisfied with the “stock” GUI of their OS, and wish to customize their GUI or to build a brand new one. The desire for customizable GUIs has led to the creation of applications known as “Launchers” in Google's Android ecosphere. A Launcher typically does not remove the underlying OS or GUI. Rather, a Launcher overlays the pre-existing interface with a new GUI, which frequently comprises graphical design and arrangement of content different from that of a standard OS GUI.

While Launchers provide new looks and interfaces for the devices, they frequently suffer from several drawbacks. Launchers require a significant amount of work from the user in order to prepare a desired interface. Further, Launchers generally suffer from compatibility issues when applied to various devices, rendering the interfaces inoperable or buggy. Moreover, Launchers suffer from major compatibility issues when users attempt to include widgets, controls, and indicators into their custom interface. In addition, Launchers sometimes render underlying software inoperable, decreasing the usefulness of the device.

It is therefore an object of the present invention to provide a GUI management system without the drawbacks of previously available user interface systems.

### SUMMARY

In one embodiment, the system disclosed herein enables users to manage and customize graphical user interfaces on various devices. In one aspect, the system provides an interface for browsing, searching, or locating preconfigured graphical user interfaces. The preconfigured graphical user interfaces may be located locally or remotely. In another aspect, the system provides users with a preview of the interface, and obtains data objects corresponding to the interface. In another aspect, the system applies a preconfigured graphical user interface to the device. In another aspect, the system provides customization options for the graphical user interface. In another aspect, the system provides for “1-click” application of themes to various devices. In another aspect, the system permits saving and exporting of customized interfaces.

In another embodiment, the system provides elements of graphical user interfaces, including elements referred to as widgets. In one aspect, the widgets can be integrated into themes and connected to the underlying device and its operating system. In another aspect, the system provides widget configuration interfaces while continuing to display the widget being customized. In another aspect, the displayed widget is updated in real time in response to user customization. In another aspect, a software architecture for facilitating live previews of customizable widgets and themes is disclosed.

In another embodiment, the system provides widget creation and customization tools. In one aspect, the tools allow significant customization of the appearance of a widget, including its shape, color, style, and background. In another aspect, the system provides the ability to display various kinds of information on the widget, such as, for example, information obtained from the device or its operating system. In another aspect, the system provides the ability to construct widgets that respond to user input or interaction.

In certain embodiments, graphical user interfaces may be preconfigured together with widgets to form themes, eliminating burdensome configuration tasks by the user and creating a tested, seamless, user experience. Examples of themes, including screenshots and descriptions, are provided throughout the specification. In another embodiment, an online repository of preconfigured themes is provided.

### BRIEF DESCRIPTION OF THE DRAWINGS

FIG. 1 illustrates one embodiment of a computing device abstracted into several layers.

FIG. 2 provides a more detailed illustration of an embodiment of a mobile operating system, and provides context for one embodiment of the present invention.

FIG. 3 illustrates various components of the preferred embodiment of the present invention.

FIG. 4 illustrates certain components of a theme in the preferred embodiment, and various methods of storing information relating thereto.

FIG. 5 is a flowchart illustrating application of a theme to a device by the disclosed system in the preferred embodiment.

FIG. 6A is a flowchart illustrating one embodiment of a process used to save widget configuration.

FIG. 6B is a flowchart illustrating one embodiment of a process used to restore widget configuration.

FIG. 6C illustrates two API methods used to save and restore widgets in the preferred embodiment.

FIG. 7 illustrates one embodiment of model hierarchy of the user interface layer of the disclosed system.

FIG. 8 is a flowchart illustrating the various processes and steps that the disclosed system in the preferred embodiment may perform in response to a user action

FIG. 9 illustrates one embodiment of the main menu of the Themer App.

FIG. 10 illustrates one embodiment of the Browse Themes menu.

FIG. 11 illustrates one embodiment of the individual theme selection screen.

FIG. 12 illustrates one embodiment of a theme list.

FIG. 13 illustrates one embodiment of the Search interface.

FIG. 14 illustrates one embodiment of the My Themes menu.

FIG. 15 illustrates one embodiment of the Settings menu.

FIG. 16 illustrates one view of an embodiment of the Account Settings menu.

FIG. 17 illustrates a second view of an embodiment of the Account Settings menu.

FIG. 18 illustrates a third view of an embodiment of the Account Settings menu.

FIG. 19 illustrates a fourth view of an embodiment of the Account Settings menu.

FIG. 20 illustrates one embodiment of the Launcher Settings menu.

FIG. 21 illustrates one view of an embodiment of the Desktop component of the Launcher Settings menu.

FIG. 22 illustrates a second view of an embodiment of the Desktop component of the Launcher Settings menu.

FIG. 23 illustrates an embodiment of the Desktop Gridsize component of the Launcher Settings menu.

FIG. 24 illustrates an embodiment of the Desktop Margins component of the Launcher Settings menu.

FIG. 25 illustrates an embodiment of the Desktop Number Of Homescreens component of the Launcher Settings menu.

FIG. 26 illustrates an embodiment of the Desktop Wallpaper Transition component of the Launcher Settings menu.

FIG. 27 illustrates one embodiment of the Folders component of the Launcher Settings menu.

FIG. 28 illustrates one embodiment of the Folder Preview Background component of the Launcher Settings menu.

FIG. 29 illustrates one embodiment of the Expanded Folder Preview Background component of the Launcher Settings menu.

FIG. 30 illustrates one embodiment of the Dock component of the Launcher Settings menu.

FIG. 31 illustrates one embodiment of the Icons component of the Launcher Settings menu.

FIG. 32 illustrates one embodiment of the Edit Icon Shortcut component of the Launcher Settings menu.

FIG. 33 illustrates one embodiment of the Export Theme component of the Launcher Settings menu.

FIG. 34 illustrates one embodiment of the Widget Settings menu.

FIG. 35 illustrates the preferred embodiment of system architecture for the Everything Widget.

FIG. 36A is a flowchart illustrating one embodiment of an automatic settings process for the Everything Widget Weather Provider based on user and locale changes.

FIG. 36B is a flowchart illustrating one embodiment of an automatic settings process for the Everything Widget Time Provider based on user and locale changes.

FIG. 36C is a flowchart illustrating one embodiment of an automatic settings process for the Everything Widget Unread Email Provider based on user and locale changes.

FIG. 37 illustrates one example of interaction between a launcher and the Everything Widget.

FIG. 38 illustrates one embodiment of a theme comprising several Everything Widgets.

FIG. 39 illustrates one embodiment of a theme comprising several Everything Widgets reacting to a long press on one of the widgets.

FIG. 40 illustrates one embodiment of a theme comprising several Everything Widgets with the editor bar overlay and a selected widget.

FIG. 41 illustrates one embodiment of the editor bar overlay sliding to a different position.

FIG. 42 illustrates one embodiment of the overflow menu from the editor bar.

FIG. 43 illustrates one embodiment of the Saved Widgets component of the editor bar's overflow menu.

FIG. 44 illustrates one embodiment of the Save component of the editor bar's overflow menu.

FIG. 45 illustrates one embodiment of the List Objects component of the editor bar's overflow menu.

FIG. 46 illustrates one embodiment of the available Battery data providers.

FIG. 47 illustrates one embodiment of the available Date data providers.

FIG. 48 illustrates one embodiment of the available Shapes data providers.

FIG. 49 illustrates one embodiment of the available System data providers.

FIG. 50 illustrates one embodiment of the available Time data providers.

FIG. 51 illustrates one embodiment of the available Weather data providers.

FIG. 52 illustrates one embodiment of the hotspot options menu.

FIG. 53 illustrates one embodiment of the available hotspot activities.

FIG. 54 illustrates one embodiment of the available hotspot shortcuts.

FIG. 55 illustrates one embodiment of the available hotspot Themer actions.

FIG. 56 illustrates one embodiment of the widget positioning interface.

FIG. 57 illustrates one embodiment of available settings for a displayed battery bar.

FIG. 58 illustrates one embodiment of available settings for a displayed battery circle.

FIG. 59 illustrates one embodiment of available settings for a displayed day of the week.

FIG. 60 illustrates one embodiment of available settings for a displayed week of the year.

FIG. 61 illustrates one embodiment of an options menu for a displayed date.

FIG. 62 illustrates one embodiment of available settings for a displayed date.

FIG. 63 illustrates one embodiment of available settings for a displayed email component.

FIG. 64 illustrates one embodiment of an options menu for a displayed image.

FIG. 65 illustrates one embodiment of a photo attachment interface.

FIG. 66 illustrates one embodiment of available settings for a displayed missed calls indicator.

FIG. 67 illustrates one embodiment of available settings for a displayed circle shape.

FIG. 68 illustrates one embodiment of available settings for a displayed line shape.

FIG. 69 illustrates one embodiment of available settings for a displayed rectangle shape.

FIG. 70 illustrates one embodiment of available style settings for alignment of a displayed data provider.

FIG. 71 illustrates one embodiment of available style settings for selecting the angle of a displayed data provider.

FIG. 72 illustrates one embodiment of available style settings for selecting colors of a displayed data provider.

FIG. 73 illustrates one embodiment of available font-related style options for a displayed data provider.

FIG. 74 illustrates one embodiment of a font-selection menu for a displayed data provider.

FIG. 75 illustrates one embodiment of a font loading screen for a displayed data provider.

FIG. 76 illustrates one embodiment of a style-related options menu for a displayed data provider.

FIG. 77 illustrates one embodiment of available settings for selecting the text-size of a displayed data provider.

FIG. 78 illustrates one embodiment of available settings for selecting the text style of a displayed data provider.

FIG. 79 illustrates one embodiment of a text-entry interface for a displayed data provider.

FIG. 80 illustrates one embodiment of an options menu for a displayed time data provider.

FIG. 81 illustrates one embodiment of available settings for a displayed time data provider.

FIG. 82 illustrates one embodiment of an options menu for a displayed unread e-mails data provider.

FIG. 83 illustrates one embodiment of an options menu for a displayed unread SMS data provider.

FIG. 84 illustrates one embodiment of available settings for a displayed unread SMS data provider.

FIG. 85 illustrates one embodiment of available text settings for a displayed weather conditions data provider.

FIG. 86 illustrates one embodiment of available icon settings for a displayed weather conditions data provider.

FIG. 87 illustrates one embodiment of a custom pack loading interface for a displayed weather conditions data provider.

FIG. 88 illustrates one embodiment of an icon set pack selection interface for a displayed conditions data provider.

FIG. 89 illustrates one embodiment of available settings for a displayed humidity indication data provider.

FIG. 90 illustrates one embodiment of available settings for a displayed weather location data provider.

FIG. 91 illustrates one embodiment of available settings for a displayed temperature data provider.

FIG. 92 illustrates one embodiment of available settings for a displayed WiFi data provider.

FIG. 93 illustrates one embodiment of a theme including several Everything Widgets and a Simple RSS Widget.

FIG. 94 illustrates one embodiment of a theme including a Simple Calendar Widget and a Simple Dialer Widget.

FIG. 95 illustrates one embodiment of a general in-theme menu.

FIG. 96 illustrates one embodiment of an in-theme Shortcuts menu.

FIG. 97 illustrates one embodiment of an in-theme Themer Actions menu.

FIG. 98 illustrates one embodiment of an in-theme Wallpaper options menu.

FIG. 99 illustrates one embodiment of an in-theme Widgets menu.

FIG. 100 illustrates one embodiment of a settings menu for a Simple Calendar Widget.

FIG. 101 illustrates one view of an appearance configuration menu for a Simple Calendar Widget.

FIG. 102 illustrates a second view of an appearance configuration menu for a Simple Calendar Widget.

FIG. 103 illustrates one embodiment of a widget backup interface.

FIG. 104 illustrates one embodiment of a calendar configuration menu for a Simple Calendar Widget.

FIG. 105 illustrates one embodiment of an information provision and request interface for a Simple Calendar Widget.

FIG. 106 illustrates one embodiment of an additional settings menu for a Simple Calendar Widget.

FIG. 107 illustrates one embodiment of a tasks settings menu for a Simple Calendar Widget.

FIG. 108 illustrates one embodiment of a configuration menu for a Simple Dialer Widget.

FIG. 109 illustrates one embodiment of a general settings menu for a Simple RSS Widget.

FIG. 110 illustrates one embodiment of an appearance settings menu for a Simple RSS Widget.

FIG. 111 illustrates one embodiment of an RSS feed management interface for a Simple RSS Widget.

FIG. 112 illustrates one embodiment of a widget settings menu for a Simple RSS Widget.

### DETAILED DESCRIPTION

In general terms, the system disclosed herein enables users to manage and customize graphical user interfaces on various devices. In the preferred embodiment, the system is implemented as one or more software modules, downloadable onto a mobile computing device. Once installed on the mobile device, the system enables users to browse or search for various preconfigured graphical user interfaces, also referred to as ‘themes’; to download the themes; customize the themes; and to export the themes for distribution and use by others. Due to the flexibility and many uses of the disclosed system, ‘users’ as applied herein may refer to end users of a mobile device or an application, or to designers of themes and graphical user interfaces. In various embodiments, the disclosed system includes elements of graphical user interfaces, also referred to as widgets, which can be integrated into themes and connected to the underlying device and its operating system. In certain embodiments, the themes may be preconfigured together with widgets, eliminating burdensome configuration tasks by the user and creating a tested, seamless, user experience. Examples of themes, including screenshots and descriptions, are provided throughout the specification.

In various embodiments, the invention is also applicable to numerous computer systems, including mobile devices such as smartphones, tablets, and notebook computers, desktop and mainframe computing systems, multimedia devices, including media players and televisions, and a number of other devices that require graphical user interfaces. At times, various embodiments of the invention may be referred to as the “disclosed system” herein. One of ordinary skill in the art will recognize that the disclosed system may also be implemented in hardware, firmware, a combination thereof, or a combination thereof with software.

### Themer System and App

In the preferred embodiment, the disclosed system is configured to work with a mobile operating system, such as Android. In the context of mobile operating systems, and in the interests of clarity and brevity, several embodiments of the disclosed system are referred to as the “Themer App” herein. This moniker is not intended to unnecessarily narrow or constrain the invention, but rather is used to provide ease of understanding and some context for the various embodiments. One of ordinary skill in the art will understand that a Themer App embodiment is not limited to mobile devices, and can function with many other computing platforms.

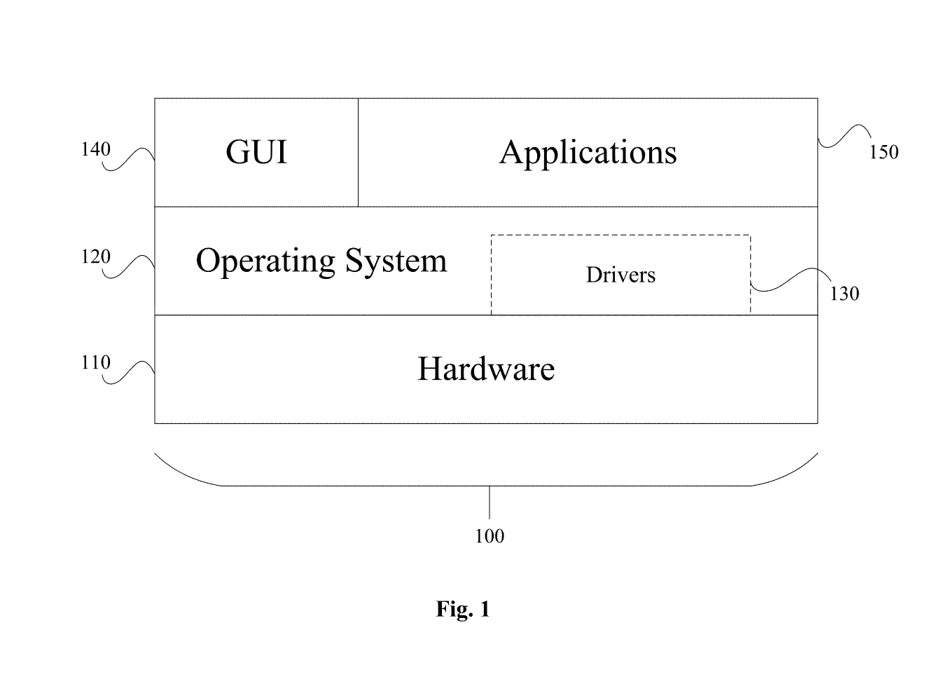

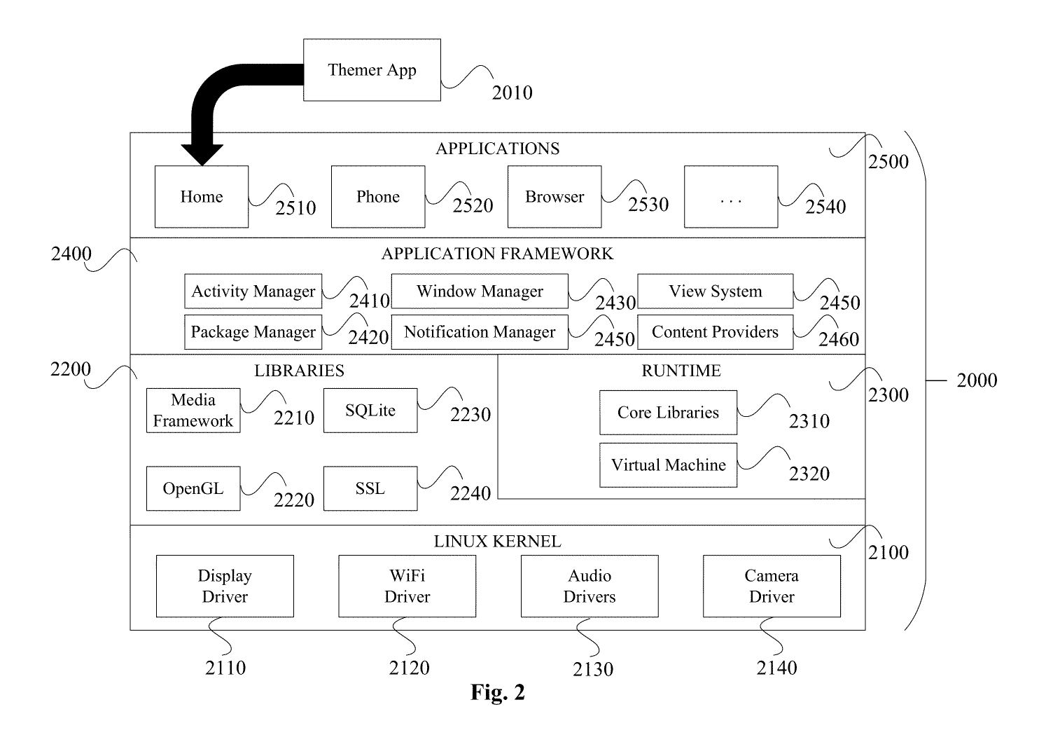

Turning to the architecture of the disclosed system, FIG. 1, described above, illustrates a very general snapshot of several layers of a computing device that includes a graphical user interface. FIG. 2 provides a more detailed illustration of a mobile operating system, and provides context for one embodiment of the present invention. In FIG. 2, block 2000 illustrates the various layers of a Linux based mobile operating system, such as Google's Android. Layer 2100 is the Linux kernel, a compilation of various software modules responsible for interfacing with computer hardware. Layer 2100 includes modules such as Display Driver 2110, WiFi Driver 2120, Audio Drivers 2130, and Camera Driver 2140. Drivers typically provide hardware-specific computer interfaces that allow an operating system to interact with hardware components from different manufacturers. In this example, Display Driver 2110 enables the OS and applications to provide an output to the device's display; WiFi Driver 2120 enables the device to function over a wireless network, Audio Drivers 2130 enable the device to output audio through a speaker, headphone jack, or other audio interface; and Camera Driver 2140 enables the device to capture video or pictures through its cameras.

Layer 2200 illustrates the various Libraries comprising the operating system. Such libraries include Media Framework 2210, SQLite 2230, OpenGL 2220, and SSL 2240. Libraries typically appear at a layer higher than the Kernel or drivers, and are usually not hardware-specific. However, for improved performance, the various libraries may be optimized to function with a specific operating system. Thus, while Secure Socket Layer (“SSL”) libraries may be found on a large number of computing platforms, the SSL library 2240 illustrated in FIG. 2 is preferably optimized for use with the specific operating system depicted in FIG. 2. In this example, Media Framework library 2210 provides tools for media creating and playback, including codecs such as H.263, MP3, and AAC. OpenGL library 2220 provides 2-Dimensional and 3-Dimensional computer graphics functionality. SQLite library 2230 is a database engine, typically used on mobile and personal computing platforms. SSL library 2240 enables Secure Socket Layer encryption and communication over networks.

In FIG. 2, Runtime layer 2300 is illustrated as occupying part of the Libraries layer 2200, but without interacting with the Linux Kernel 2100. In the illustrated implementation, Runtime layer 2300 does not interface with the Kernel 2100 for security reasons, so as to prevent third party applications from having virtually direct control over hardware components. However, in other implementations of operating systems, the runtime component may interface with the Kernel. Turning back to FIG. 2, Virtual Machine 2320 provides a common runtime environment across various devices running the operating system that may execute applications. One purpose of Virtual Machine 2320 is to provide a standard runtime platforms for developers, instead of having developers worry about various hardware configurations. Core Libraries 2310 provide common Application Programming Interfaces (“APIs”) for applications and developers, such as data structures, file access, and graphics. Runtime layer 2300 interfaces with Libraries layer 2200 and draws on various libraries to the extent they are required by various running applications and processes.

In the illustrated embodiment, Application Framework layer 2400 runs on top of Libraries layer 2200 and Runtime layer 2300. Some of the illustrated framework and service components in layer 2400 include Activity Manager 2410, Package Manager 2420, Window Manager 2430, Notification Manager 2450, View System 2450, and Content Providers 2460. Typically, these services operate in the background to maintain the operating system in a state intended by its creators. On certain occasions, third party applications may access some of the services from layer 2400, but this is a relatively rare occurrence.

In FIG. 2, Applications layer 2500 lies on top of Application Framework layer 2400. Applications layer 2500 comprises both software applications provided with the operating system and applications provided by third-parties. Some of the applications in layer 2500 may be the Home application 2510, Phone application 2520, Browser application 2530, and numerous other applications indicated with box 2540. While most applications in layer 2500 will have a graphical output to interface with the user, this is not a requirement. Indeed, some applications may function in the background without a graphical component.

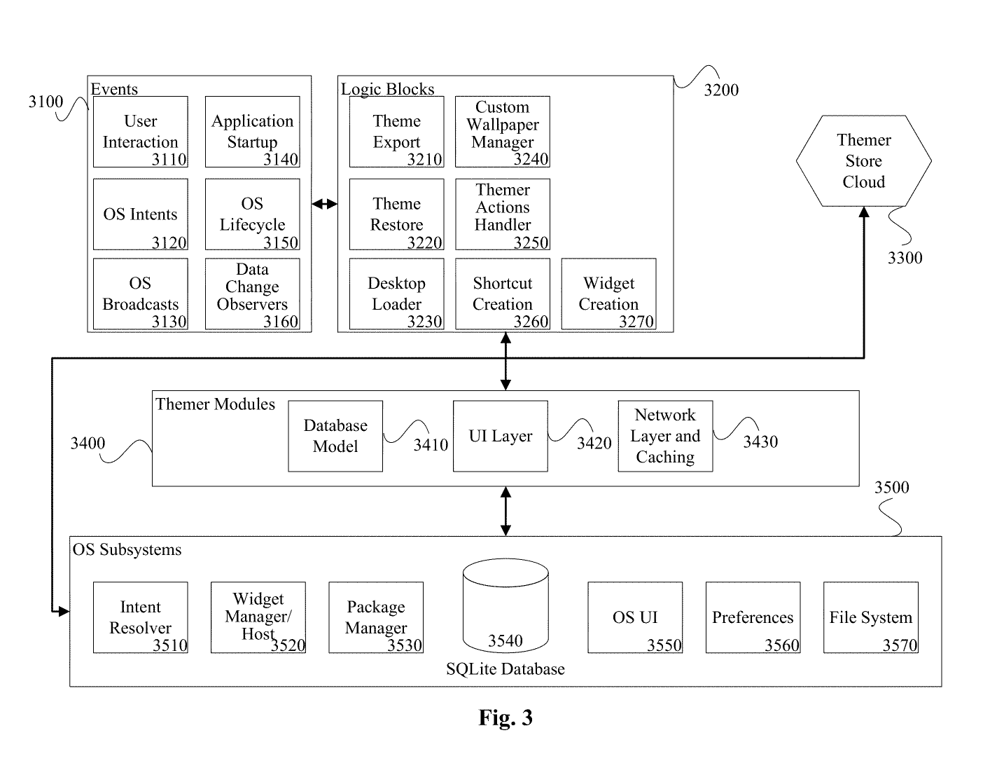

In FIG. 2, Home application 2510 provides the basic user interface provided to the user of the operating system. For example, in the Android OS, the Home application provides the standard Android ‘Home’ screen and multiple desktop backgrounds which the user may access by swiping left and right across the touchscreen with a finger. Turning to the preferred embodiment illustrated in FIG. 2, Themer App 2010 is used as a replacement for Home application 2510, providing a custom graphical user interface management system for users. The various components and processes of Themer App are illustrated beginning in FIG. 3 and accompanying text. It should be noted that, as a general matter, the Themer App and the disclosed system are not restricted to being replacements for Home applications on Android, and can be standalone components, or even layers, of operating systems. Rather, FIG. 2 illustrates one embodiment and use of the disclosed system. It will also be understood by one of ordinary skill in the art that FIG. 2 does not provide an exclusive list of drivers, libraries, and other modules comprising an operating system. Many other software modules typically comprise an operating system, and the modules provided herein are used as illustrations.

Turning to the Themer App, the preferred embodiment of its system architecture is illustrated in FIG. 3. FIG. 3 illustrates various aspects of the Themer App and its ecosphere. Element 3100 provides examples of some events that may trigger a response by the Themer App. Logic Blocks 3200 illustrates some of the fundamental modules that may be activated by the Themer App. Themer Store Cloud 3300 is preferably one or more servers that store various themes that may be downloaded by users onto the Themer App via the Internet. Themer Modules 3400 illustrates some of the higher level software modules of the Themer App. OS Subsystems 3500 shows some of the operating system subsystems that may interface with the Themer App.

Turning to the specific OS Subsystems, in the preferred embodiment the Themer App can interface with Intent Resolver 3510, Widget Manager/Host 3520, Package Manager 3530, SQLite Database 3540, OS UI 3550, Preferences 3560, and File System 3570. For example, the Themer App may interact with Intent Resolver 3510 to determine the correct application to launch; Widget Manager/Host 3520 to present an interactive widget that provides access to certain data on a home screen of the device; Package Manager 3530 to obtain information regarding the various applications installed on the device; SQLite Database 3540 to store various settings and configurations, such as shortcuts and icons; OS UI 3550 to present accessible user interfaces; Preferences 3560 to store and access key values relevant to the configuration of the device; and File System 3570 for the ability to save and open various files.

Turning to the various modules comprising the Themer App, in FIG. 3 several modules have been abstracted into three high level elements: Database Model 3410, UI Layer 3420, and Network Layer and Caching. In the preferred embodiment, Database Model 3410 is responsible for maintaining a database of various theme components and user settings. UI Layer 3420 prepares and presents a graphical user interface accessible by the user. Network Layer and Caching 3430 interfaces with the Themer Store Cloud 3300 and other network resources to the extent necessary.

In the preferred embodiment, when running, the Themer App spawns various Processes, some of which correspond to logic blocks 3200, including Theme Export 3210 used to export a theme customized by a user; Theme Restore 3220 used to load a theme onto the device; Desktop Loader 3230 used to prepare the desktop interface; Custom Wallpaper Manager 3240 used to manage one or more theme wallpapers; Themer Actions Handler 3520 to manage user interactions with the device; Shortcut Creation 3260 used to create shortcuts to various applications and data sources; and Widget Creation 3260 used to create various widgets for the user. While not shown in FIG. 3, Logic Blocks 3200 may also include other blocks relating to graphical, data transfer, or interface processing.

Turning to Events element 3100, in the preferred embodiment the Themer App is configured to react to various events that may occur from time to time. For example, User Interaction 3110 is an event that may require the Themer App to deal with a user interaction; OS Intents 3120 that may require the Themer App to respond to a system intent; OS Broadcasts 3130 that may signal or transmit a message from or to the OS; Application Startup 3140 events that kick off initialization procedures; OS Lifecycle 3150 events that signal to the App that it should change its state (paused, resumed, exited); and Data Change Observers 3160 that produce events signaling that the App should respond to some underlying data change. While not shown in FIG. 3, Events 3100 may also include implementation and platform specific listeners.

It should be noted that the lines connecting elements 3100, 3200, 3300, 3400, and 3500 in FIG. 3 do not necessarily represent logical or physical connections. Rather, the lines are used to illustrate conceptual interfaces and interactions between various system modules. For example, in the preferred embodiment, the only Themer App module from layer 3400 to interact with the Themer Store Cloud 3300 is Network Layer and Caching 3430. However, in the preferred embodiment, a number of other Processes and OS Subsystems are affected, or at least influenced, by the Internet, and to that end a line connecting the various components to the cloud can be found in FIG. 3. In addition, one of ordinary skill in the art will recognize that other components, some of which have not been shown in FIG. 3, may play a role in the operation of the device.

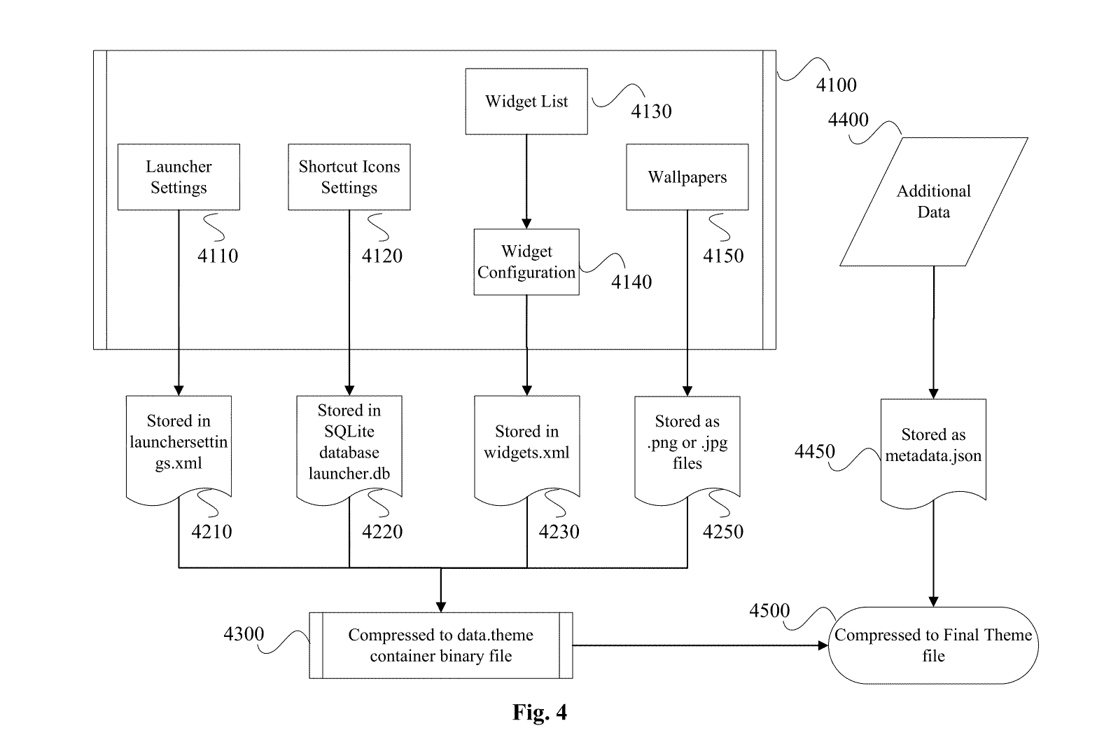

Turning to the next figure, FIG. 4 illustrates the various settings, information, and modules of a theme in a preferred embodiment, and one method of storing and combining various theme components into a single file. As noted earlier, in accordance with certain embodiments of the present invention, the preconfigured themes may include a number of elements, including backgrounds, icons, and widgets. This offers a significant advantage to the user of the disclosed system. Whereas previously users had to download elements of graphical user interfaces, such as wallpapers, widgets, graphics, and icons, individually and then devote a significant amount of time on configuring the various elements to work together, certain embodiments of the disclosed system provide a pre-packaged and preconfigured theme that is ready to use.

In FIG. 4, Element 4100 illustrates various modules of settings, graphics, information, and software that comprise a theme in the preferred embodiment of this invention. Element 4400 illustrates various metadata that may relate to a particular theme. Turning first to the theme components, element 4110 represents Launcher Settings, such as, for example, the grid size, number of home screens presented to the user, and whether the search bar should be shown. Launcher Settings 4110 are preferably stored in XML format in a file named launchersettings.xml, illustrated as element 4210 in FIG. 4. Settings for the Shortcut Icons, such as, for example, the icon title, icon package name, and icon position on the screen, are represented by element 4120, and stored in file SQLitedatabaselauncher.db, illustrated as element 4220. A list of widgets included with the theme, such as, for example, the clock, Everything Widget, or an RSS feed, is represented by element 4130, with configurations for the widgets, such as the RSS feed URLs, font size, and colors being represented by element 4140. In the preferred embodiment, each widget's configuration is stored in a separate file named widgets.xml, with each file being stored in a separate widget folder. The theme wallpaper, or multiple wallpapers, are represented by element 4150, preferably stored as .png or .jpg files in element 4250.

The various list, graphic, settings, configuration, and other data and text files comprising the theme can be compressed into a container binary file named, for example, data.theme, as illustrated by element 4300. While container binary file 4300 comprises most of the theme data, other information relating to the theme, which may not necessarily be required to construct the graphical user interface contained in the theme, is represented by element 4400. Information in element 4400 may include theme store metadata, the theme author, themeID, and other useful information. This information is stored as a file named, for example, metadata.json as illustrated in 4450. The data.theme container binary file 4300 and metadata.json file 4450 may then be compressed into a final theme file 4500, which can be distributed to users or incorporated into the theme web store.

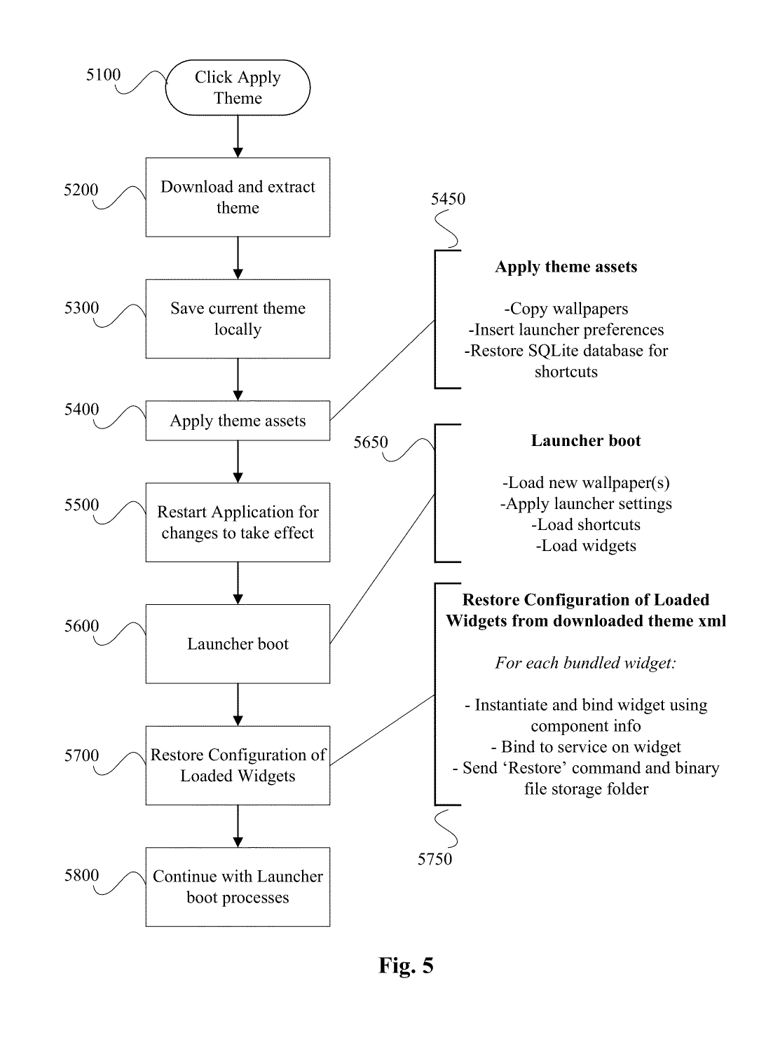

FIG. 5 is a flowchart illustrating application of a theme by the Themer App to the device in the preferred embodiment. At step 5100, a user has selected “Apply Theme” on the user interface provided by the Themer App. In response, at step 5200, the Themer App downloads the theme, preferably in the shape of a compressed theme file, such as file 4500 illustrated in FIG. 4, and extracts the theme file. At step 5300, the Themer App saves the extracted theme locally. At step 5400, the Themer App applies the theme assets, a procedure shown in more detail in callout 5450. As indicated in 5450, when applying theme assets in the preferred embodiment, the Themer App copies theme wallpapers; inserts theme launcher preferences into appropriate OS records; and restores SQLite database for shortcuts that came preconfigured with the downloaded theme. It should be noted that a similar process is used to apply a theme that has been sideloaded onto the device.

After theme assets have been applied, the Themer App moves onto step 5500, where the application is restarted for changes to take effect. Next, the launcher boots at step 5600, described in more detail in callout 5650. As illustrated, when the launcher boots in the preferred embodiment, the Themer App loads the new wallpapers, applies launcher settings, loads shortcuts, and loads widgets included with the theme. At step 5700, described in more detail in callout 5750, the Themer App restores loaded widgets based on the downloaded theme xml file, including: instantiating and binding the widgets using component info; binding to services on the widgets; and sends a ‘Restore’ command and binary file to storage folder. At step 5800, the launcher boot process continues.

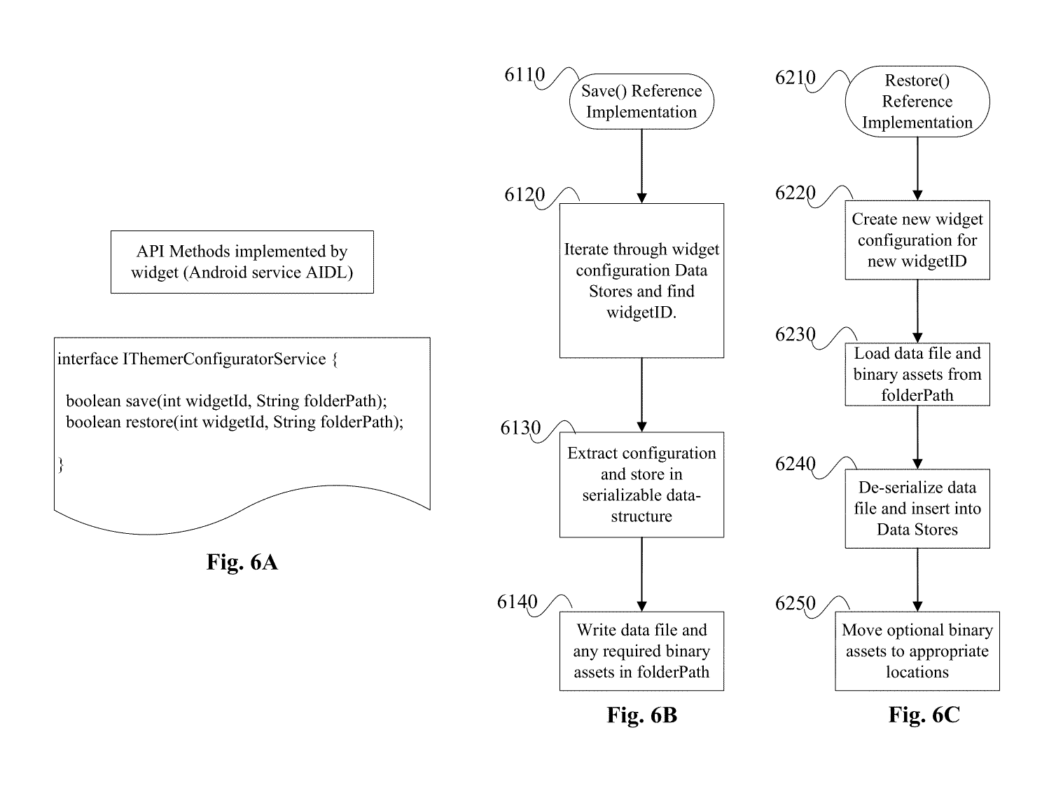

FIGS. 6A-6C illustrate exemplary processes and methods used to save and restore widget configurations. FIG. 6A shows the preferred embodiment of declarations for the save and restore methods, as configured to function on the Android operating system. Here, the save( ) and restore ( ) methods each require an integer parameter widgetID, and a text string parameter folderPath. FIG. 6B is a flowchart showing process steps for saving widget settings in the preferred embodiment. At step 6110, the save( ) method is called. At 6120, the Themer App iterates through widget configuration Data Stores looking for the referenced widgetID. Here, Data Stores refers to any mechanism used to store widget configuration, such as OS Preferences, SQLite, and others. At 6130, the Themer App extracts discovered widget configurations and stores them in serializable data-structures. At 6140, the widget configurations are written to a data file and stored together with any required binary assets in the referenced folderPath.

FIG. 6C is a flowchart showing process steps for restoring widget settings in the preferred embodiment. At step 6210, the restore( ) method is called. At 6220, new widget configuration is created for the referenced widgetID. At 6230, the Themer App loads the data file and binary assets from the provided folderPath. At 6240, the loaded data file is de-serialized and the data is inserted into the Data Stores referenced in FIG. 6B. At 6250, the Themer App moves optional binary assets to appropriate locations. One of ordinary skill in the art will recognize that FIGS. 6A-6C illustrate the preferred embodiment of the widget save and restore methods. Other methods of saving and restoring widgets, and executing the various steps described herein, are possible, including the execution of the steps by modules other than the Themer App. It should be noted that the save and restore features described above may be applied to both themes downloaded from the theme store and to sideloaded themes.

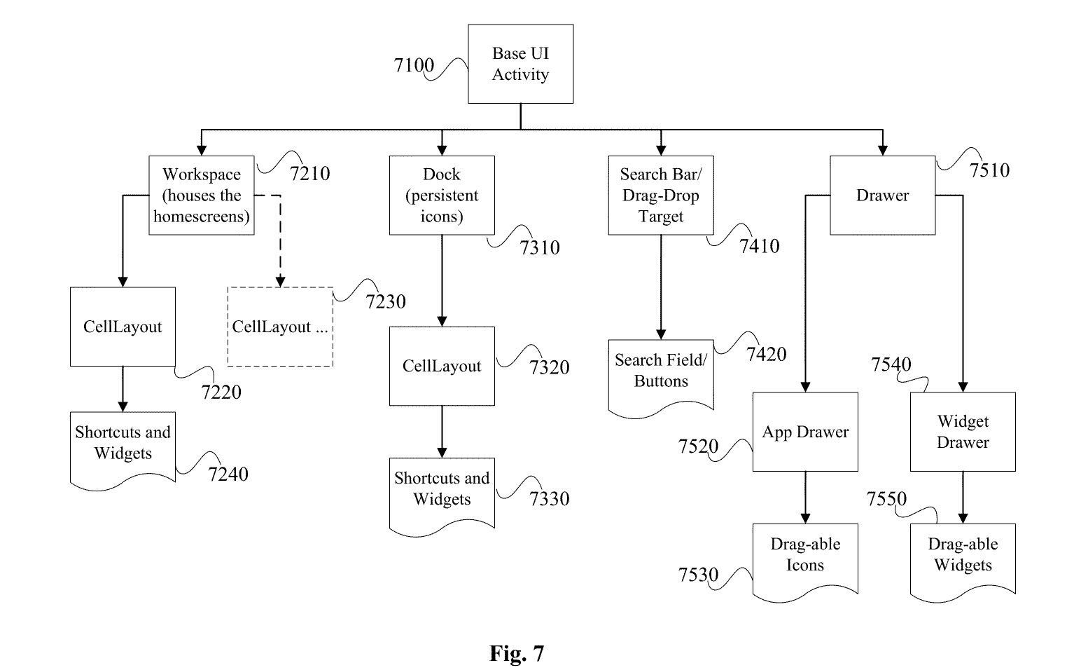

FIG. 7 illustrates one embodiment of the hierarchy of the user interface (“UI”) layer in the disclosed system. Block 7100, labeled “Base UI Activity,” represents the top of the UI hierarchy in this embodiment. The label Activity refers to nomenclature from certain operating systems, such as Android, that refer to user interfaces as Activities. At the next level lie four other elements, including Workspace 7210 which houses the home screens; Dock 7310 which comprises of persistent icons which can be fixed to one position on a screen; Search Bar/Drag-Drop Target 7410, which provides a search bar on a homescreen and is capable of presenting a drop target for icons depending on the state of the device; and Drawer 7510 which houses applications, widgets, and other packages installed or housed on the device.

In the depicted hierarchy, below Workspace 7210 lie CellLayout nodes 7220 and 7230. CellLayouts represent the graphical and logical layout of cells on each homescreen. In FIG. 7, CellLayout 7220 is surrounded by a solid border, but CellLayout 7230 is represented by a broken-line border. In the preferred embodiment, a theme applied by the disclosed system contains at least one homescreen, which is represented by the solid border of CellLayout 7220, but the theme may include many other homescreens, which would be represented by CellLayout 7230 and others. Further, CellLayout 7220 is the parent node for Shortcuts and Widgets 7240, which is an object used to represent the various shortcuts and widgets that appear on a homescreen in accordance with the parent CellLayout 7220.

Turning to Dock 7310, in FIG. 7 the Dock is a parent of CellLayout 7320, similarly to Workspace 7210 being the parent of CellLayouts 7220 and 7230. In the preferred embodiment, the Dock contains icons and/or widgets affixed to a particular portion of the screen, remaining at that location even when the user flips between various homescreens. CellLayout 7320 is the parent of Shortcuts and Widgets node 7330, which contains positioning and/or appearance information for shortcuts and widgets inside the dock.

Search Bar/Drag-Drop Target 7410 is a UI hierarchy object designed to provide users with a search bar and a drag-drop target for icons. For example, in the preferred embodiment, a user may wish to always display a search bar at a location on the homescreen. The search bar may be configured accept user input in the form of an alphanumeric string, or in the form of voice input. After accepting user input, the search bar may run a search of the device file system, the Internet through a search engine like Google or Bing, social media, or a combination of the above. The drag-drop target may be used to provide contextual menus in the event that a user drags an icon or a widget over a specified location. The contextual menus may include options to delete the icon, uninstall a program, rename the shortcut, or various other actions. Search Field/Buttons object 7420 is a child node of Search Bar/Drag-Drop Target 7410, and it provides settings and configuration options for the various search field attributes and buttons.

Drawer 7510 is the parent element in the UI hierarchy for various drawers that may be made available to the user, such as App Drawer 7520 and Widget Drawer 7540. App Drawer 7530 may include Drag-able Icons 7530, and Widget Drawer 7540 may include Drag-Able Widgets 7550. One of ordinary skill in the art will recognize that the disclosed system is not limited to providing app and widget drawers, but may provide drawers for various executable data objects, including picture and video galleries, social media objects, and other elements.

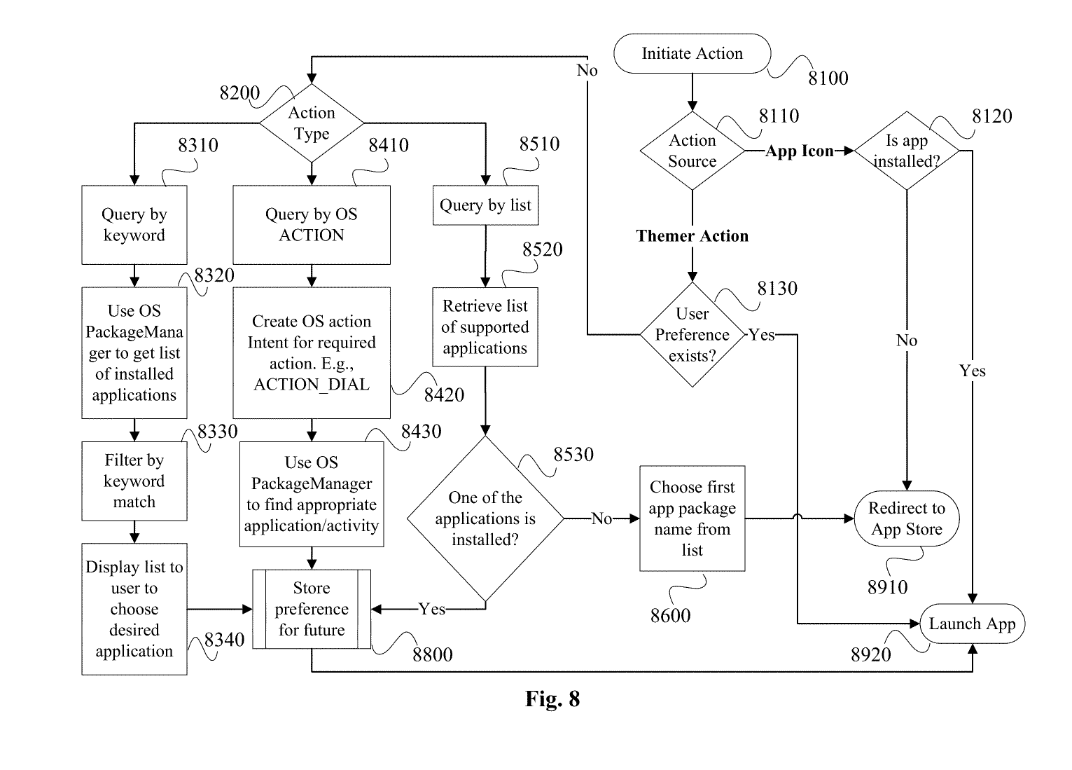

FIG. 8 is a flowchart illustrating the various processes and steps that the disclosed system in the preferred embodiment may perform in response to a user action. At step 8100, a user initiates an action, including, for example, by selecting an icon or a hotspot. The selection may be a tap or a swipe on a touch screen, a click with a mouse, a key press, a stylus action, a controller input, or any other input mechanism. At 8110, the system detects the source of the action, or in other words, whether the action was the selection of a shortcut icon, such as for a game, a social media platform, or for a browser, or whether the action was the selection of a feature of the Themer App, which may in certain embodiments include, for example, the Phone app, SMS app, Social Media app or widgets, or a Books app. If the user selected an App Icon, at 8120 the system checks whether the selected app has been installed on the device. If the app has not been installed on the device, the system redirects the user to the App Store at 8910. Redirection to the app store may involve launching a website or a dedicated app such as Google Play Store or the Apple App Store. Similarly, the system may redirect the user to various other content providers depending on the type of icon selected. Thus, for example, if the icon selected at 8100 represents an MP3 file, the user may be redirected to a music store. If the app has been installed on the device, the system launches the app at 8920.

If the user action was a Themer Action, the system detects whether a user preference exists for the action at step 8130. If a configured user preference exists for the Themer Action, the system launches the app at step 8920. If no user preference exists for the Themer Action, the system proceeds to determine how it should properly react to the action, starting at step 8200. The disclosed system, or Themer App as one embodiment thereof, may use various methods to determine an appropriate response. The Themer App may isolate one or more keywords relating to a user's action, such as, for example, from the title of the icon clicked by the user or from the name of a widget accessed by the user. The system may then run a keyword query (step 8310 in FIG. 8) through the list of installed applications (step 8320); filter the query results by the keyword (step 8330), and display a list for the user, so that the user may choose the desired application (step 8340). The system may then store the user's preference for future use at step 8800. With respect to step 8320, if applied to an embodiment of the system running on an Android device, the system may use the Android packageManager to obtain a list of installed applications.

As an alternative to querying by keyword in 8310, the system may query by OS ACTION in 8410. At 8420, the system creates an Android action intent for the required action. For example, the system may determine that the relevant action is ACTION_DIAL, and use the OS package manager to find appropriate application or activity, storing the preference at 8800 for future use.

As another alternative, the system may query by list at 8510. At 8520, the Themer App retrieves a list of supported applications, and at 8530 determines whether one of the applications is installed. The applications are considered in priority of the list order, preferably alphanumerical. If one of the applications has already been installed, the Themer App stores the preference for future use at 8800. If none of the applications have been installed, the Themer App chooses the first app package name from the list at 8600, and redirects the user to the App Store at 8910. Turning back to the storage of preferences for future use at step 8800, the Themer App next proceeds to launch the app at step 8920 based on the stored preferences.

### User Interface

The foregoing was a detailed description of the system architecture of the disclosed system, and some of its embodiments. The disclosed system also provides a graphical interface that enables a user to browse, select, apply, and customize various interface themes onto the device. As noted above, certain embodiments of the disclosed system may be referred to as the Themer App, which in the preferred embodiment, is downloadable onto a mobile device running an operating system, such as Google Android.

After downloading or sideloading the Themer App onto the device, a user may want to access the main menu of the Themer App, which in the preferred embodiment is the gateway to the app's functions. A user may access the main menu in several ways, such as by long-pressing or double-pressing a Home key, if one exists on the device, by selecting the Themer App icon, or via other ways, such as voice activation. Other methods of accessing the Themer App may include long-pressing the Home key, if one exists on the device, or by accessing the widget and app drawer. The precise method of accessing the Themer App may vary based on the device, as different manufacturers implement various shortcuts differently. User interfaces of the Themer App are illustrated and described in more detail below, in the context of an embodiment running on the Google Android operating system.

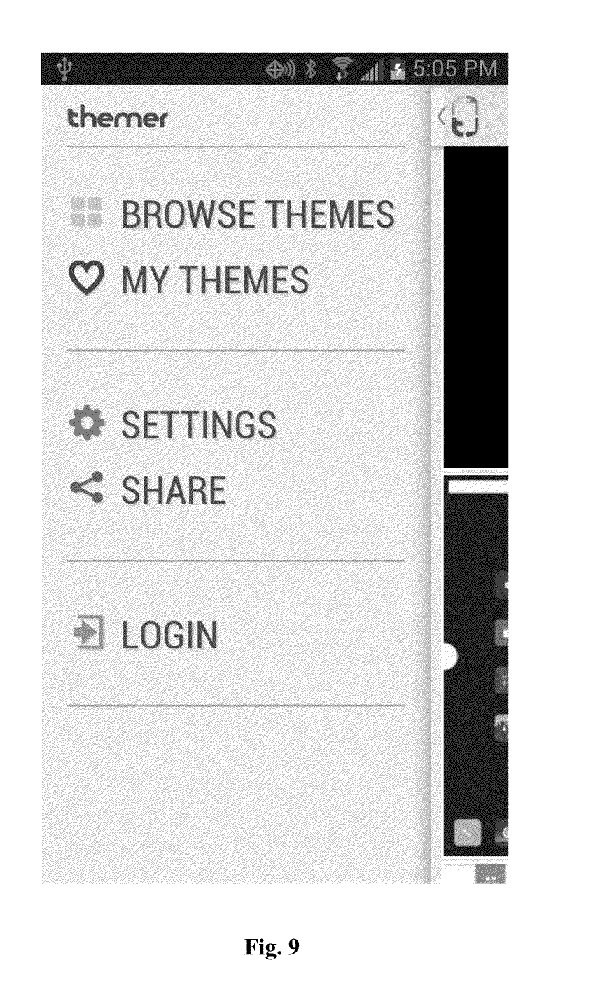

FIG. 9 illustrates one embodiment of the main menu of the Themer App. As shown in the figure, the main menu provides several selectable buttons to the user, including Browse Themes, My Themes, Settings, Share, and Logout.

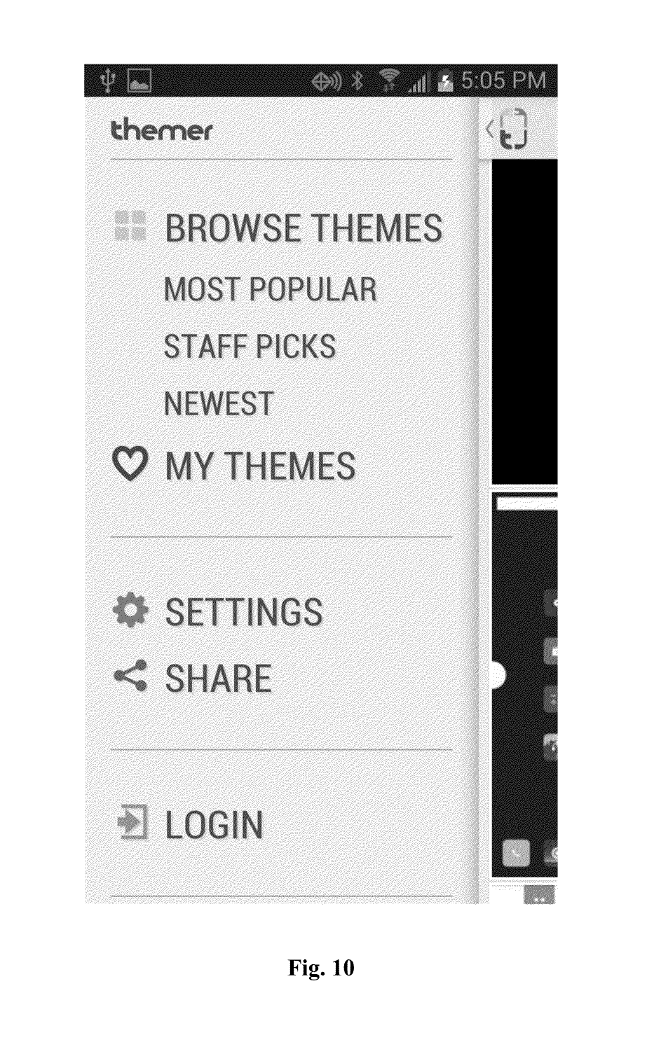

FIG. 10 illustrates one embodiment of the Browse Themes menu. When a user selects ‘Browse Themes’ on the main menu, the menu slides down revealing three additional elements: Most Popular, Staff Pick, and Newest.

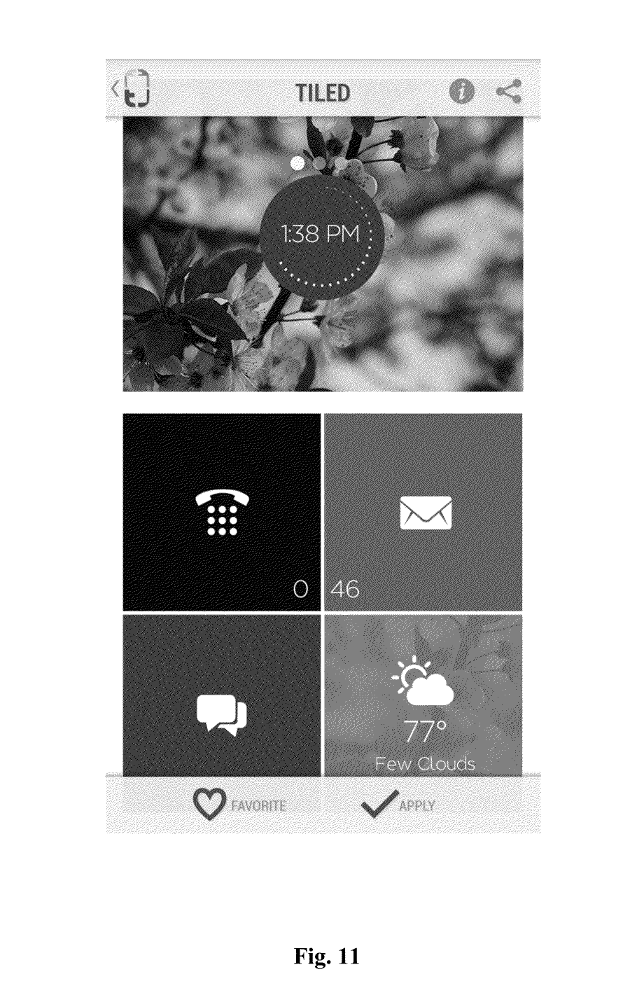

FIG. 11 illustrates one embodiment of the individual theme selection screen The shown ‘Tiled’ theme provides a screenshot of how the theme may look on the device, and the user is provided with an option to make the theme his or her ‘Favorite’ and to ‘Apply’ the theme. As shown, the user may also go back to the previous screen, obtain more information, or share the theme using some of the selectable buttons at the top of the screen.

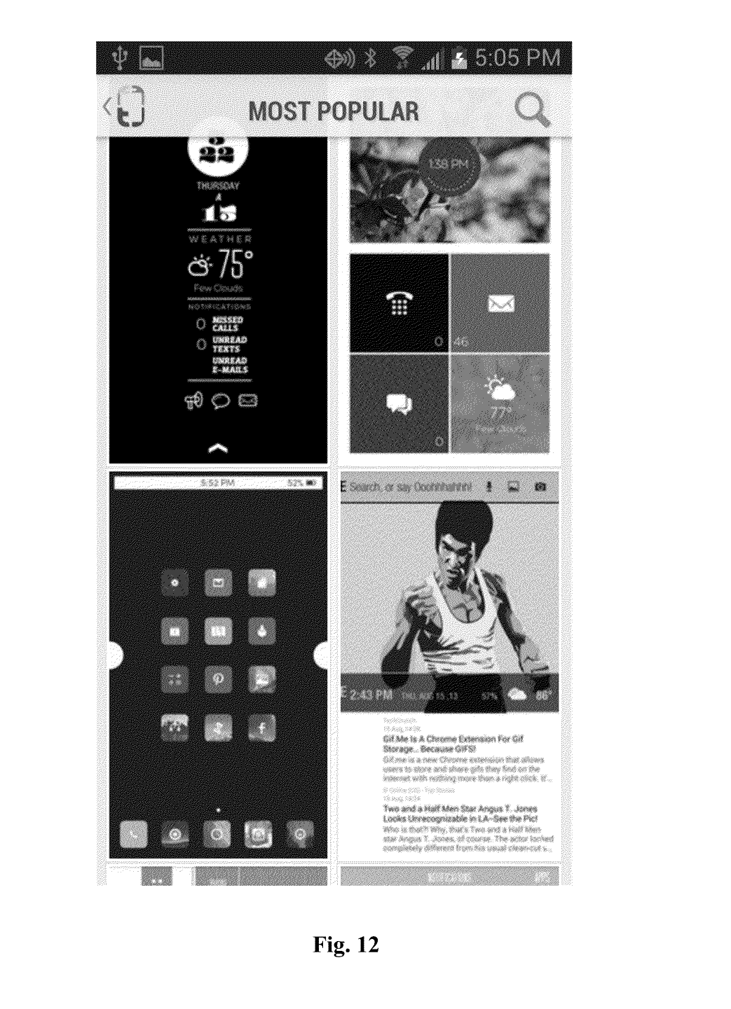

FIG. 12 illustrates one embodiment of a theme list. Here, the list comprises the ‘Most Popular’ themes, selectable from the Browse Themes component of the main menu.

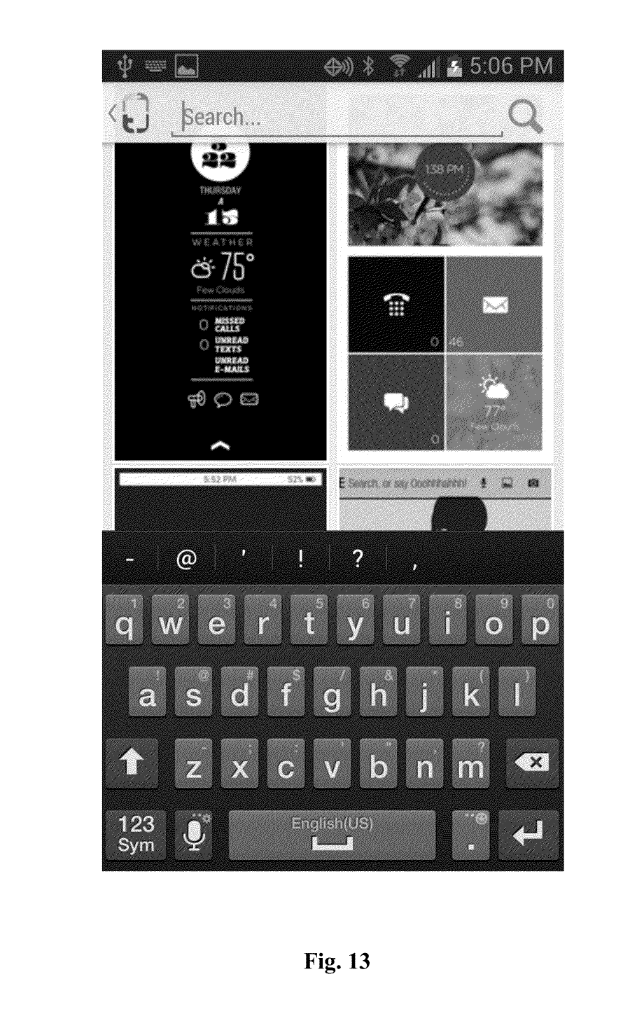

FIG. 13 illustrates one embodiment of the Search interface. Here, the user may type in a keyword, such as a theme title, description, author name, or another theme attribute. The Themer App will then perform a search based on a keyword. The search may be local to the device or a specific folder on the device, transmitted to the theme store, or be a broad Internet search for the particular keyword. Themes that match the search may be presented to the user in as a list, individually, or another viewable format.

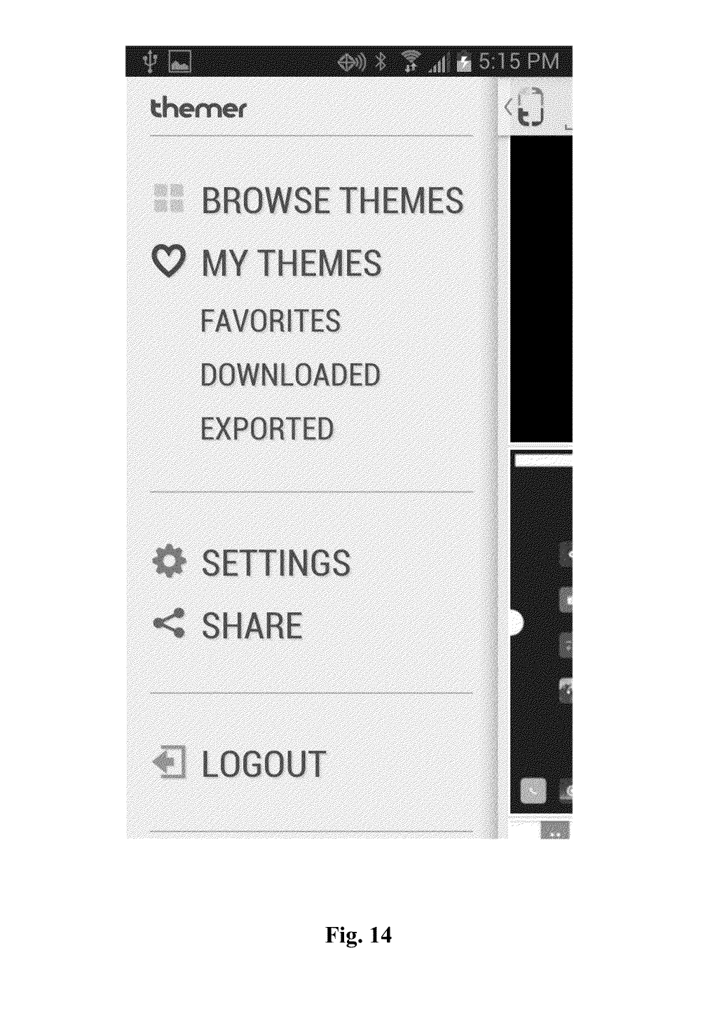

FIG. 14 illustrates one embodiment of the My Themes menu. As shown, when the My Themes menu item is selected, the main menu slides down revealing ‘Favorites,’ ‘Downloaded,’ and ‘Exported’ menu items. Selecting Favorites will display themes that the user has marked as a favorite; selecting Downloaded will display themes that have been downloaded by the user; and selecting Exported will display themes that have been exported by the user.

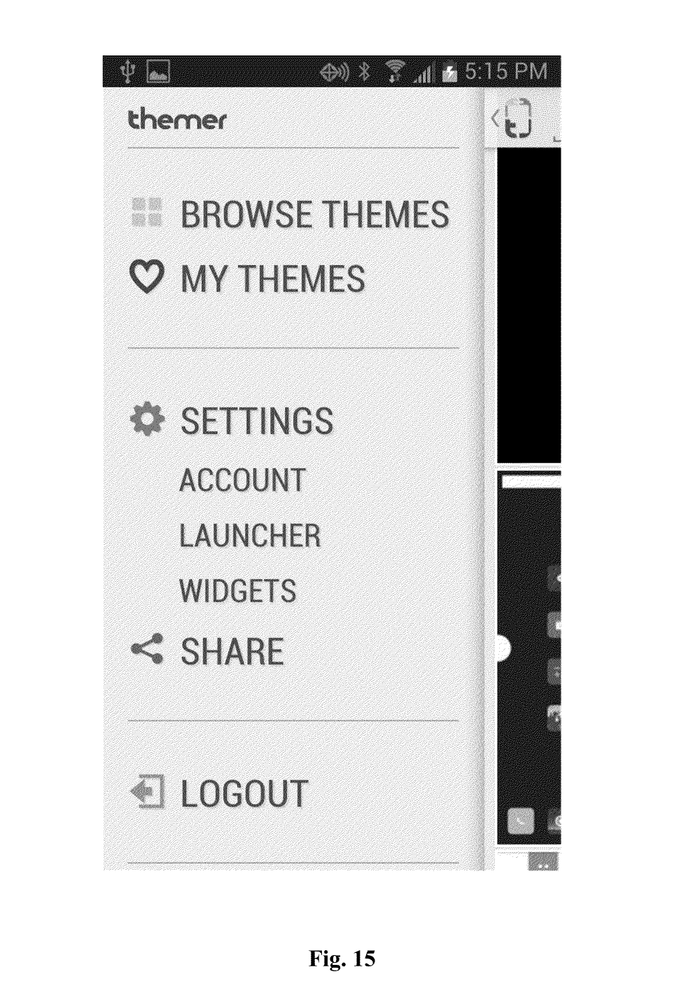

FIG. 15 illustrates one embodiment of the Settings menu. As shown, when the Settings menu item is selected, the main menu slides down revealing ‘Account,’ ‘Launcher,’ and ‘Widgets’ menu items. Each of these menu items is discussed in further detail below.

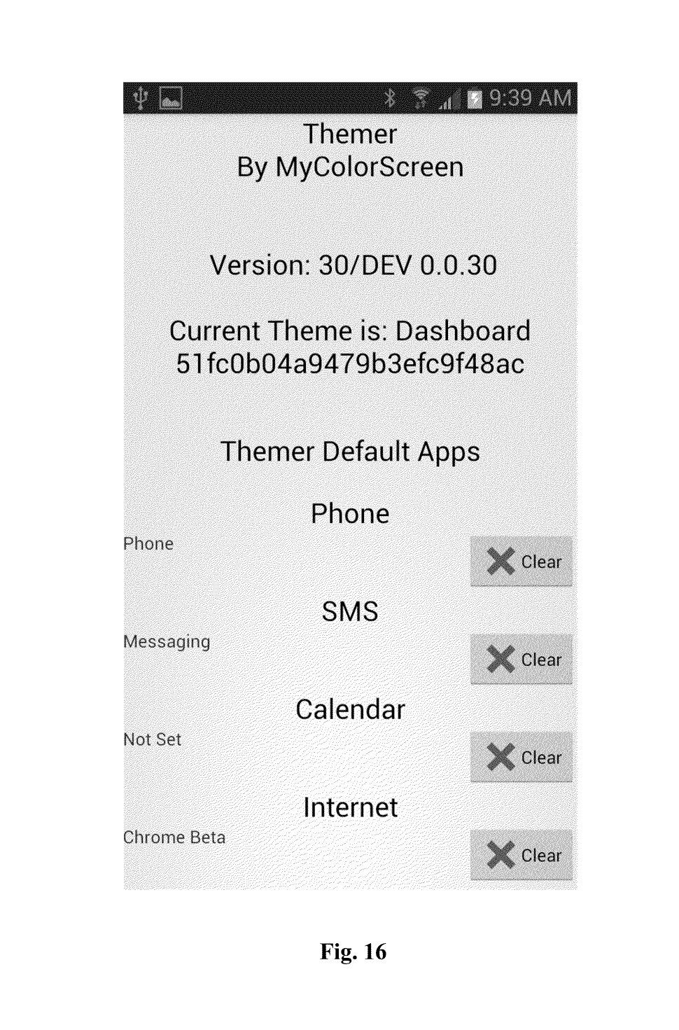

In the preferred embodiment, the Account menu provides the user with certain information about the current theme, the version of the Themer App, and default Themer Apps that are used for certain functions and events. The Account menu may include a large number of items, and to facilitate ease of access, the menu may be scrollable by the user. Here, FIGS. 16-19 illustrate various views of the Account Settings menu, including the different default apps that may be used.

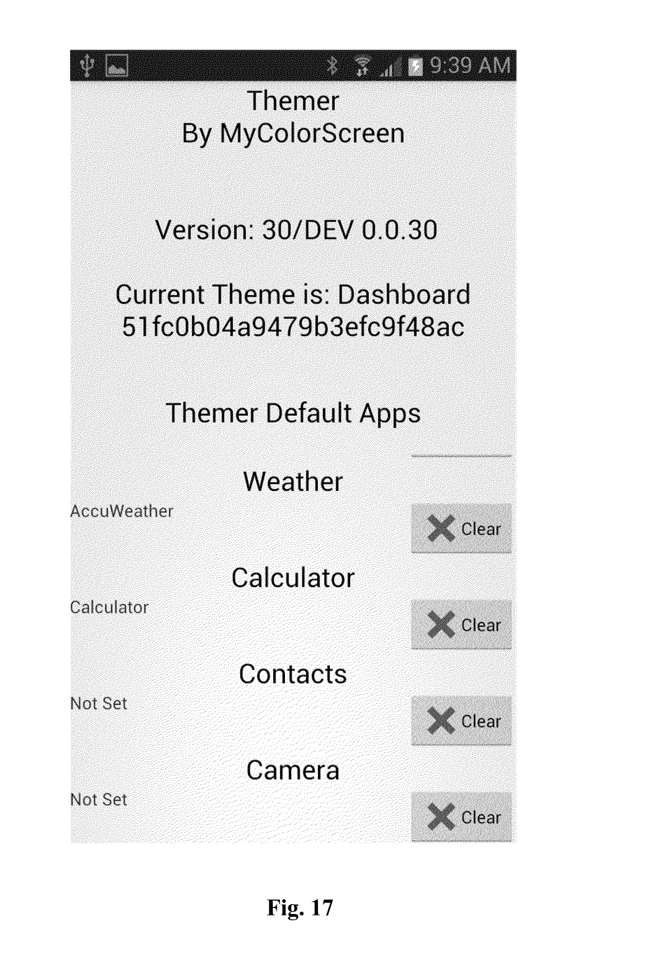

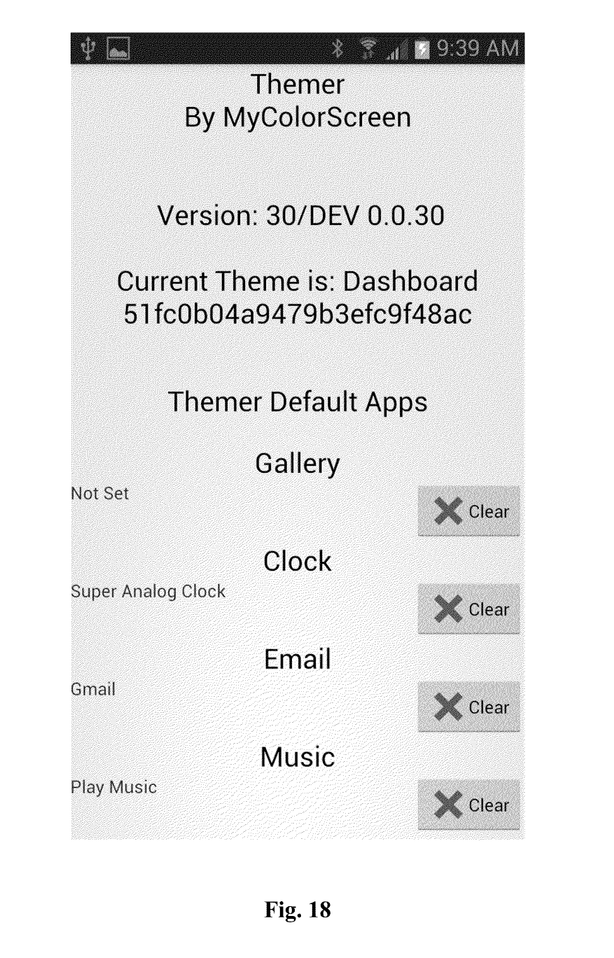

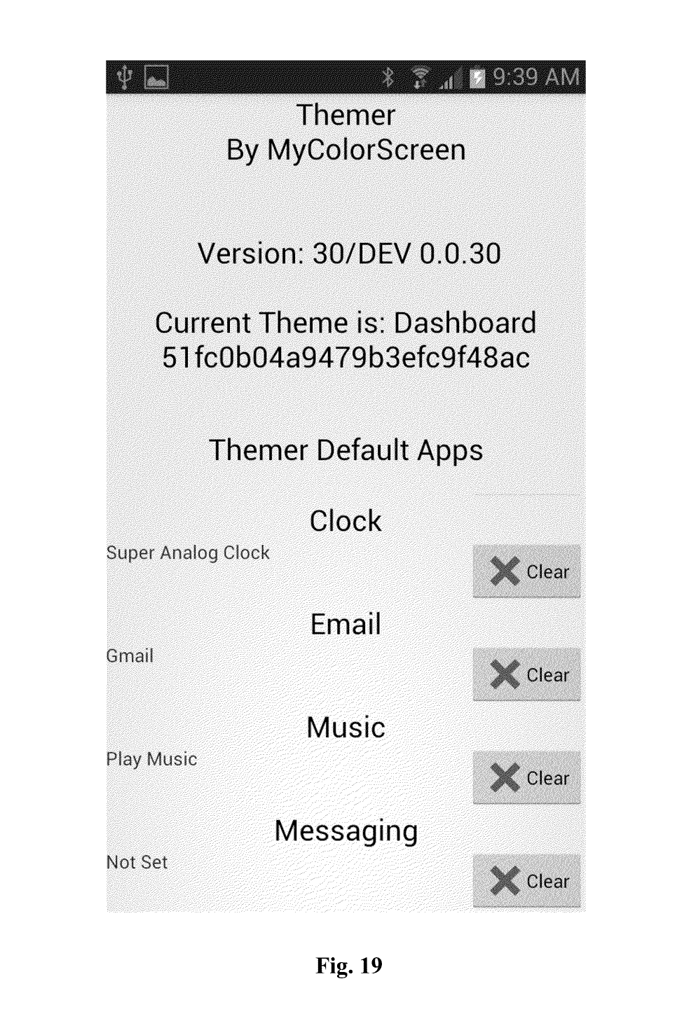

FIG. 16 illustrates one view of an embodiment of the Account Settings menu, including the default apps selected for actions involving Phone, SMS, Calendar, and Internet. For example, Phone is the default app for Phone actions, Messaging is the default app for SMS actions, no app has been set for Calendar actions, and Chrome Beta is the default app for Internet actions. FIG. 17 illustrates a second view of an embodiment of the Account Settings menu. Here, AccuWeather is the default app for Weather actions, Calculator is the default app for Calculator actions, and no default apps have been set for Contacts and Camera actions. In one embodiment, when no apps are selected for a particular action, the Themer App relies on default OS settings for the action. FIG. 18 illustrates a third view of an embodiment of the Account Settings menu. Here, no default app has been set for Gallery actions, the Super Analog Clock has been set as the default app for Clock actions, Gmail is the default app for Email, and Play Music is the default app for Music. FIG. 19 illustrates a fourth view of an embodiment of the Account Settings menu. Here, the scrollable list has reached the end, and the figure adds one new item, Messaging, for which no default app has been set. It will be understood by one of ordinary skill in the art that the list of default apps provided herein is not exclusive, and is not limited to a particular operating system. Rather, different operating systems include different actions, and use different nomenclature to describe certain actions and apps, which may be integrated with one or more embodiments of the present invention.

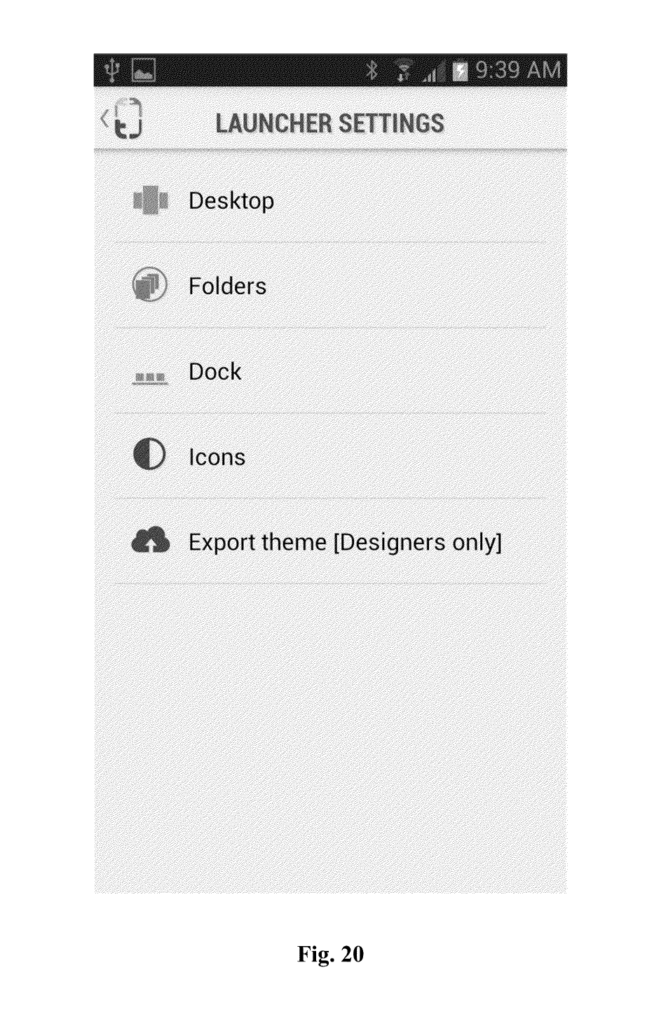

FIG. 20 illustrates one embodiment of the Launcher Settings menu, selectable from the Settings portion of the Main Menu. Here, the user is presented with several categories of components to configure, including the Desktop, Folders, Dock, Icons, and an option to Export themes. Each of these elements is described in further detail below.

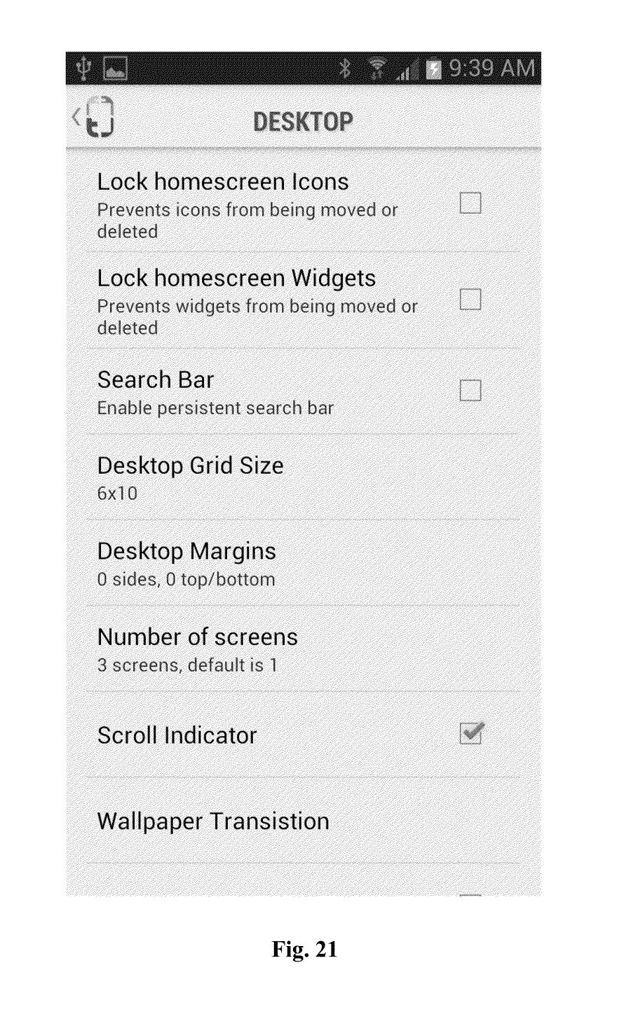

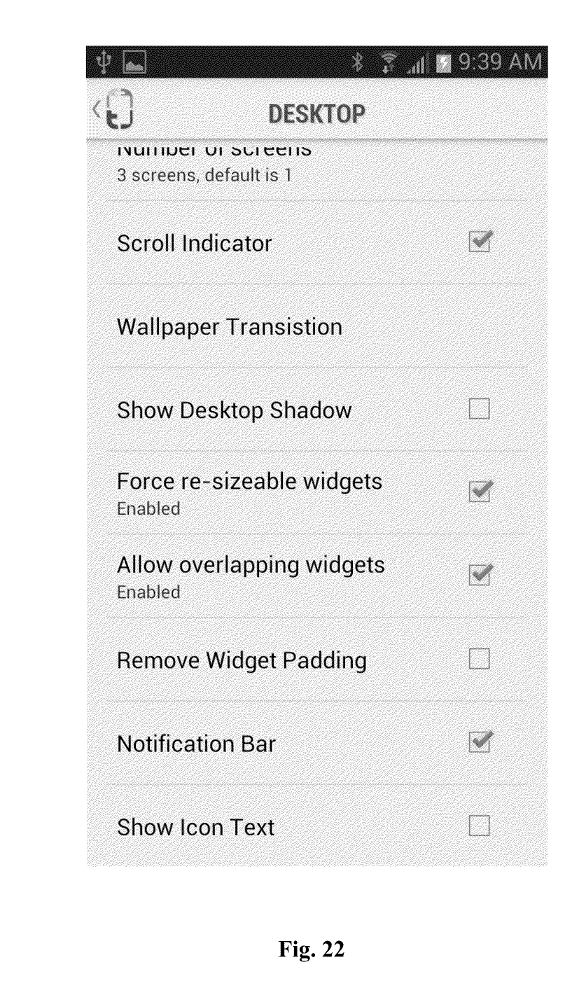

In the preferred embodiment, the Desktop settings menu includes various configuration options that may not fit on the same screen, and to this end the menu may be presented to the user in several screens, or made scrollable. FIG. 21 illustrates one view of an embodiment of the Desktop component of the Launcher Settings menu. Here, the user may choose to Lock homescreen icons to prevent the icons from being moved or deleted; Lock homescreen widgets to prevent the widgets from being moved or deleted; to enable a persistent search bar, which will appear in one or several homescreens; or to enable a scroll indicator on the screen, which may illustrate which of the homescreens the user is currently viewing, or to illustrate which portion of a homescreen is currently displayed. Options to customize the Desktop Grid Size, Desktop Margins, Number Of Screens, and Wallpaper Transition are described in more detail below. FIG. 22 illustrates a second view of an embodiment of the Desktop component of the Launcher Settings menu. Here, the user may choose to show a desktop shadow, force re-sizeable widgets, allow overlapping widgets, remove widget padding, enable a notification bar, and show icon text.

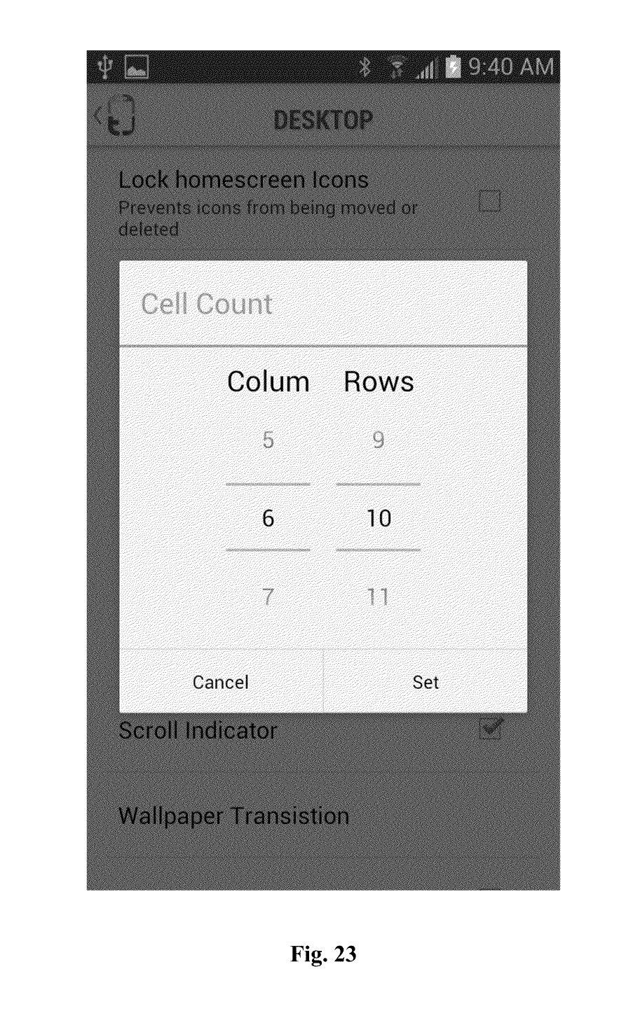

FIG. 23 illustrates an embodiment of the Desktop Grid Size configuration screen, accessible from the Desktop component of the Launcher Settings menu. Here, the user is allowed to select the cell count in terms of columns and rows. The cells may be used to size and position icons, widgets, and other graphical user interface objects.

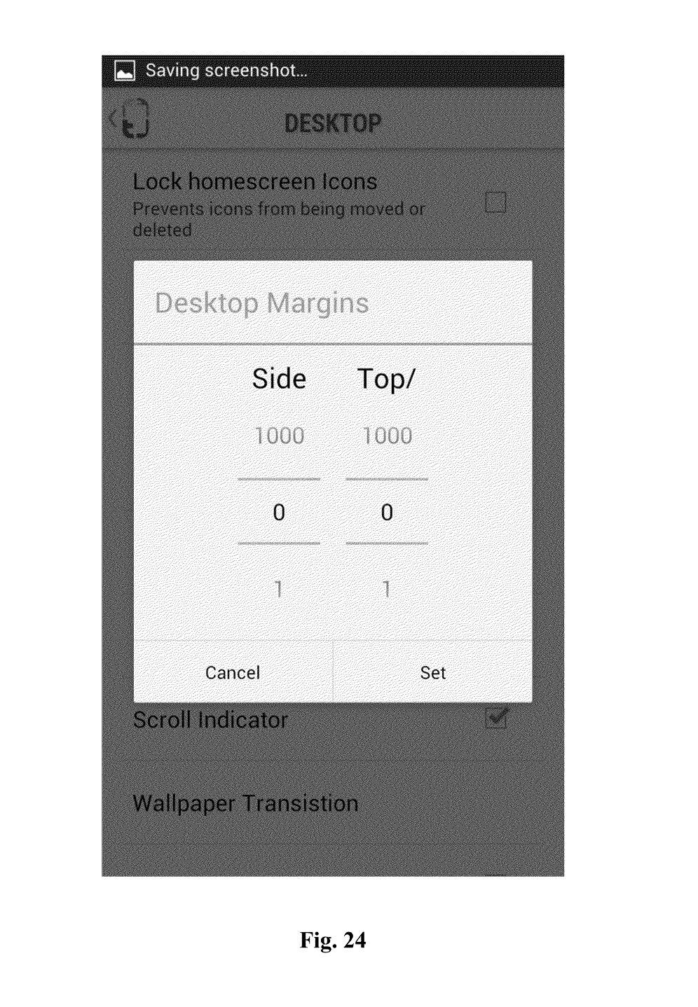

FIG. 24 illustrates an embodiment of the Desktop Margins configuration screen, accessible from the Desktop component of the Launcher Settings menu. Here, the user is allowed to select the desktop margins in terms of the distance in pixels, or other measurements, from the side and top of the screen.

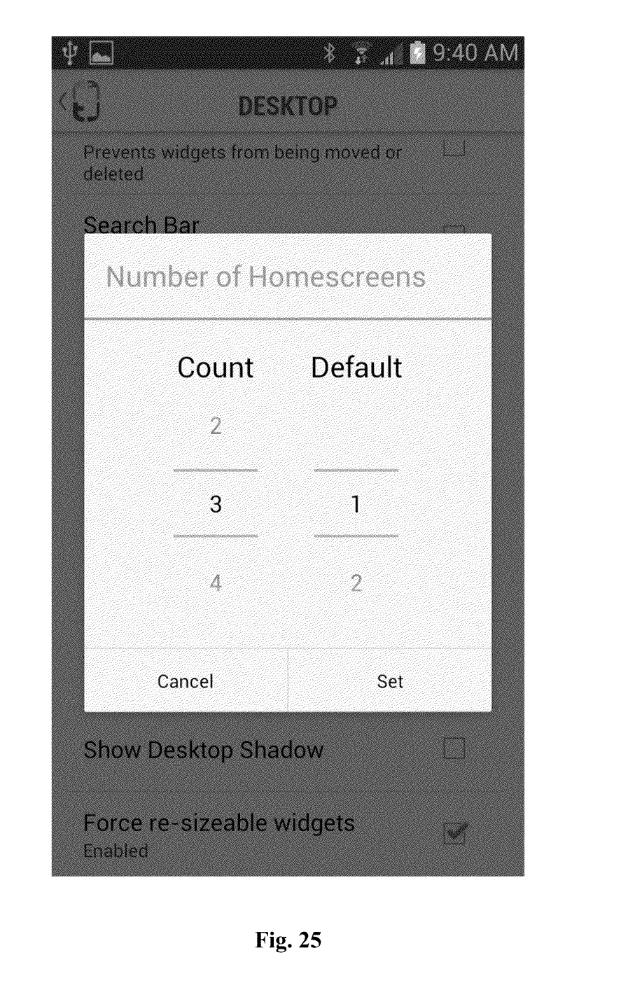

FIG. 25 illustrates an embodiment of the Desktop Number Of Homescreens configuration screen, accessible from the Desktop component of the Launcher Settings menu. Here, the user is allowed to select the default number of homescreens to be presented with a theme, and also the maximum count of homescreens that users of the theme may expand the default number to. In this example, the theme will come preconfigured with one homescreen by default, but theme users may be able to expand that number up to three homescreens.

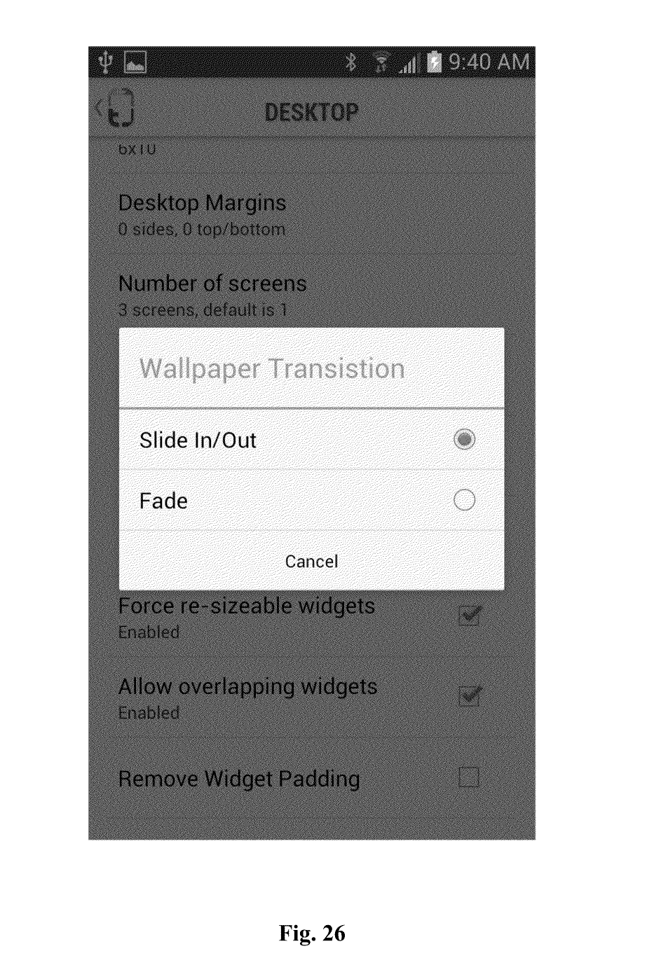

FIG. 26 illustrates an embodiment of the Desktop Wallpaper Transition configuration screen, accessible from the Desktop component of the Launcher Settings menu. Here, the user is presented with an option to choose different wallpaper transitions, such as Slide In/Out or Fade.

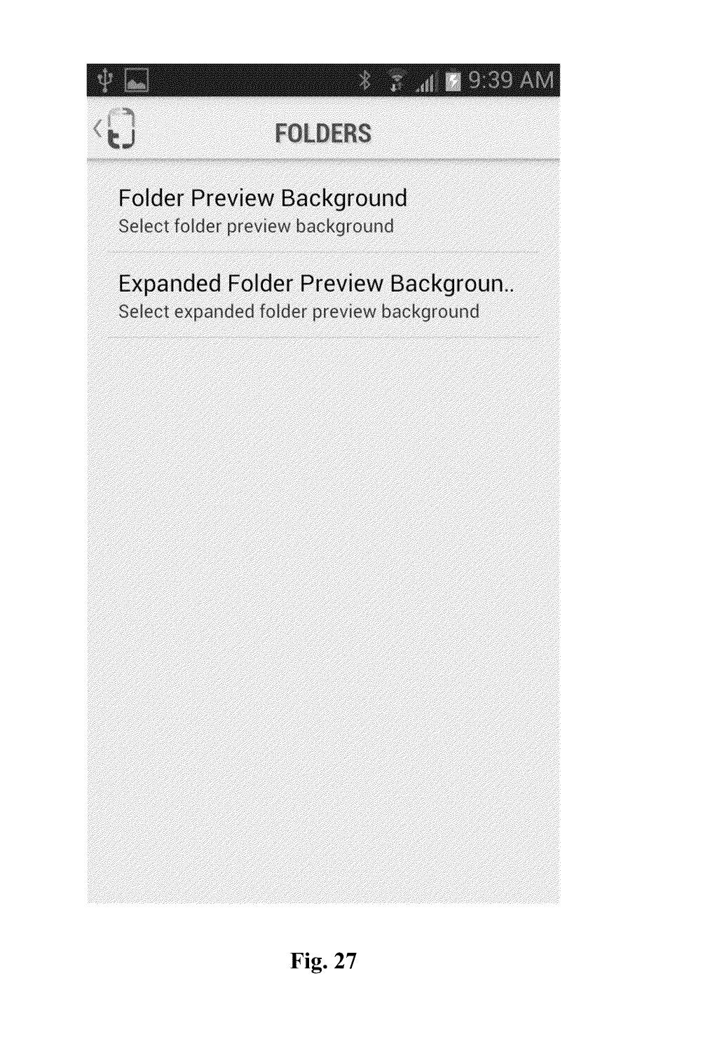

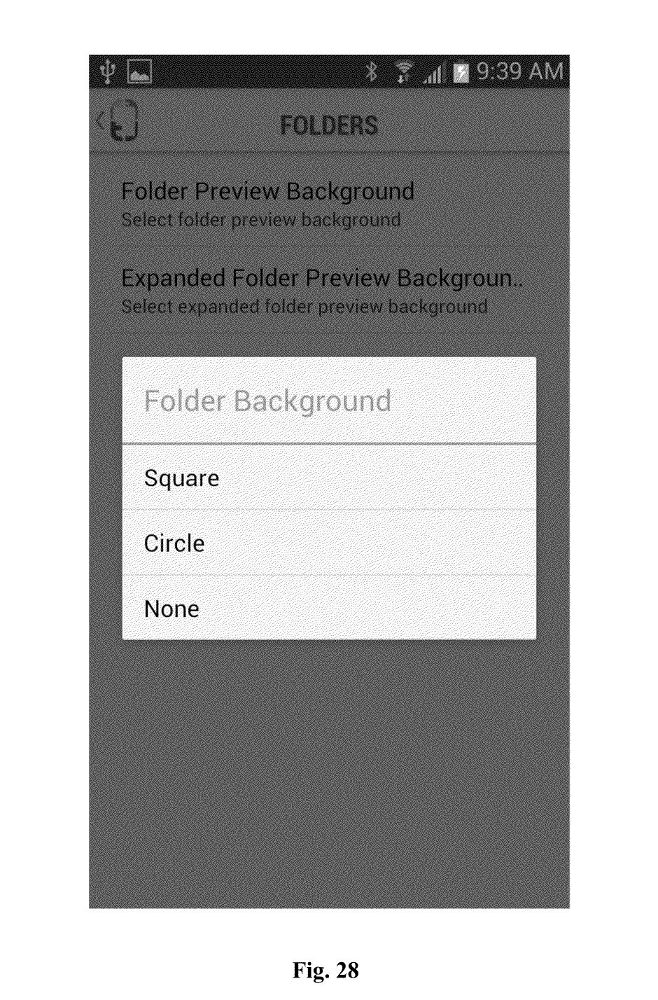

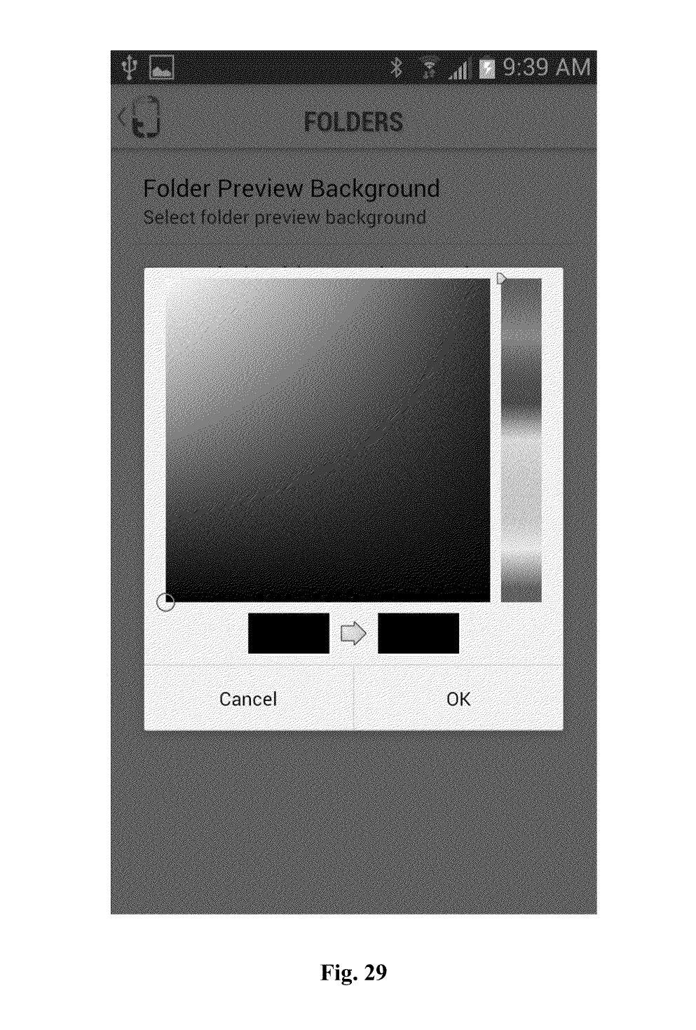

FIG. 27 illustrates one embodiment of the Folders configuration screen, accessible through the Launcher Settings menu. Here, the user is presented with selectable options for folder preview backgrounds and for expanded folder preview backgrounds, shown in FIGS. 28 and 29. FIG. 28 illustrates one embodiment of the Folder Preview Background configuration screen, accessible from the Folders component of the Launcher Settings menu. In this embodiment, the user is presented with an option to select the geometric shape of the folder background, such as a square, circle, or none. FIG. 29 illustrates one embodiment of the Expanded Folder Preview Background configuration screen, accessible from the Folders component of the Launcher Settings menu. Here, the user is presented with a color pallet allowing a wide choice of colors to be selected, and a transition feature, that allows the folder preview background to transition from one color to another.

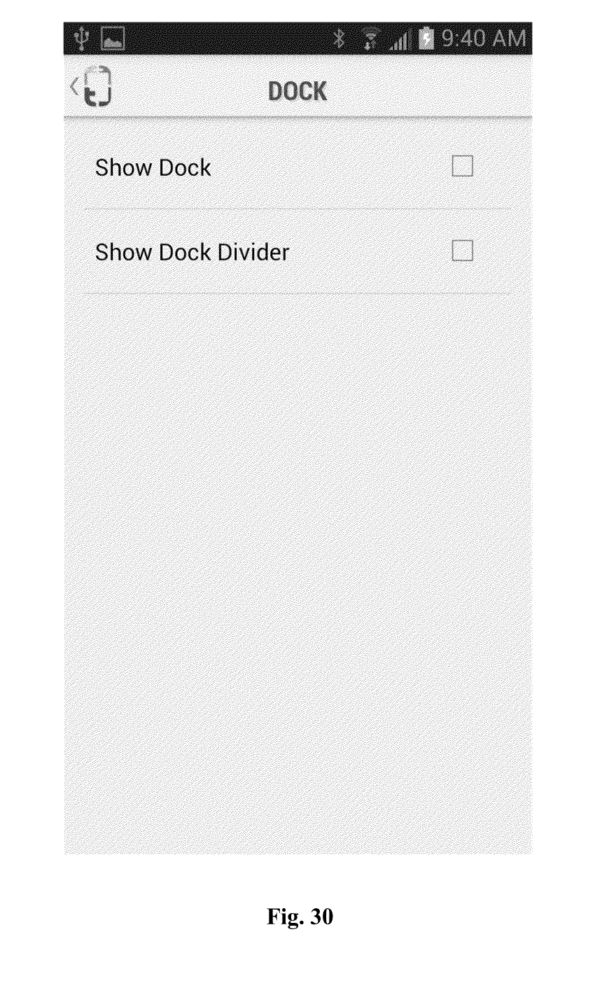

FIG. 30 illustrates one embodiment of the Dock configuration screen, accessible through the Launcher Settings menu. Here, the user is presented with checkbox options of whether to Show Dock, and whether to Show Dock Divider.

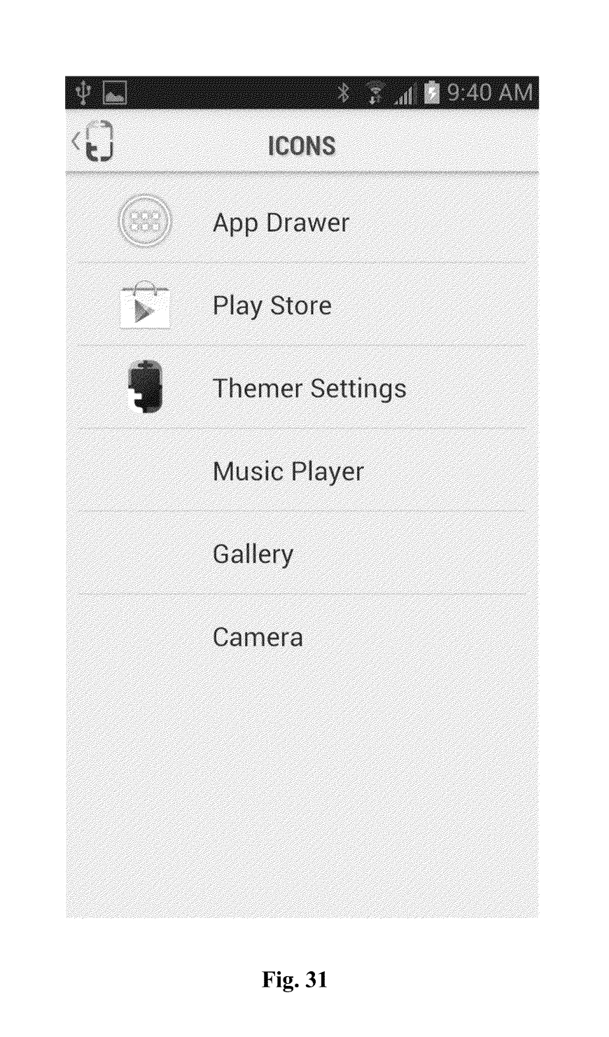

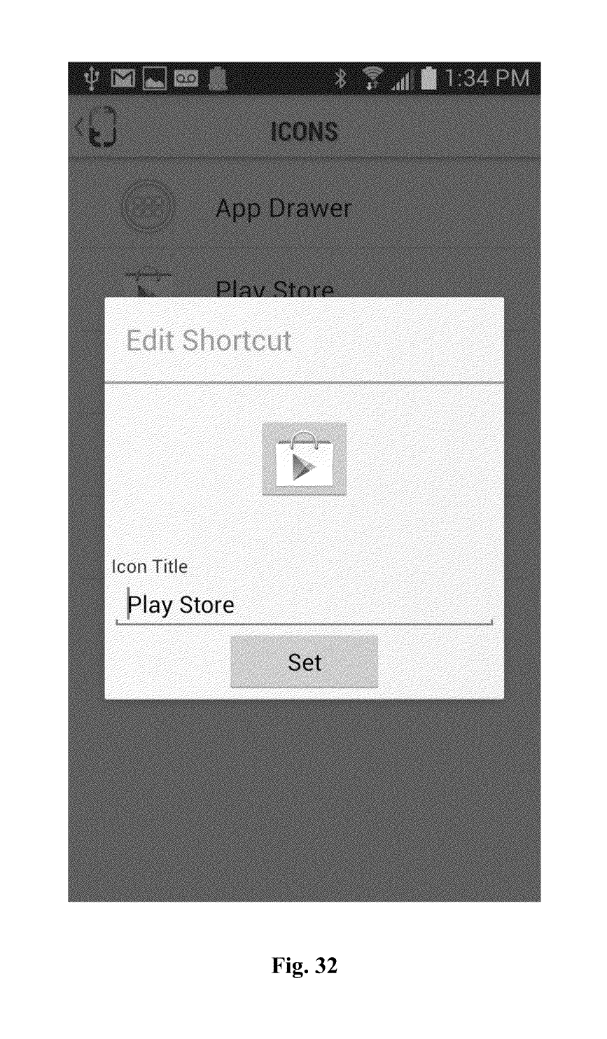

FIG. 31 illustrates one embodiment of the Icons configuration screen, accessible through the Launcher Settings menu. In the illustrated embodiment, the Icons configuration screen shows the various icons used by the theme, and offers the ability to change the text attributes of the icons, as illustrated in FIG. 32. In other embodiments, users are presented with options to change the graphical nature of the icons, and/or the actions assigned to the icons.

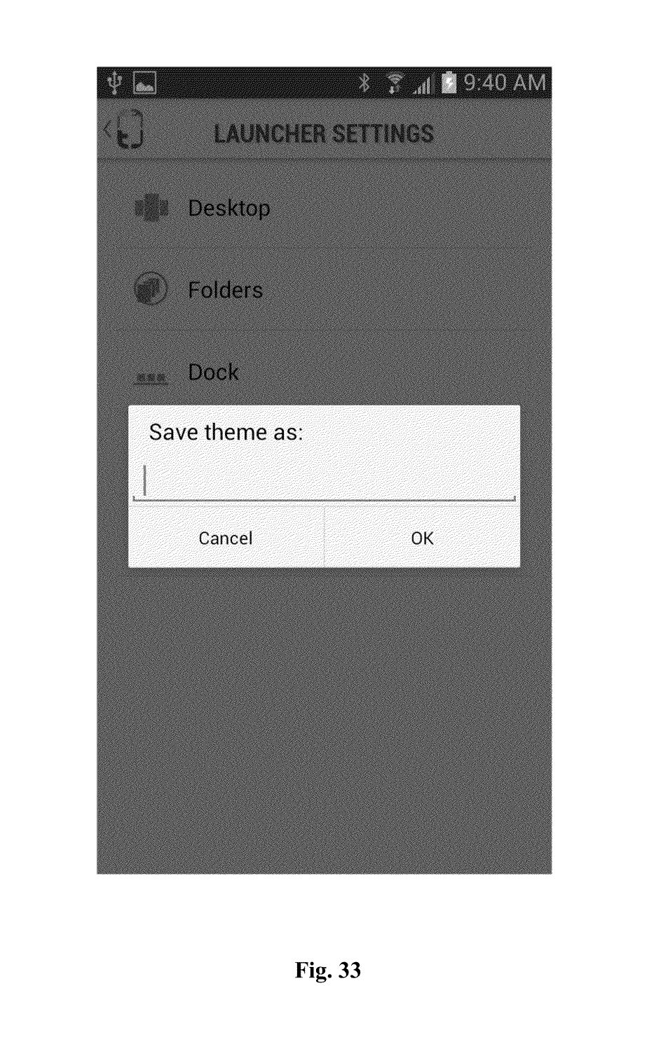

FIG. 33 illustrates one embodiment of the Export Theme screen, accessible from the Launcher Settings menu. Here, the user is requested to provide a name or title for the theme.

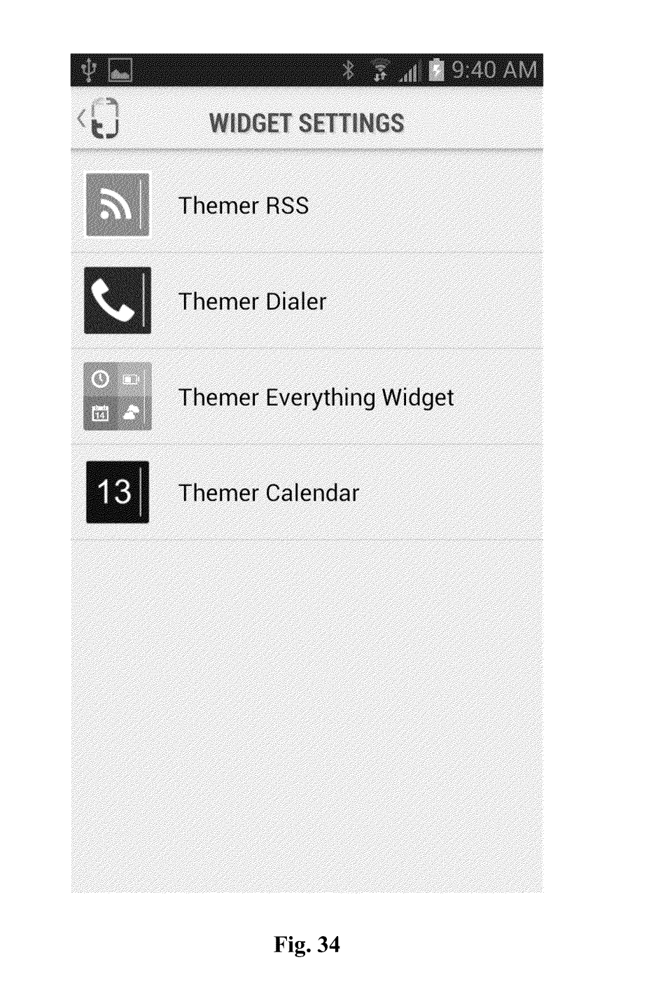

FIG. 34 illustrates one embodiment of the Widget Settings menu, accessible from the Settings component of the Main Menu. In the shown embodiment, the screen shows various widgets, and allows the users to configure their settings. In some embodiments, the list of widgets in the Widget Settings screen may be limited to the widgets configured as part of a theme, whereas in other embodiments, the list may include all widgets available on the mobile device. Other lists, involving a limited amount of widgets are also possible.

### Additional Features

Various embodiments of the Themer App may be configured to provide functionality in addition to that described above. For example, in one embodiment, the Themer App is configured to provide a full set of custom icons packaged together, which can be used to replace all icons on a user's homescreen, app drawer, and/or any other place that icons appear on the device. In another example, icons representing various categories of items are provided, such as, for example, icons for popular apps, system functions, and standard smartphone functions. In another embodiment, a hierarchy of icons is provided, preferably arranged from most specific to generic, and the system is configured to apply the icons to the apps and shortcuts in that order. Thus, for example, when displaying a link to an application, the system would first look for an icon designed by the provider of an application, next moving to a more generic icon for the type of application, perhaps based on the title of the application, moving next to a generic icon indicating a broader category of applications, and being unable to find any of the above icons, settling on a generic application icon. In this embodiment, icons would be categorized in accordance with a particular structure, and would obtain a more consistent appearance.

In another embodiment, the Themer App provides an ‘infinite grid,’ allowing a user to place any widget, icon, graphical asset, folder, or other item on the homescreen in any place, restricted only by the pixel resolution of the device. In this embodiment, standard grid-based limitations of operating systems are eliminated.

In another embodiment, the Themer App automatically categorizes applications based on certain conditions, and stores the applications in various folders, such as games, productivity, ‘Suggested Apps,’ and other categories.

Other embodiments may include additional interface enhancements, such as swipe animations and homescreen transition effects; gesture support for various actions such as launching apps, entering the Themer marketplace, opening the app drawer, or bringing up multi-tasking; or pinch-out commands to see multiple or all homescreens.

Other embodiments may include additional visual configuration options for icons, folders, the app drawer, and dock, including, for example, label text fonts and formatting, shadows, color, shape, animations, homescreen indicators. App Drawers may include settings for groups of apps, swipe animations, colors, pagination, scrolling effects, density (grid-size), opening animation, and the ability to hide certain apps. Docks may include settings for a scrollable dock, dock with ‘pages,’ infant scroll, icon size, and grid size. In certain embodiments, the launcher may be retained in memory so as not to redraw, thereby improving performance. In addition, in some embodiments the launcher options may be applied on a per-homescreen, as opposed to a per-theme, basis.

### Everything Widget

Several embodiments of the disclosed system may be referred to as an Everything Widget. In general terms, the Everything Widget is a graphical user interface that provides significant customizability to the end user, and offers several unique features that permit unprecedented integration with the disclosed system, also referred to as the Themer App in several embodiments. The Everything Widget offers a number of advantages over previously available widgets and other graphical interfaces, including robust features described herein and the ability to preview the interface as it is being customized by the user. In the preferred embodiment, one or more Everything Widgets may be placed on a screen, the widgets being capable of having varying sizes, content, and interactivity.

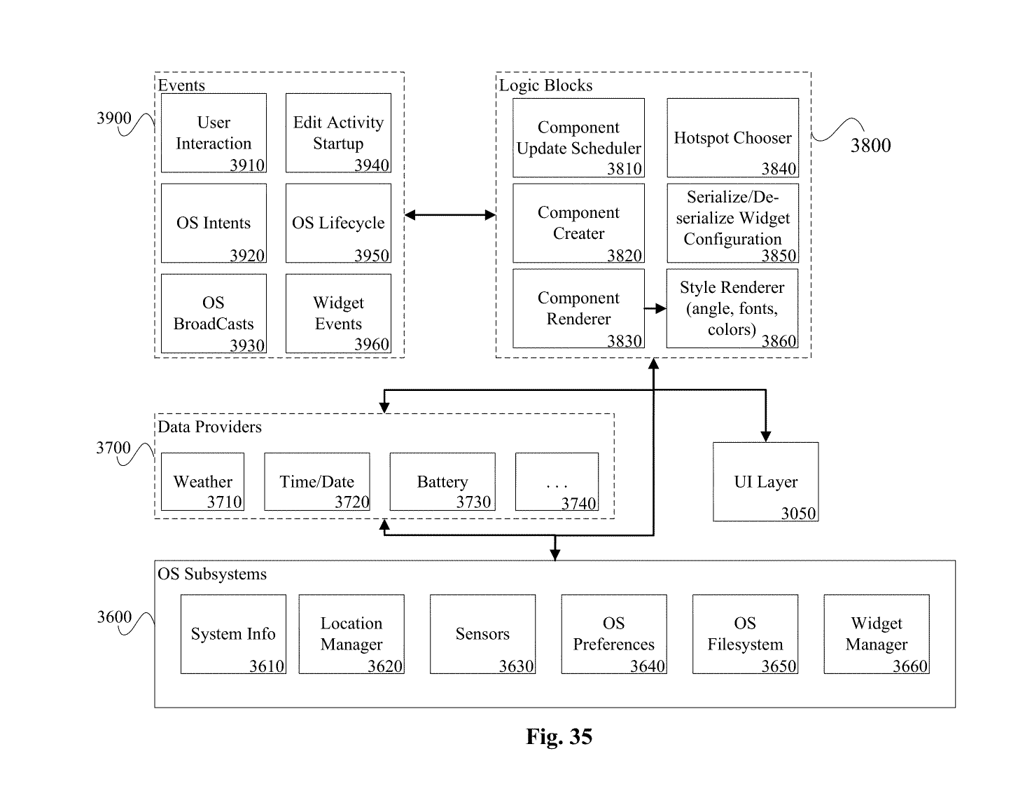

The system architecture of the Everything Widget is shown in FIG. 35. As illustrated in FIG. 35, in the preferred embodiment the Everything Widget relies on various components of a computing system, including the underlying hardware, operating system, and applications. More specifically, these components include Android Subsystems 3600, Data Providers 3700, UI Layer 3050, Logic Blocks 3800, and Events 3900.

Turning to OS Subsystems 3600, some of the illustrated modules include System Info 3610, which provides information regarding the current hardware, software, and their state; Location Manager 3620, which provides information regarding the device's location; Sensors 3630, which may include cameras, microphones, accelerometers, barometers, altimeters, fingerprint scanners, and other sensors; OS Preferences 3640, which include various OS settings and configuration parameters; OS Filesystem 3650, which is used to manage certain aspects of data storage on the device; and Widget Manager 3660, which manages the various widgets that may appear on the device's homescreens.

The Everything Widget may also interact with certain Data Providers 3700, including Weather 3710, which provides weather information such as temperature readings, sky conditions, and forecasts; Time/Date 3720, which provides appropriate time, date, and year information; Battery 3730, which may provide information regarding the charging status of the battery, its capacity, and charge level; and other data providers 3740. The Everything Widget also interacts with the UI Layer 3050, the hierarchy of which was described in FIG. 7 and accompanying text.

When running, the Everything Widget spawns several processes, some of which correspond to Logic Blocks 3800, including Component Update Scheduler 3810, which may establish a schedule with which various components of the widget are updated; Component Creator 3820, which prepares data objects and other services necessary to create components of the widget; Component Renderer 3830, which outputs the components of the widget to a screen; Hotspot Chooser 3840, which allows the user to attach a click action to a component; Serialize/De-serialize Widget Configuration 3850, which enables users to save, load, and/or export their configuration of the Everything Widget; and Style Renderer 3860, which may establish the angles, fonts, colors, and other visual attributes of widget components.

In addition to presenting information to a user, the Everything Widget reacts to various events, some of which are illustrated in block 3900. For example, User Interaction 3910 is an event that may require the Everything Widget to deal with a user interaction; OS Intents 3920 that may require the Themer App to respond to a system intent; OS Broadcasts 3930 that may signal or transmit a message from or to the OS; Edit Activity Startup 3940 that events that kick off initialization procedures; OS Lifecycle 3950 events that signal to the Editor App that it should change its state (paused, resumed, exited); and Widget Events 3960 that may indicate an interaction with a widget, a scheduled update, or a change in widget state. While not shown in FIG. 35, Events 3900 may also include implementation and platform specific listeners.

It should be noted that the lines connecting elements 3050, 3600, 3700, 3800, and 3900 in FIG. 35 do not necessarily represent logical or physical connections. Rather, the lines are used to illustrate conceptual interfaces and interactions between various system modules. In addition, one of ordinary skill in the art will recognize that other components, some of which have not been shown in FIG. 35, may play a role in the operation of the device.

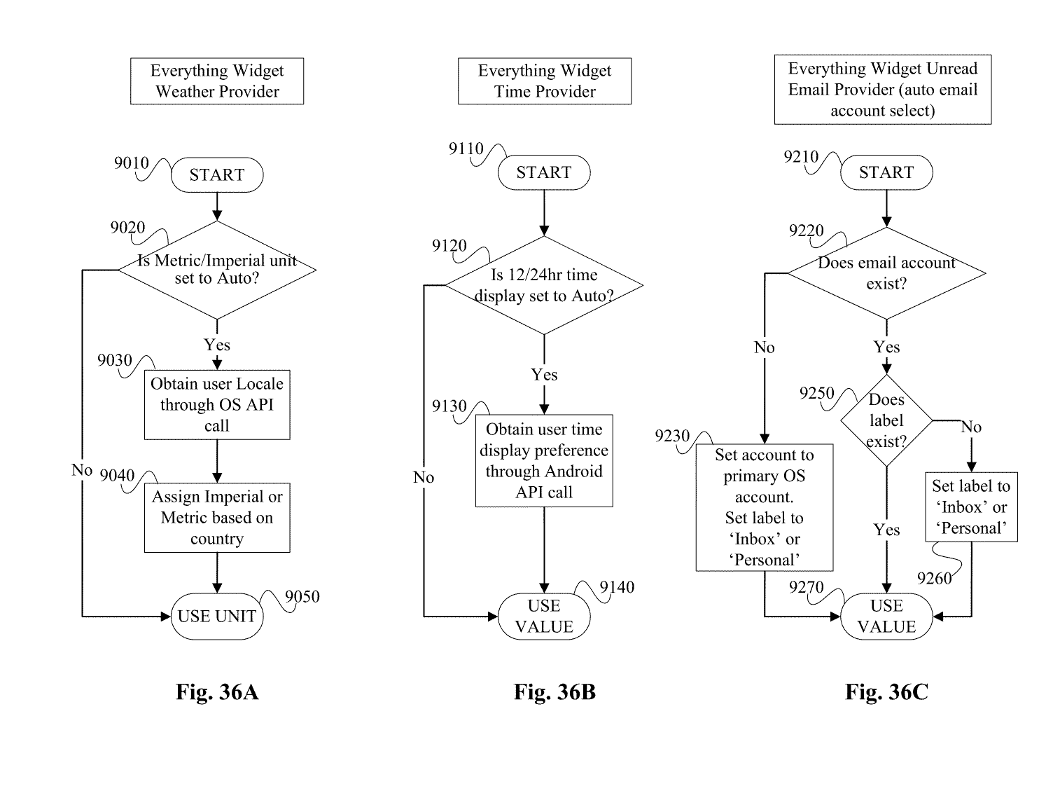

While Everything Widget, in many embodiments, provides the user with significant ability to customize various aspects of the widget, it may also include certain automated operations that reduce the workload on a user as compared to previously available graphical user interfaces. Some of these automated features are illustrated in FIGS. 36A-C. These features enable the Everything Widget to provide a current, and relevant experience to a user, without being adversely affected by location, time-zone, and other changes.

FIG. 36A is a flowchart illustrating one embodiment of an automatic settings process for the Everything Widget Weather Provider based on user and locale changes. After the process starts at step 9010, the Everything Widget determines at step 9020 whether the Metric/Imperial unit selection has been set to Auto. If the unit selection parameter has not been set to Auto, the Everything Widget proceeds to use the default units. If the unit selection parameter has been set to Auto, at step 9030 the system obtains the user and device's Locale, or location, through an OS API call. At step 9040, the system assigns imperial or metric units based on the location information, such as the country where the device is located, obtained from the OS. At step 9050, the Everything Widget proceeds to use the assigned units.

FIG. 36B is a flowchart illustrating one embodiment of an automatic settings process for the Everything Widget Time Provider based on user and locale changes. After the process starts at step 9110, the Everything Widget determines at step 9120 whether the 12/24 hour display setting parameter is set to Auto. If no, the widget uses the default value used until that point at step 9140. If yes, then the system obtains the user's time display preferences through an OS API call at step 9130, and uses the obtained preferences at step 9140.

FIG. 36C is a flowchart illustrating one embodiment of an automatic settings process for the Everything Widget Unread Email Provider based on user and locale changes. After the process starts at step 9210, the Everything Widget determines at step 9220 whether an email account exists on the device or the current Themer or Launcher system. If no email account exists, at step 9230 the system sets the email account to the primary OS account, and sets the corresponding label to, for example, ‘Inbox’ or ‘Personal.’ At step 9270, the system uses the selected account. If at step 9220, an email account exists, the system checks whether a label for the account exists at step 9250. If no label exists, at step 9260 the Everything Widget sets the label to, for example, ‘Inbox’ or ‘Personal, and uses the selected account at step 9270. If at step 9250 the email account already has a label, Everything Widget proceeds to use the account at step 9270.

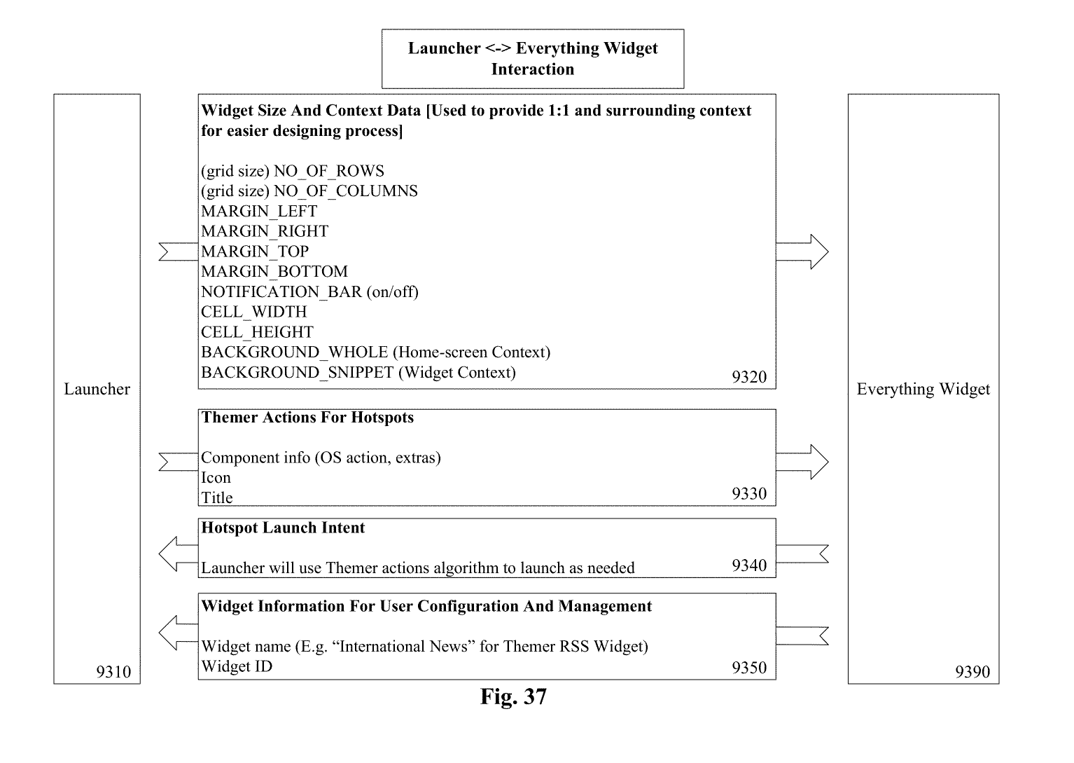

As noted above, one of the unique features of the Everything Widget is the ability to provide a full preview of the widget to the user as the widget is being configured. In the preferred embodiment, this feature is enabled by specially configured interactions between the Everything Widget, and the underlying interface system, such as the Themer App, or another launcher compatible with the widget. One example of these interactions is illustrated in FIG. 37. The left side of the diagram shows Launcher 9310, and the right side shows Everything Widget 9390. As shown in the figure, Launcher 9310 submits Widget Size And Context Data 9320, and Themer Actions for Hotspots 9330 to Everything Widget 9390. Widget Size And Context Data 9320 is used to provide a 1:1 and surrounding context for the user for an easier widget design and customization process. The parameters passed along in element 9320, such as NO_OF_ROWS, NO_OF_COLUMNS, MARGIN_LEFT, MARGIN_RIGHT, MARGIN_TOP, MARGIN_BOTTOM, NOTIFICATION_BAR, CELL_WIDTH, CELL_HEIGHT, BACKGROUND_WHOLE, and BACKGROUND_SNIPPET enable the system to construct a preview of the widget as the user modifies its various aspects. Parameters passed in the Themer Actions For Hotspots 9330 include component information, icons, and titles that are used to create the hotspots in the widget.

In the reverse direction, Everything Widget 9390 sends Hotspot Launch Intent 9340 and Widget Information For User Configuration And Management 9350 to Launcher 9310. Hotspot Launch Intent 9340 sends various commands to Launcher 9310 to execute as needed, and Widget Information For User Configuration And Management 9350 submits the Widget name and Widget ID to Launcher 9310 to integrate the widget with the underlying Launcher and OS.

The visual interface of the Everything Widget, its configuration options, and the computing engine used to render the widget are described next. As noted earlier, the Everything Widget may be configured to be of different size, content and interactivity. Several Everything Widgets may be combined into a single theme, as one example of an application of the Themer App.

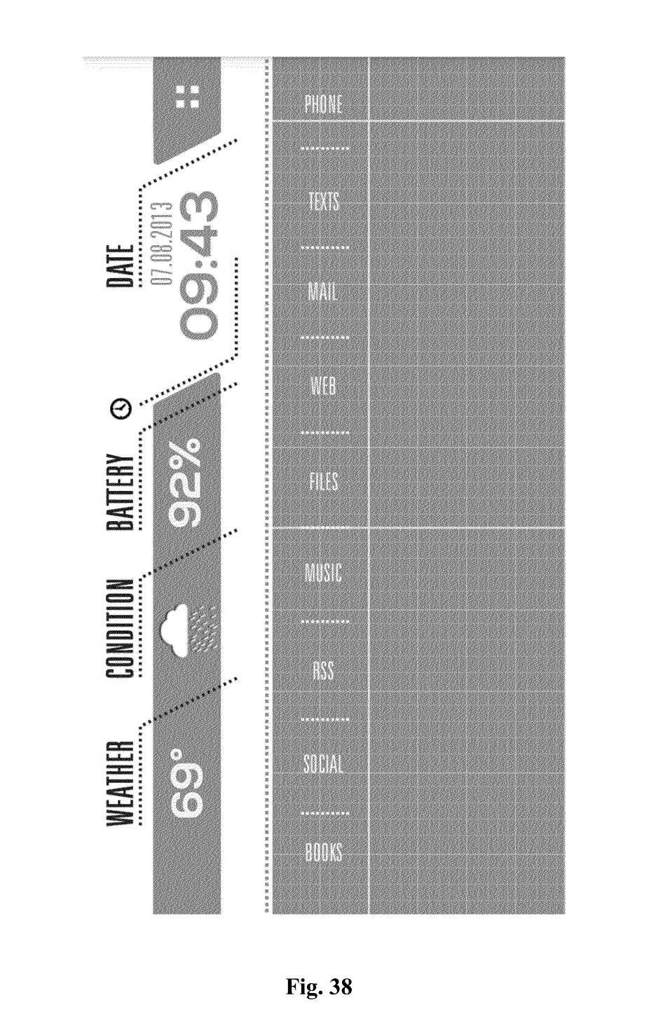

FIG. 38 illustrates one embodiment of a theme comprising several Everything Widgets. As shown, a separate Everything Widget is used to display the temperature, weather condition (illustrated by a cloud), the battery charge percentage, the time, the date, and several other elements of the theme.

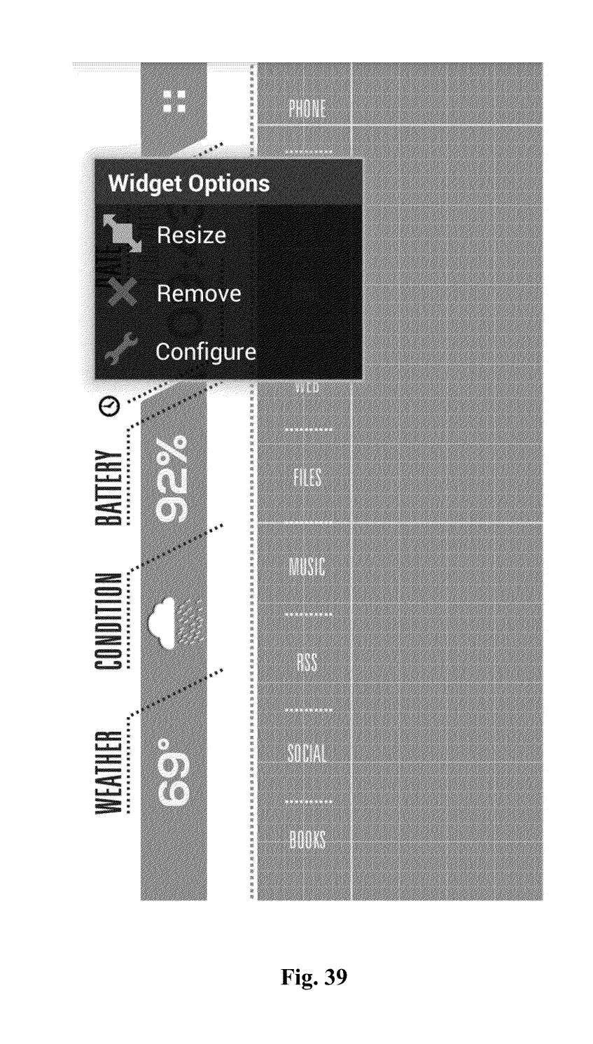

FIG. 39 illustrates one embodiment of a theme comprising several Everything Widgets reacting to a long press on one of the widgets by providing the user with options to Resize, Remove, or Configure the widget. In the preferred embodiment, each widget is capable of providing independent options to the user.

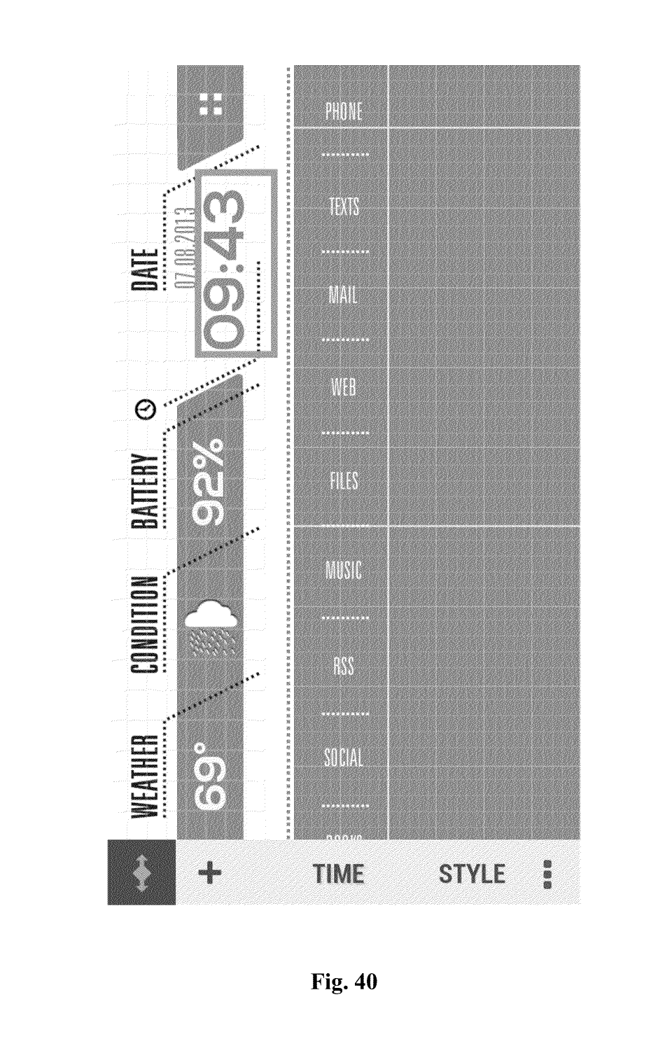

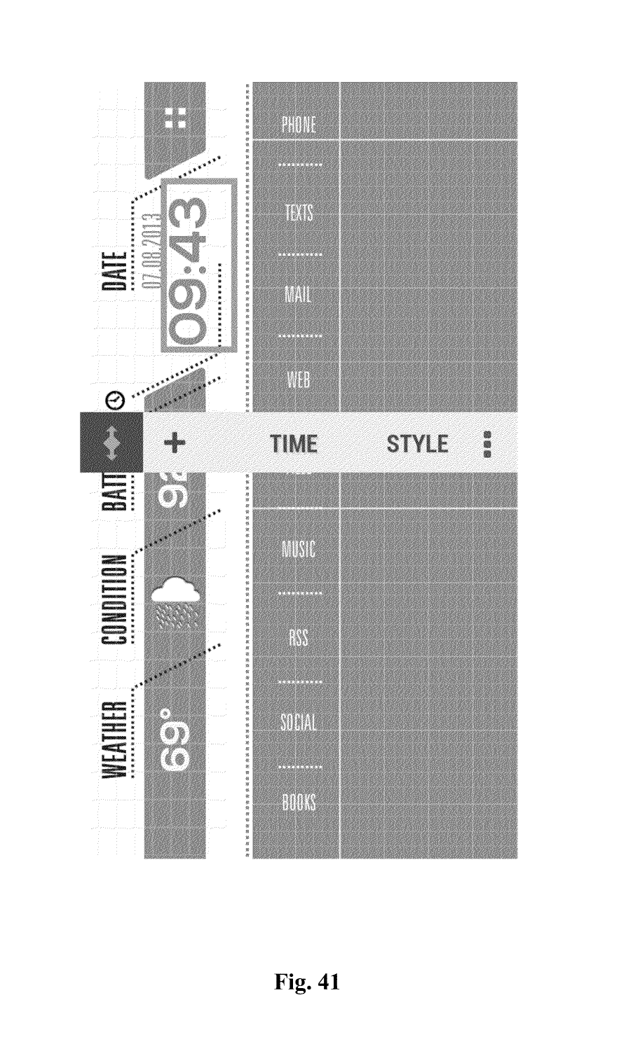

FIG. 40 illustrates one embodiment of a theme comprising several Everything Widgets with the editor bar overlay and a selected widget. Here, the selected widget provides time, as indicated by a rectangular bar surrounding the widget. The editor bar appears at the bottom of the screen. In the preferred embodiment, the editor bar appears in response to the selection of the Configure option illustrated in FIG. 39. FIG. 41 illustrates one embodiment of the editor bar overlay from FIG. 40 sliding to a different position.

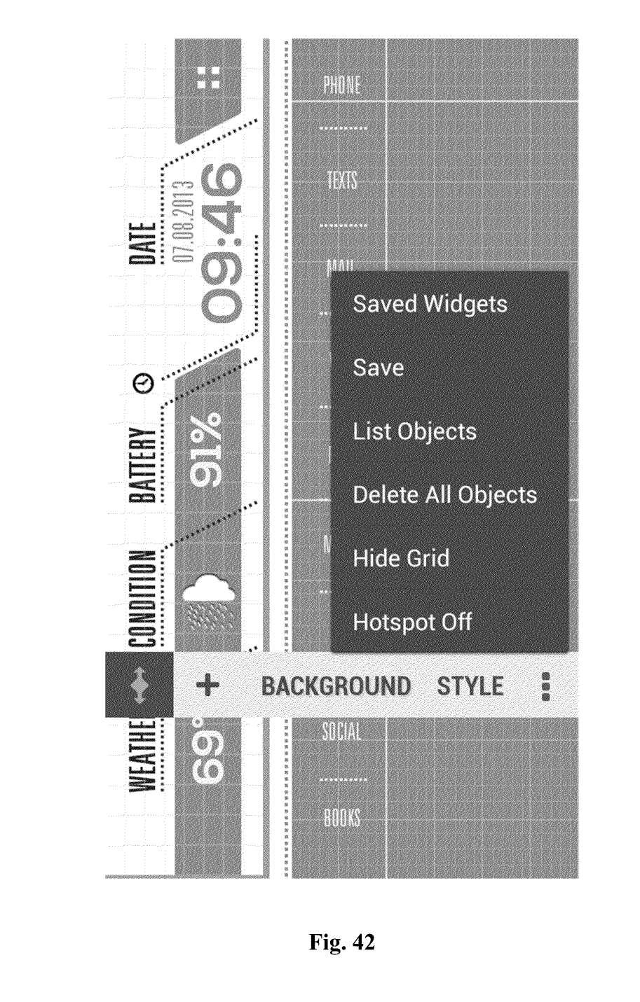

FIG. 42 illustrates one embodiment of the overflow menu from the editor bar, displayed in response to a user selecting the three dots arranged vertically at the right-hand side of the editor bar.

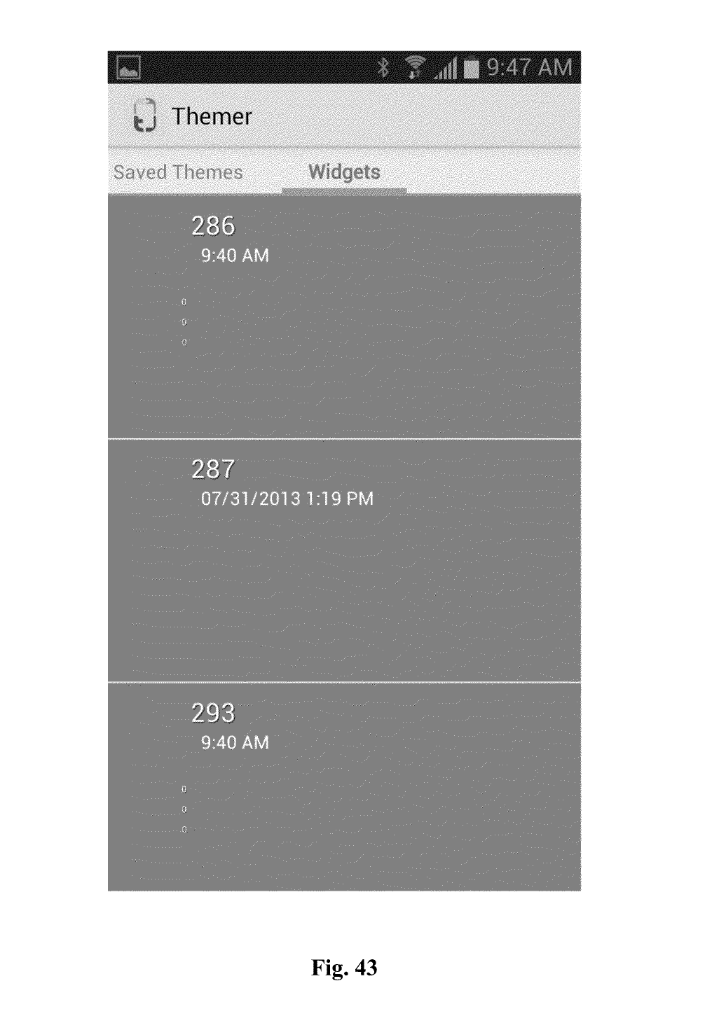

FIG. 43 illustrates one embodiment of the Saved Widgets component of the editor bar's overflow menu. Here, the widgets that have been configured and saved by the user are displayed to the user for future or current use.

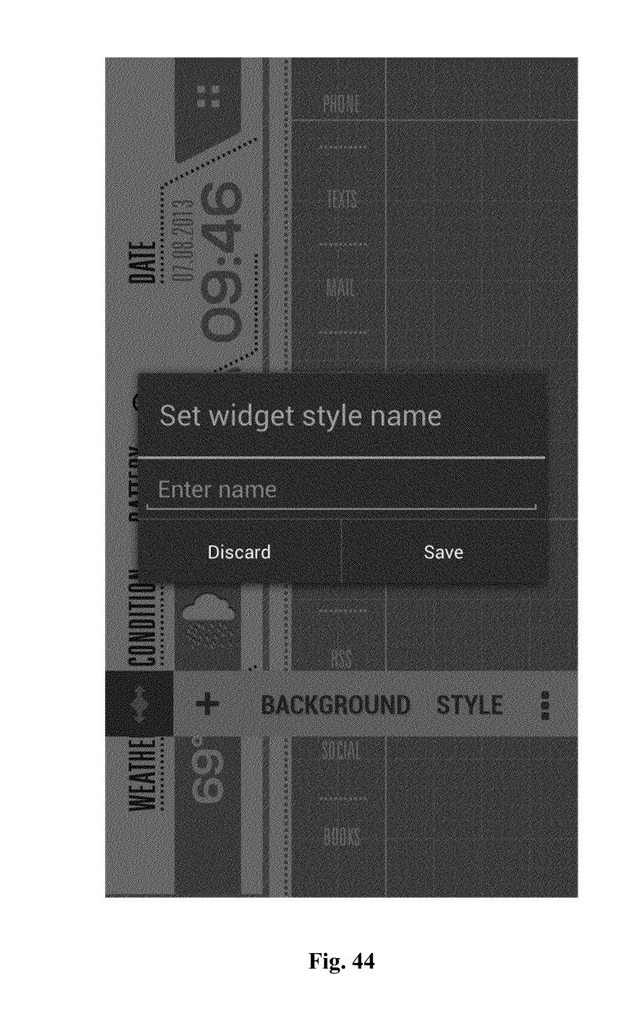

FIG. 44 illustrates one embodiment of the Save component of the editor bar's overflow menu. Here, a user is provided with an opportunity to provide a name for the configured widget.

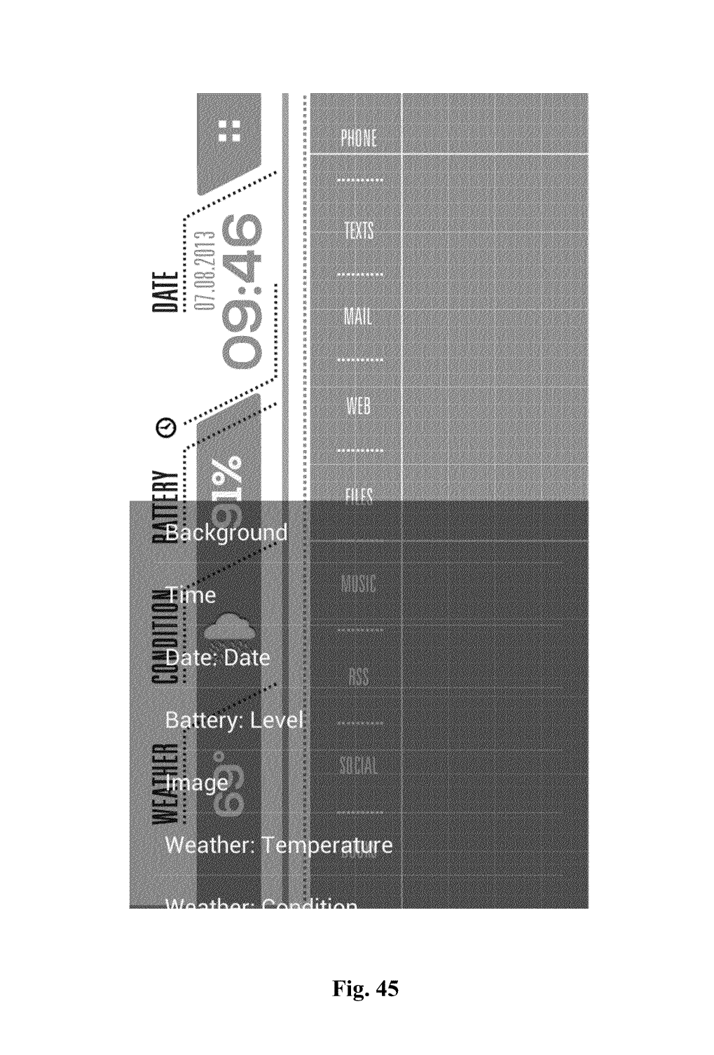

FIG. 45 illustrates one embodiment of the List Objects component of the editor bar's overflow menu. Here, in response to the selection of List Objects on the widget editor's overflow menu, a list of various objects comprising the widget appear at the bottom of the screen.

As noted in the discussion of the Everything Widget's architecture, one aspect of the widget is its ability to display data on the screen. In the preferred embodiment, visual elements that provide data to the screen are referred to as data providers. In other embodiments, data providers need not be of a visual nature, and may instead be, for example, data objects, or audio objects.

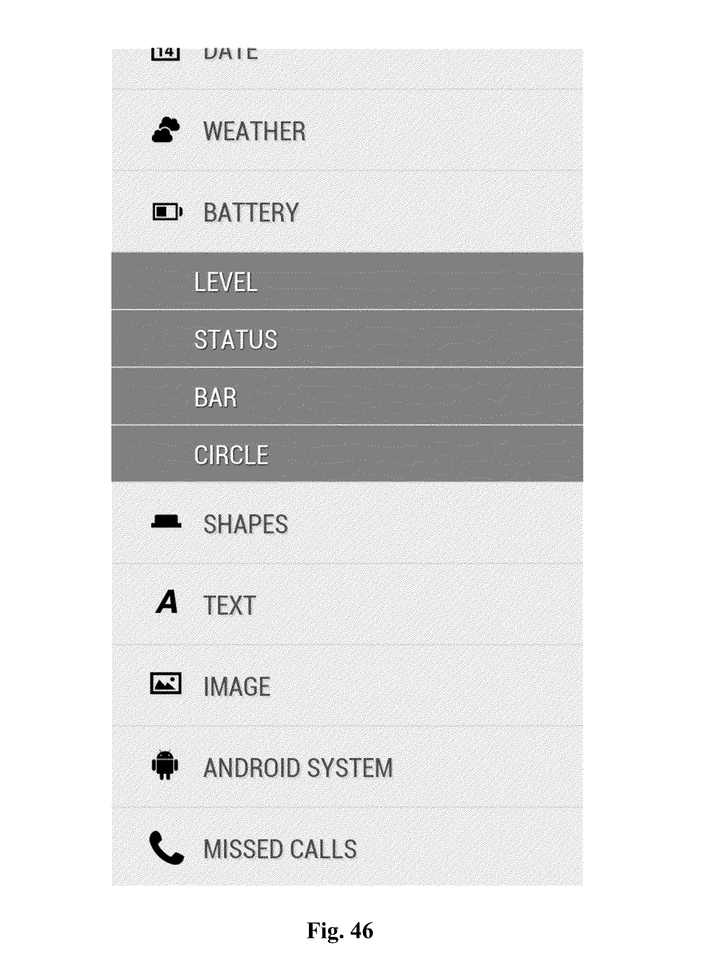

Turning to various data providers that may be utilized with an Everything Widget, FIG. 46 illustrates one embodiment of the available Battery data providers, such as those that provide battery charge information in the form of, for example, a level, status, bar, or circle.

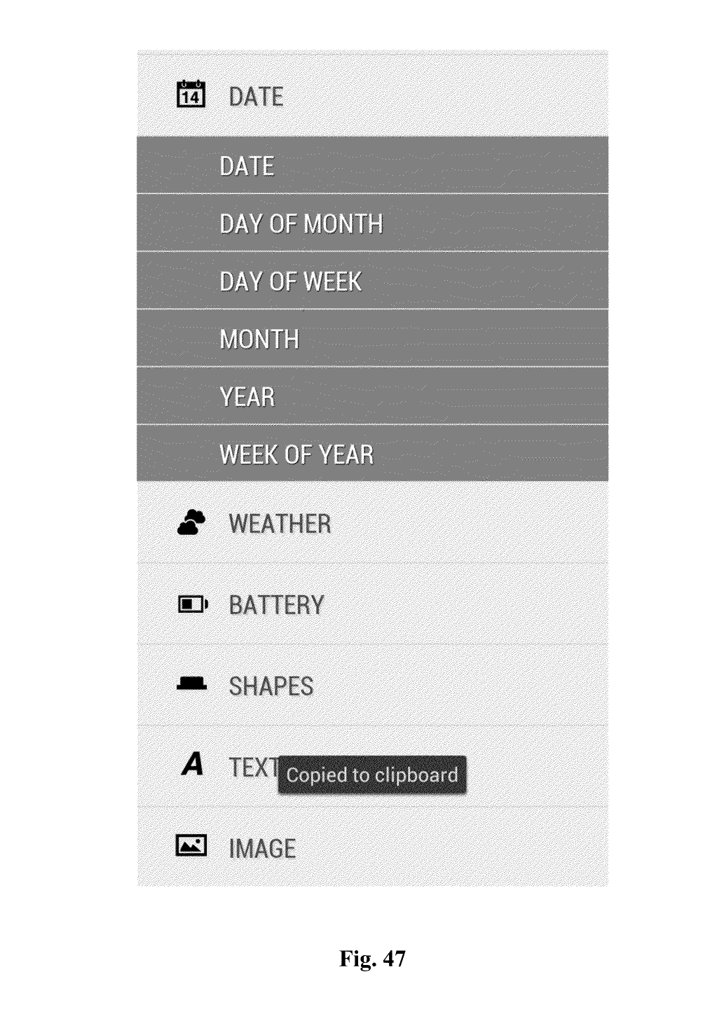

FIG. 47 illustrates one embodiment of the available Date data providers, such as those that display the date, day of month, day of week, month, year, or week of year.

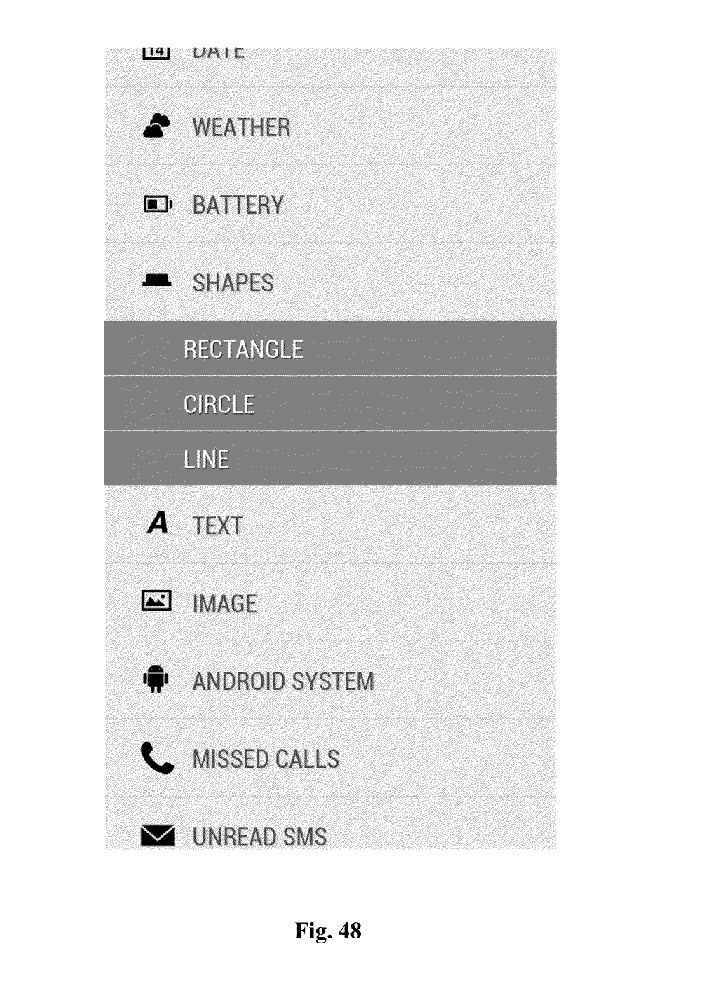

FIG. 48 illustrates one embodiment of the available Shapes data providers, which are not preconfigured to provide a certain type of data, but may be customized by the user or designer to display various data in the shape of a rectangle, circle, or line.

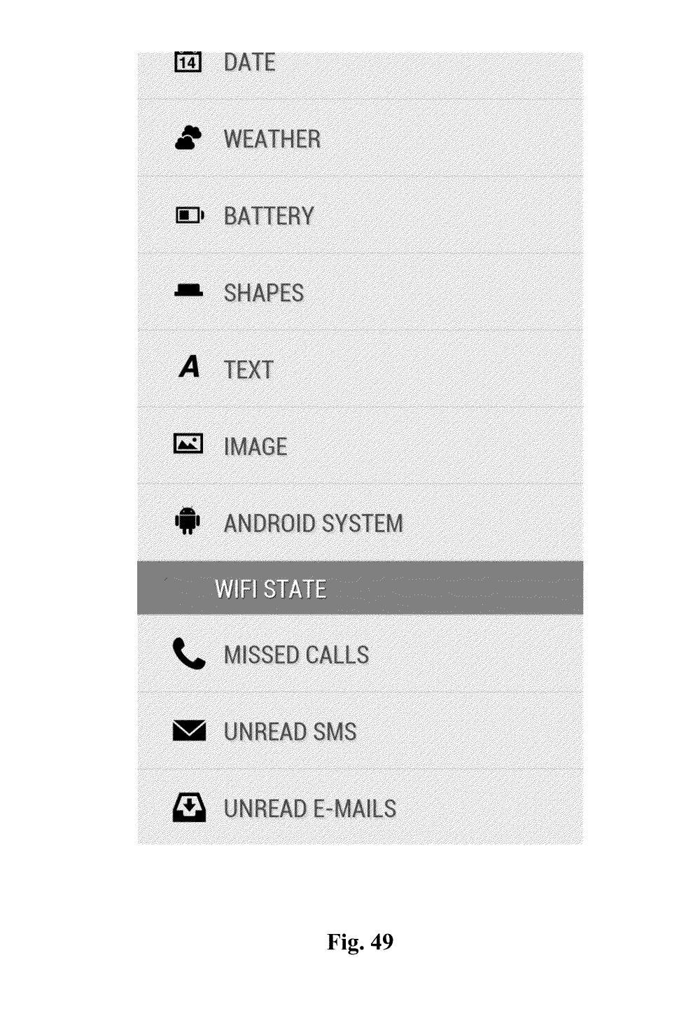

FIG. 49 illustrates one embodiment of the available System data providers, such as, for example, the WiFi state indicator.

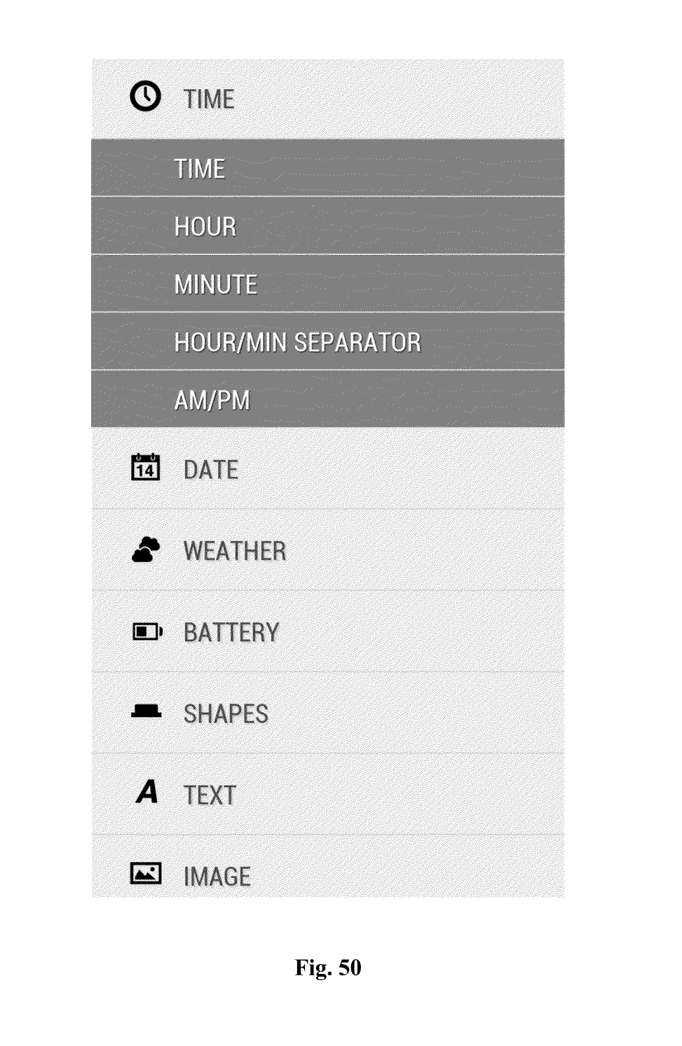

FIG. 50 illustrates one embodiment of the available Time data providers, such as, for example, the Time, Hour, Minute, AM/PM indicators, or the Hour/Minute separator.

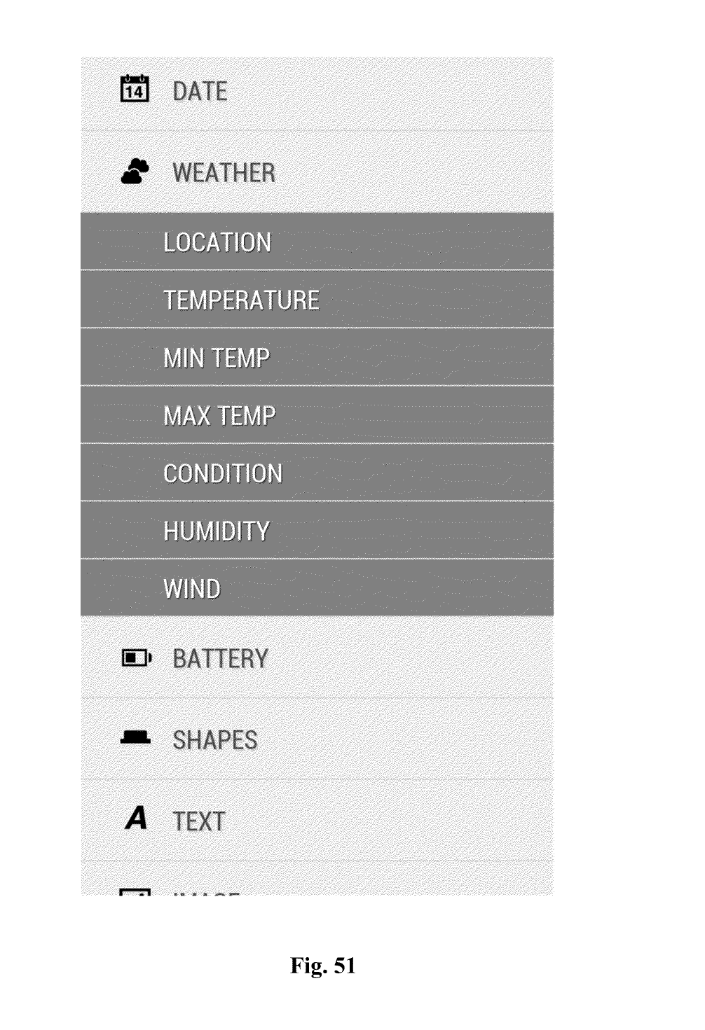

FIG. 51 illustrates one embodiment of the available Weather data providers, such as, for example, location, temperature, minimum temperature, maximum temperature, condition, humidity, or wind indicators.

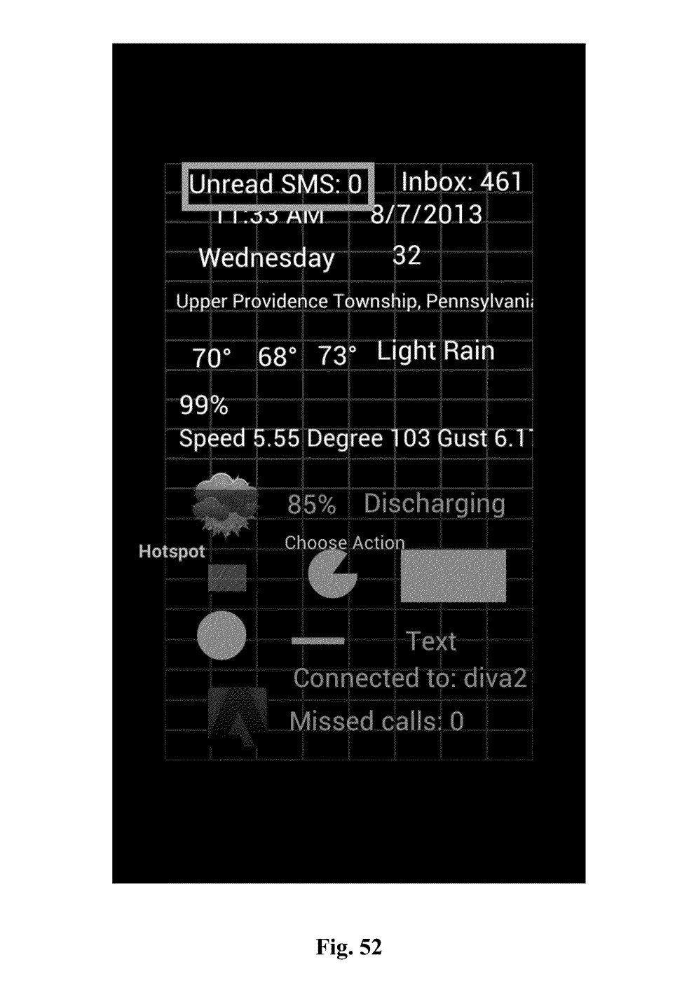

In the preferred embodiment, Everything Widgets may include a “hotspot,” or an area that may be configured to react in a preconfigured fashion to user input, such as a touch, or a swipe, of the hotspot area. When configuring the widget, a user or theme designer may configure the hotspot through various option screens. FIG. 52 illustrates one embodiment of the hotspot options menu, presenting the user with an option to choose an action for the hotspot, and illustrating an overlay of the menu over the widget being configured. The overlay allows the user to see the widget as it is being configured, and is one example of how the Everything Widget enables easier widget configuration.

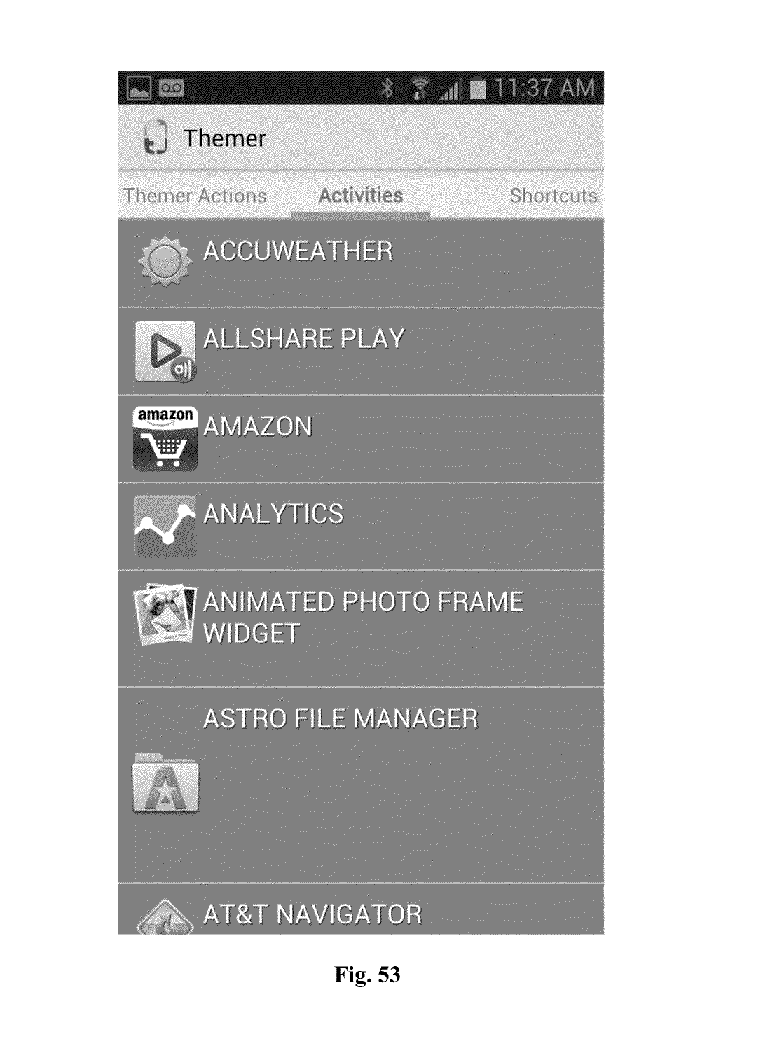

FIG. 53 illustrates one embodiment of the available hotspot activities, which may include various apps, widgets, website links, and other data objects.

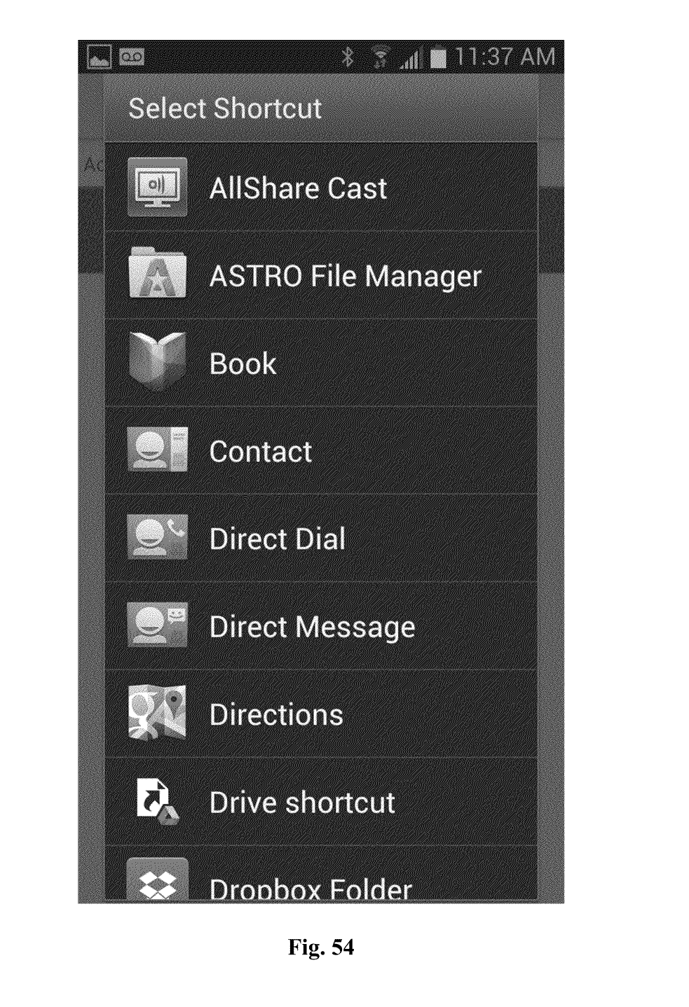

FIG. 54 illustrates one embodiment of the available hotspot shortcuts. In the preferred embodiment, the presented shortcuts are obtained from the operating system, underlying launcher, or both.

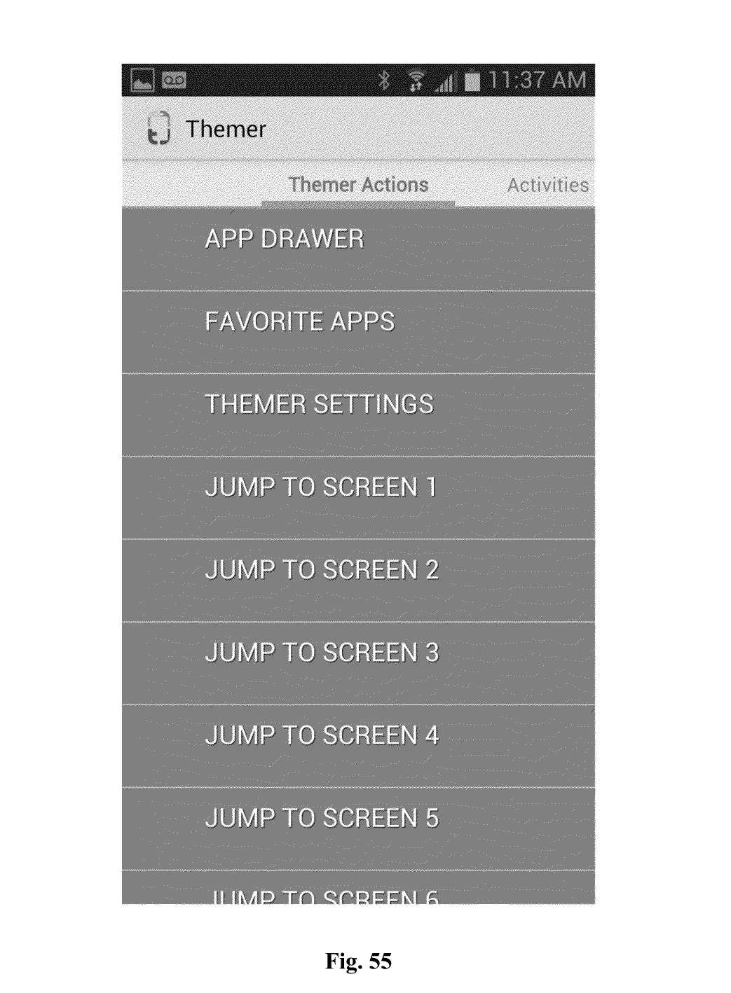

FIG. 55 illustrates one embodiment of the available hotspot Themer actions, including the ability to jump to the app drawer, favorite apps, Themer settings, or various homescreens.

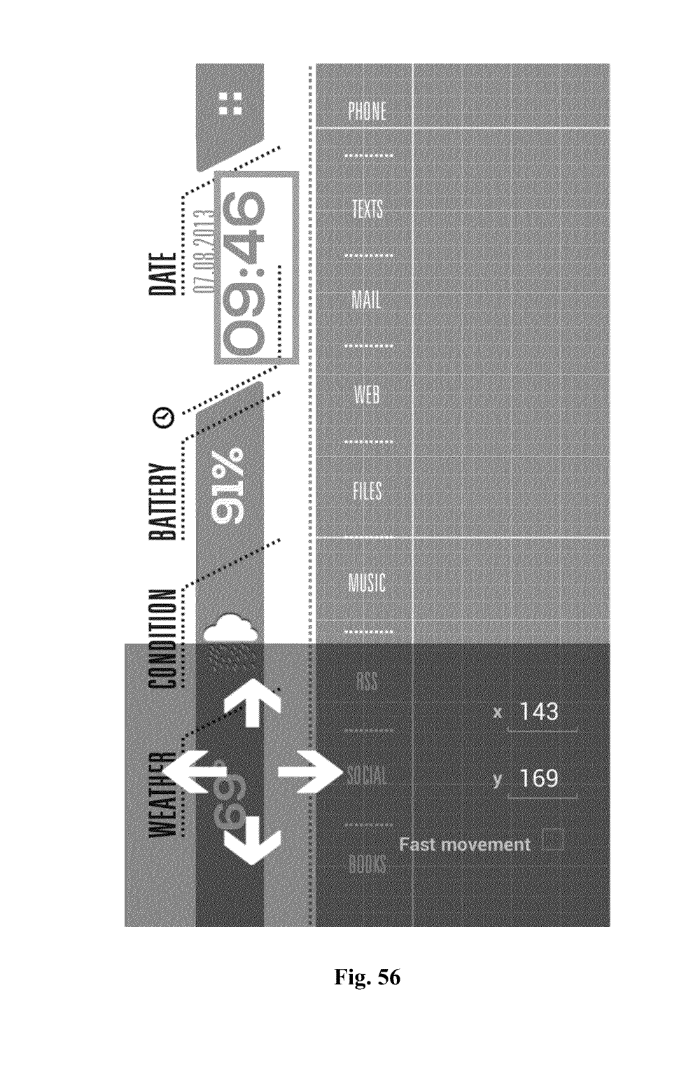

FIG. 56 illustrates one embodiment of the widget positioning interface, which presents the user or designer with the ability to slowly position the widget using on-screen arrow keys, or to select a fast movement checkbox, which will enable faster positioning. In this embodiment, the widget coordinates are also displayed while positioning.

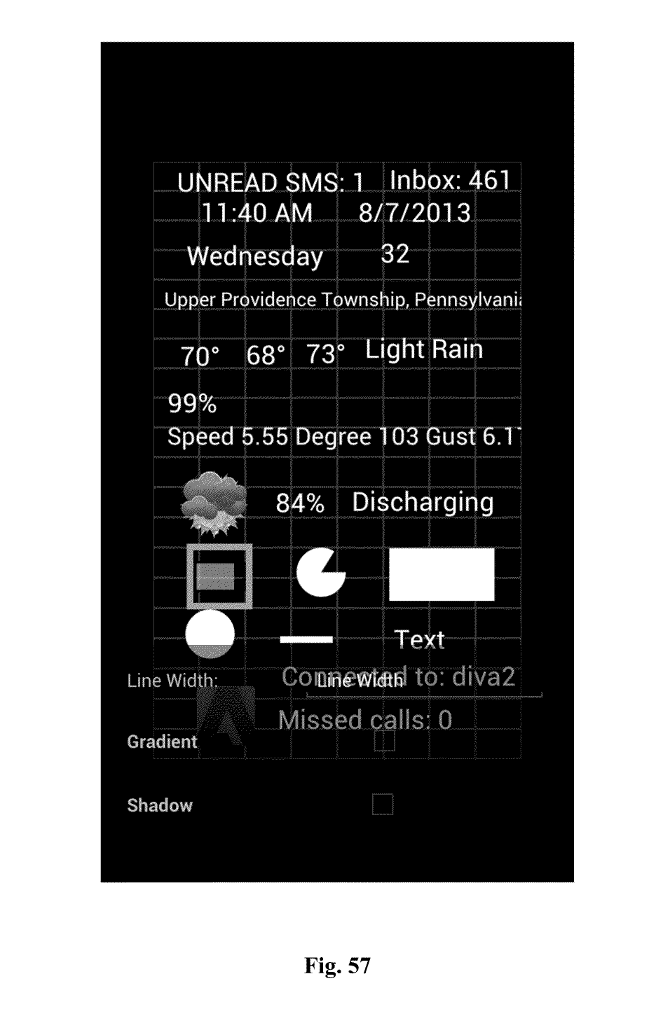

FIG. 57 illustrates one embodiment of available settings for a displayed battery bar, such as, for example, the line width, gradient, and shadow.

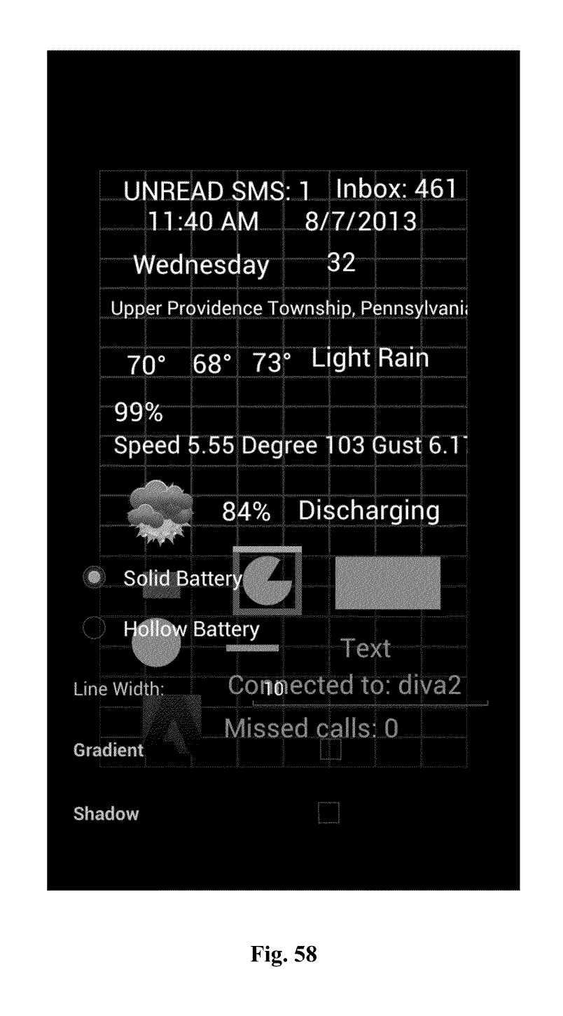

FIG. 58 illustrates one embodiment of available settings for a displayed battery circle, such as, for example, the line width, gradient, and shadow.

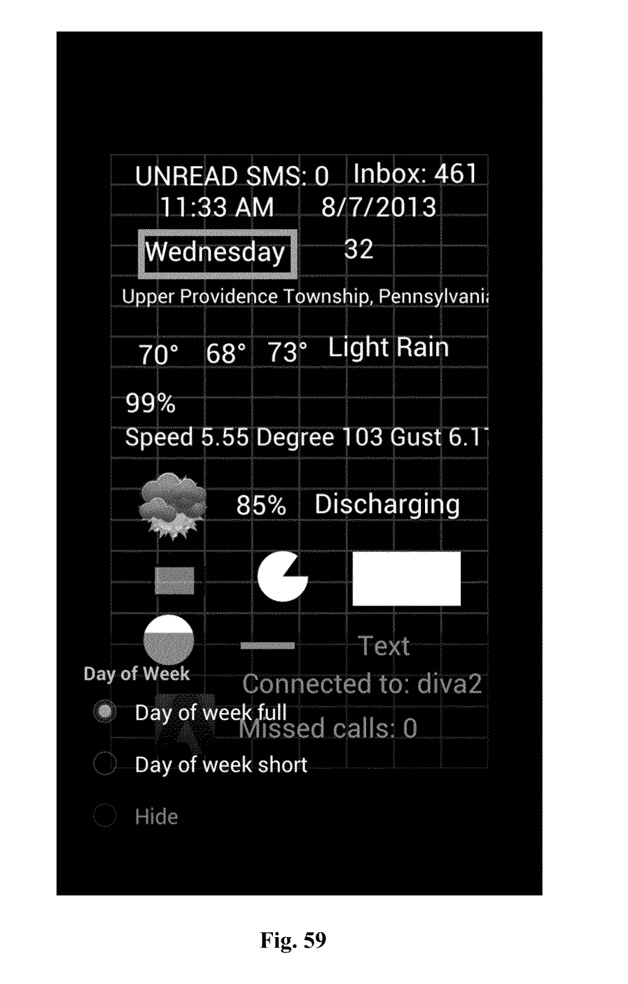

FIG. 59 illustrates one embodiment of available settings for a displayed day of the week, such as, for example, the options to display a full day of week, a shortened day, or to hide the data provider completely.

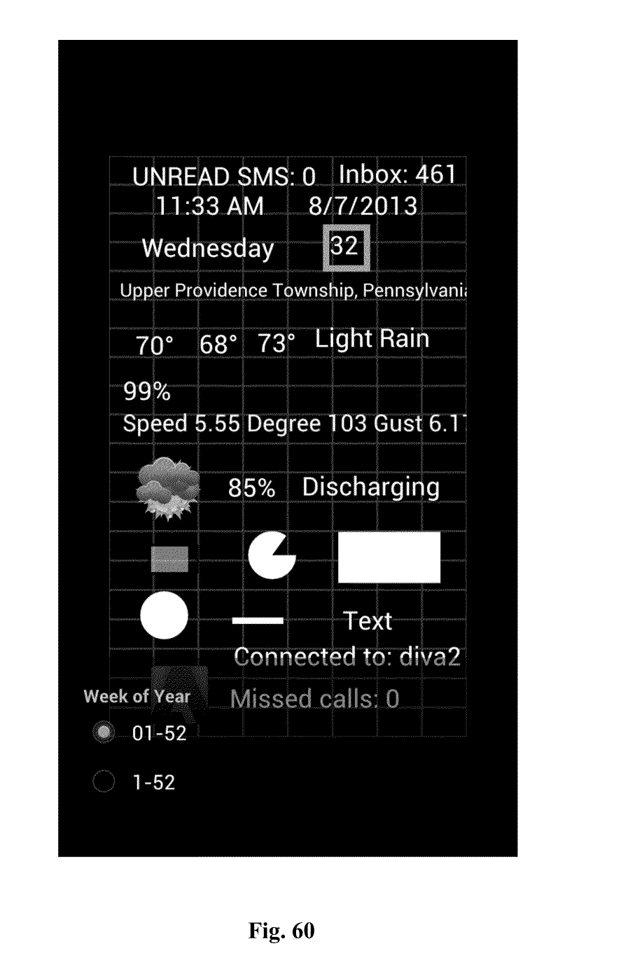

FIG. 60 illustrates one embodiment of available settings for a displayed week of the year, such as, for example, displaying weeks as 01-52 or 1-52.

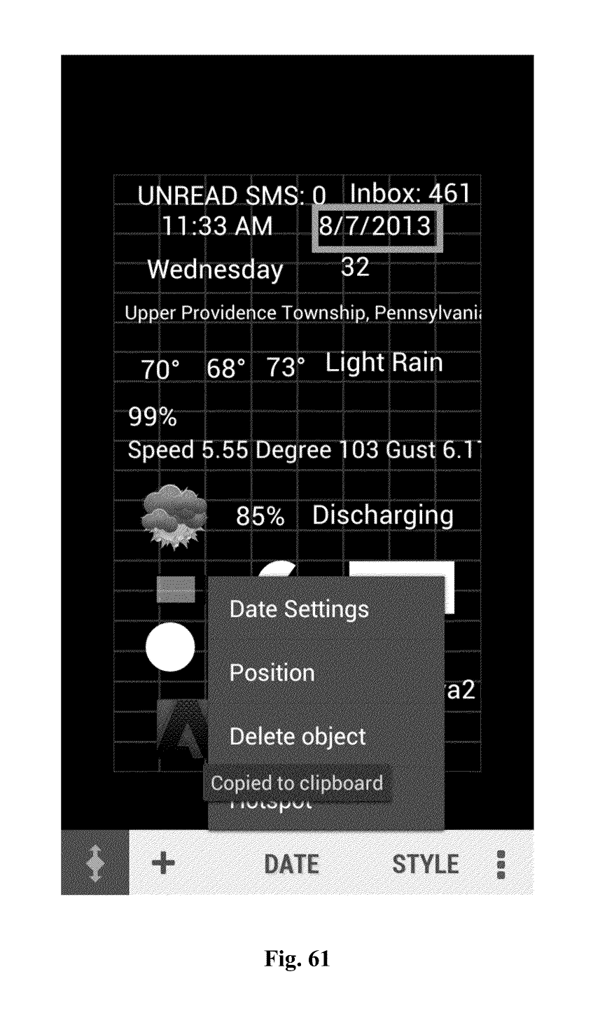

FIG. 61 illustrates one embodiment of an options menu for a displayed date, including options for Date Settings, Position, Object deletion, or Hotspot.

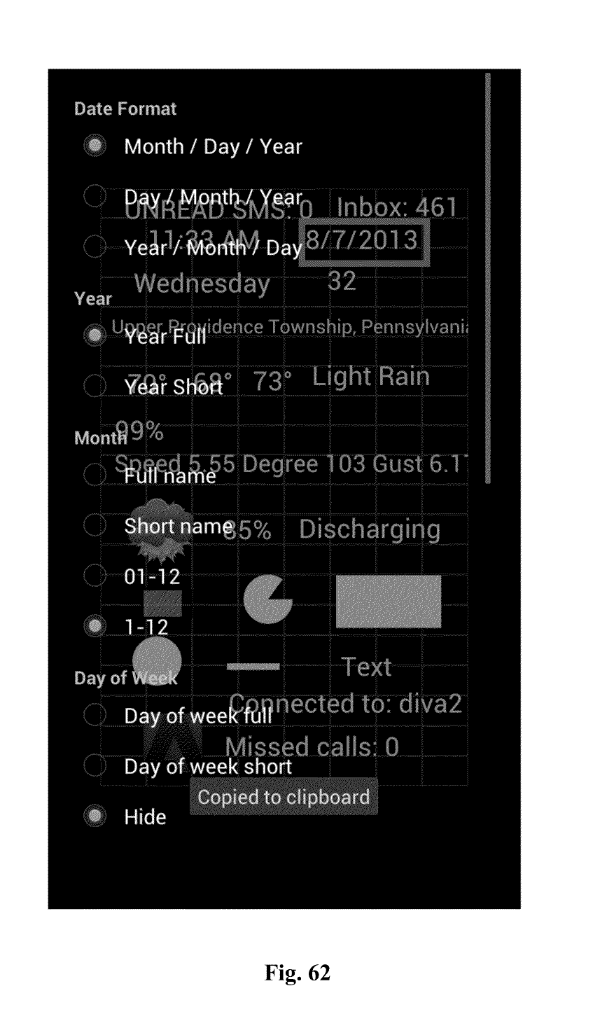

FIG. 62 illustrates one embodiment of available settings for a displayed date, such as, for example, format of the date, year, month, or day of the week.

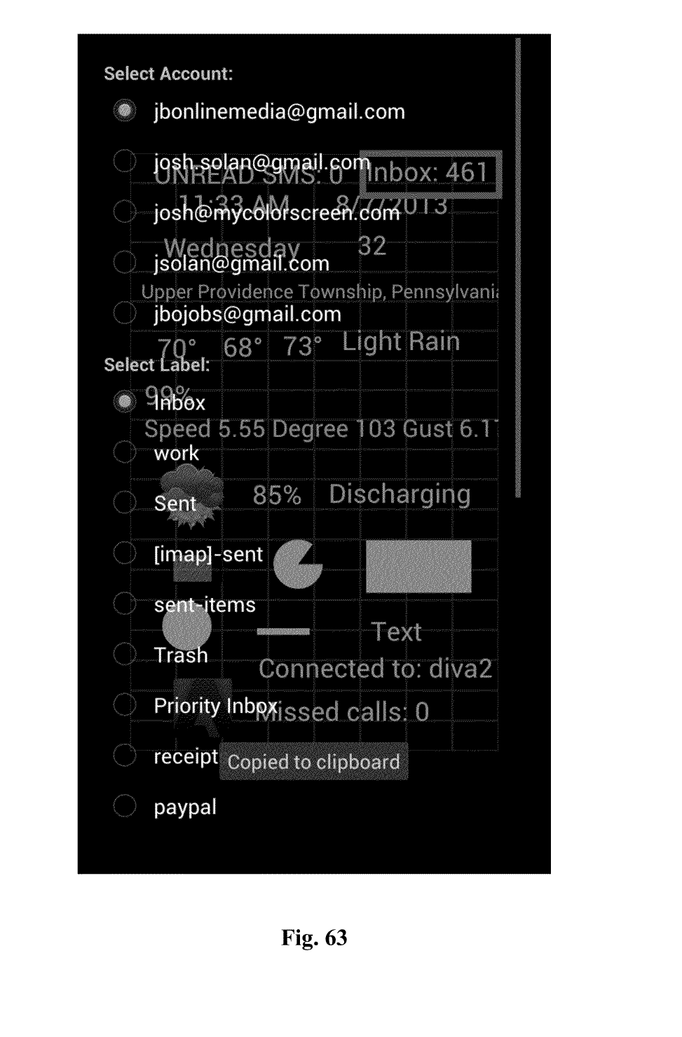

FIG. 63 illustrates one embodiment of available settings for an unread email component, such as, for example, a selected email account, and a label, if chosen by the user.

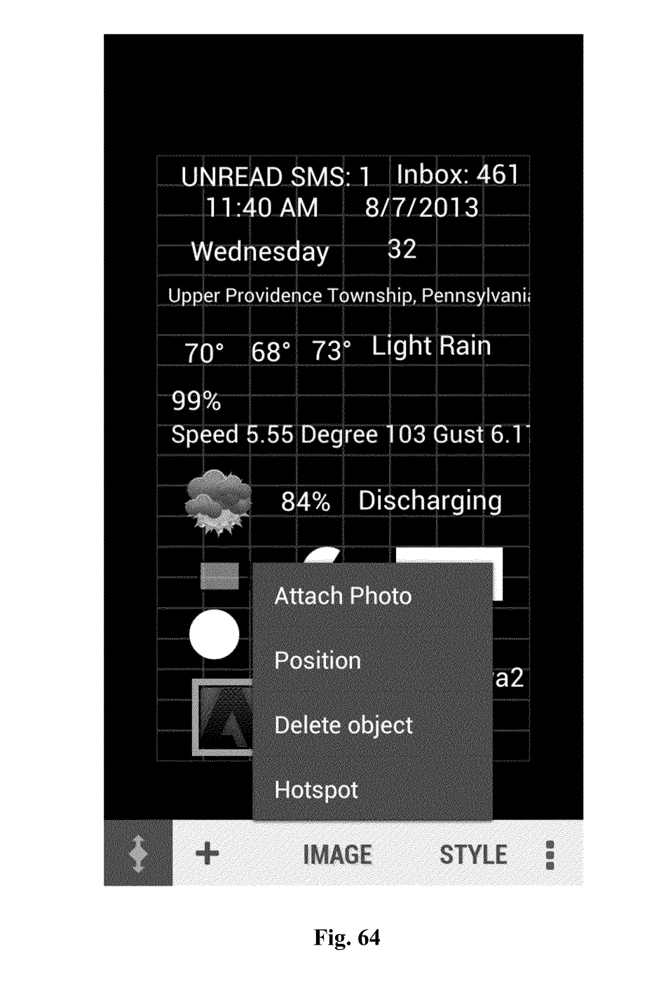

FIG. 64 illustrates one embodiment of an options menu for a displayed image, including options for Photo attachment, Position, Object deletion, and Hotspot.

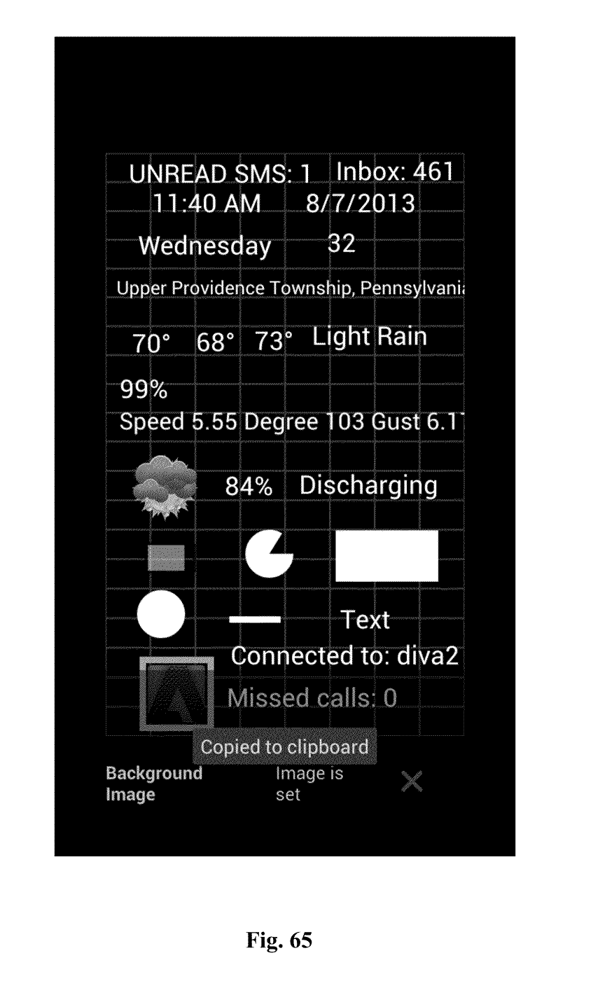

FIG. 65 illustrates one embodiment of a photo attachment interface, where, in the preferred embodiment, the user may select a background image for the object.

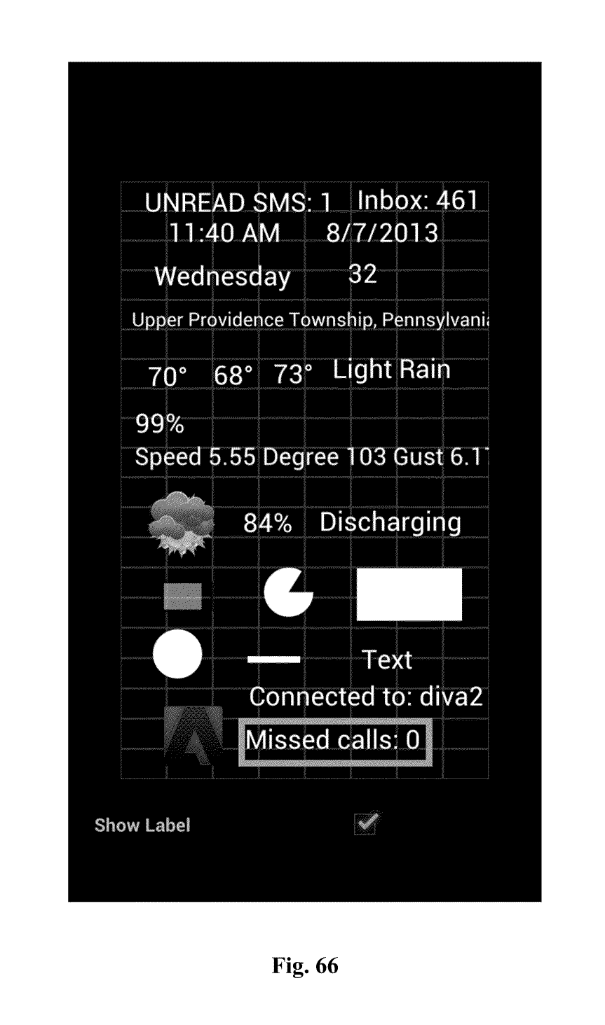

FIG. 66 illustrates one embodiment of available settings for a displayed missed calls indicator, such as, for example, its label.

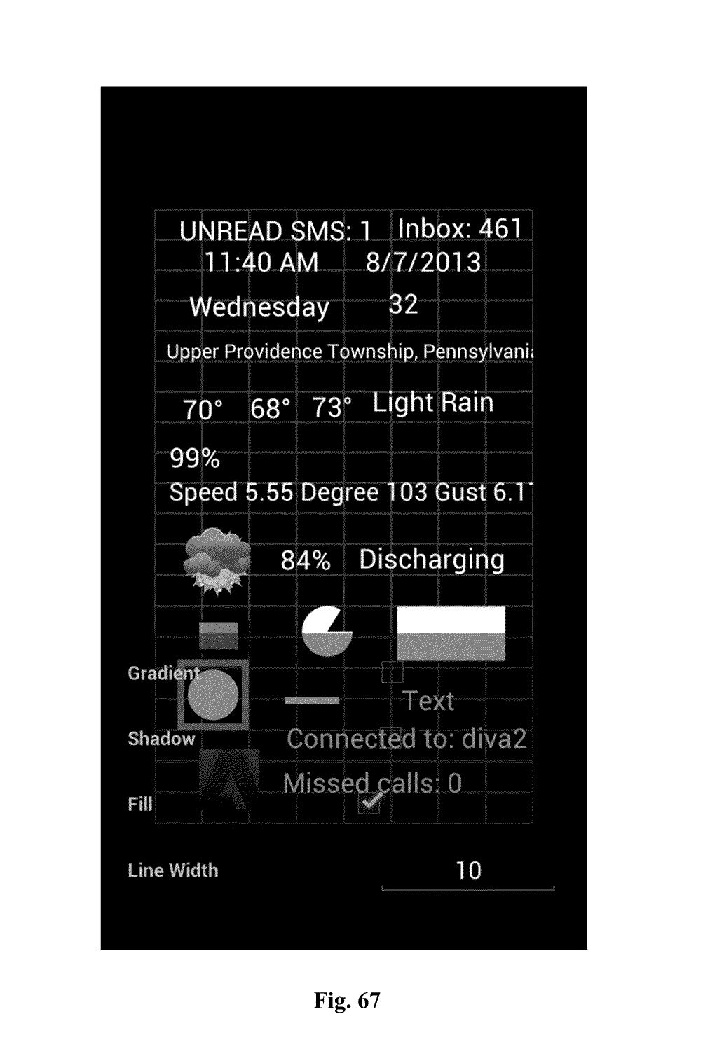

FIG. 67 illustrates one embodiment of available settings for a displayed circle shape, such as, for example, the gradient, shadow, fill, or line width.

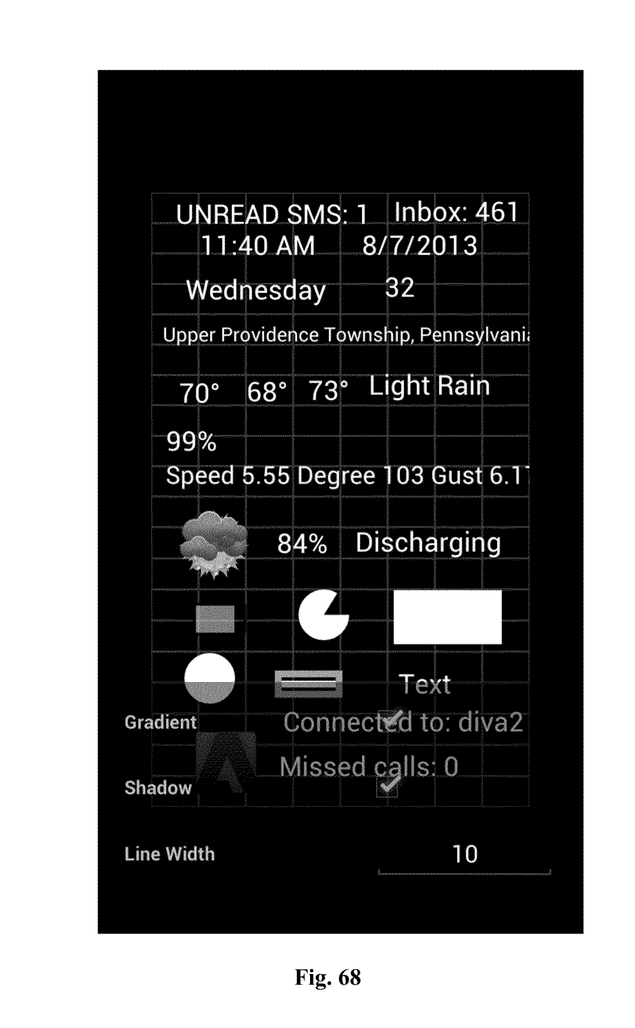

FIG. 68 illustrates one embodiment of available settings for a displayed line shape, such as, for example, the gradient, shadow, or line width.

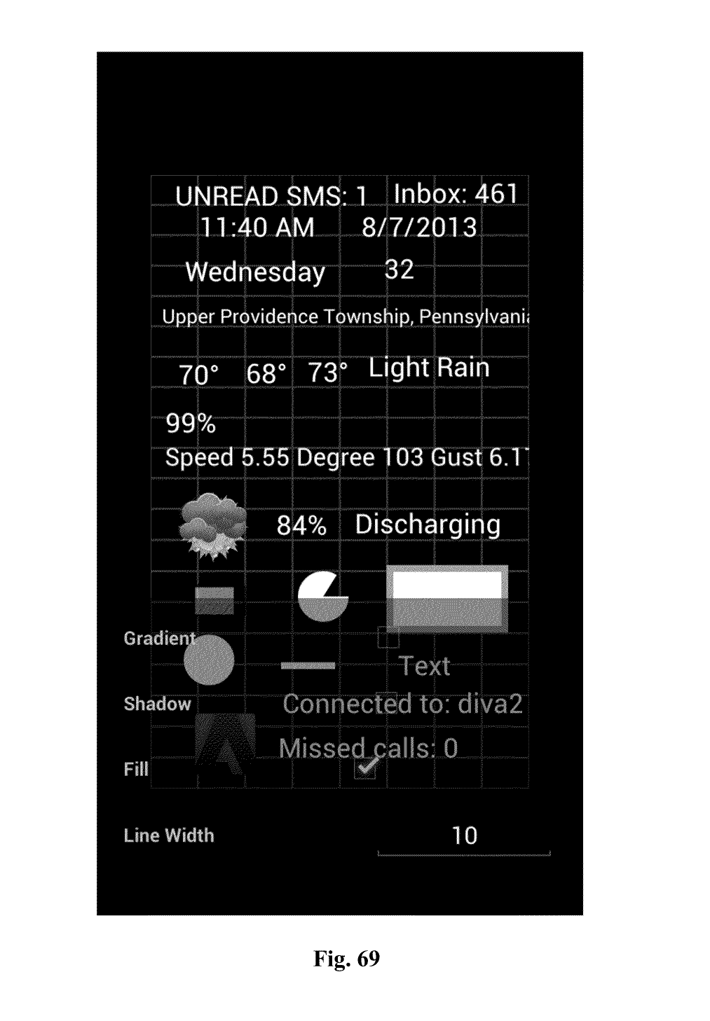

FIG. 69 illustrates one embodiment of available settings for a displayed rectangle shape, such as, for example, the gradient, shadow, or line width.

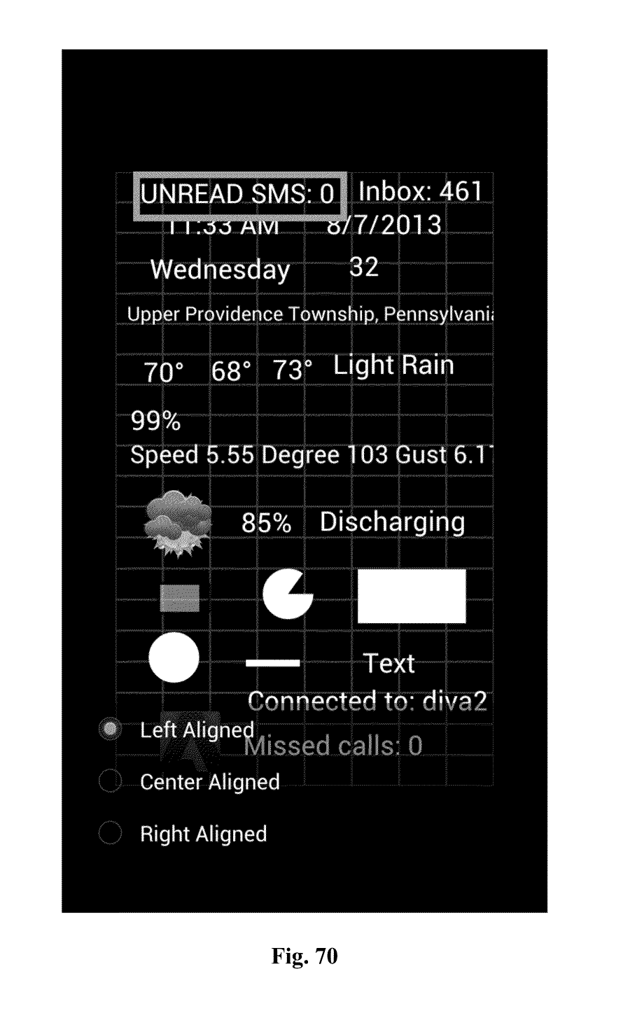

FIG. 70 illustrates one embodiment of available style settings for left, center, or right alignment of a displayed data provider. In other embodiments, the data provider and its contents may be aligned in other ways, including top, center, bottom, or diagonally.

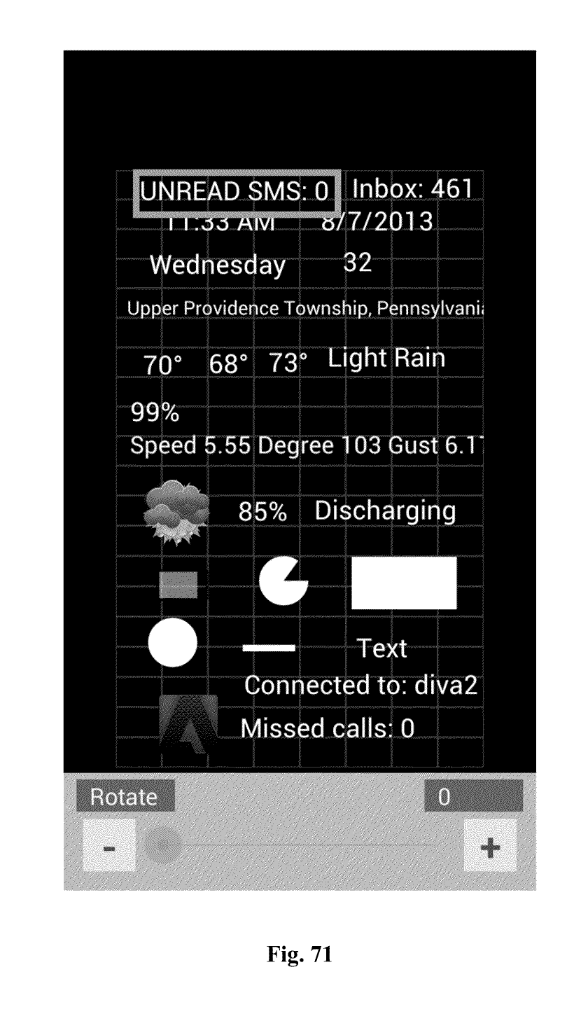

FIG. 71 illustrates one embodiment of available style settings for selecting the angle of a displayed data provider, such as, for example, providing a graphical interface for rotating the data provider at various angles.

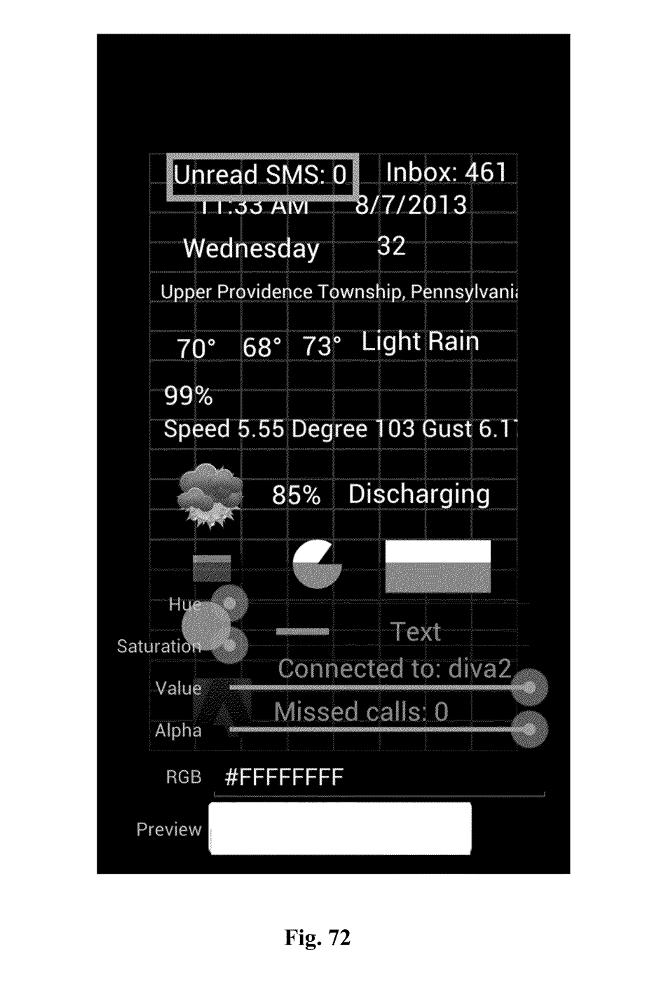

FIG. 72 illustrates one embodiment of available style settings for selecting colors of a displayed data provider, such as, for example, settings for hue, saturation, value, alpha, and RGB values. As shown in FIG. 72, a preview of the selected color may also be displayed.

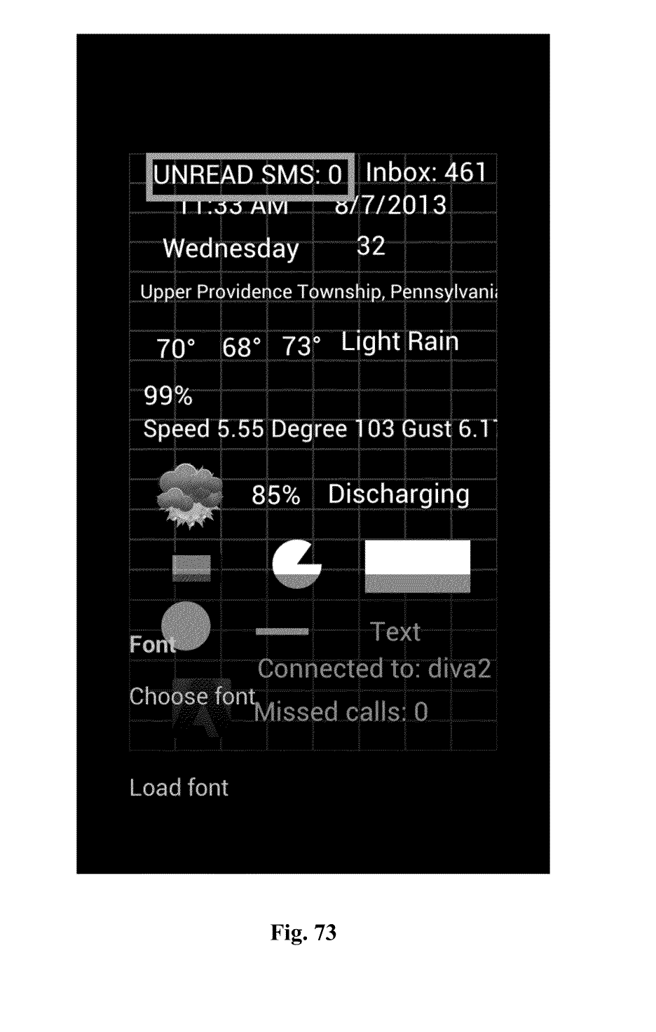

FIG. 73 illustrates one embodiment of available font-related style options for a displayed data provider, such as, for example, the ability to select a font or to load a custom font.

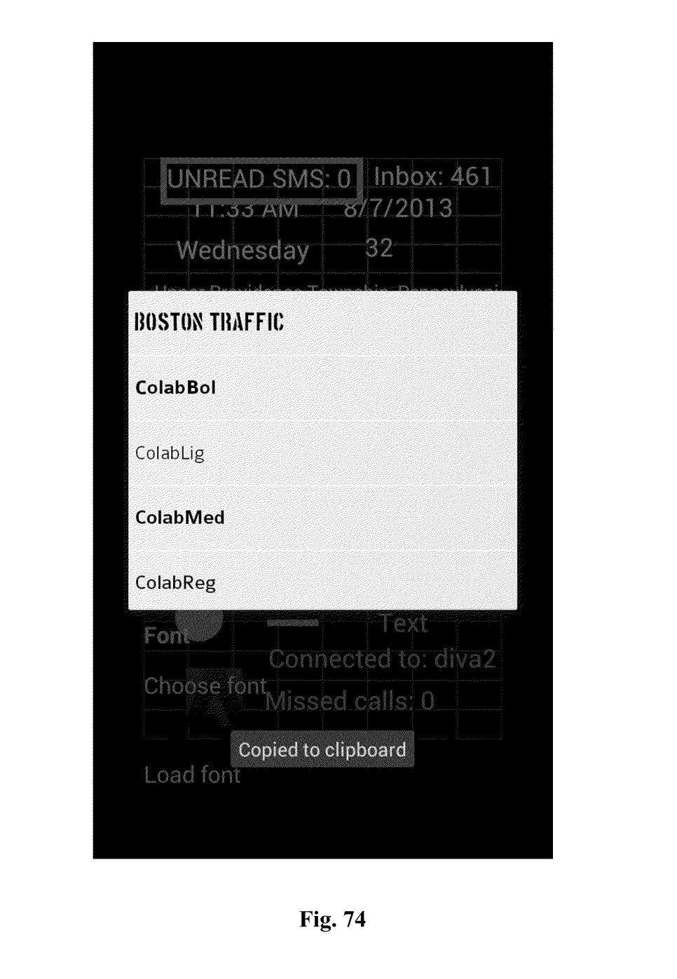

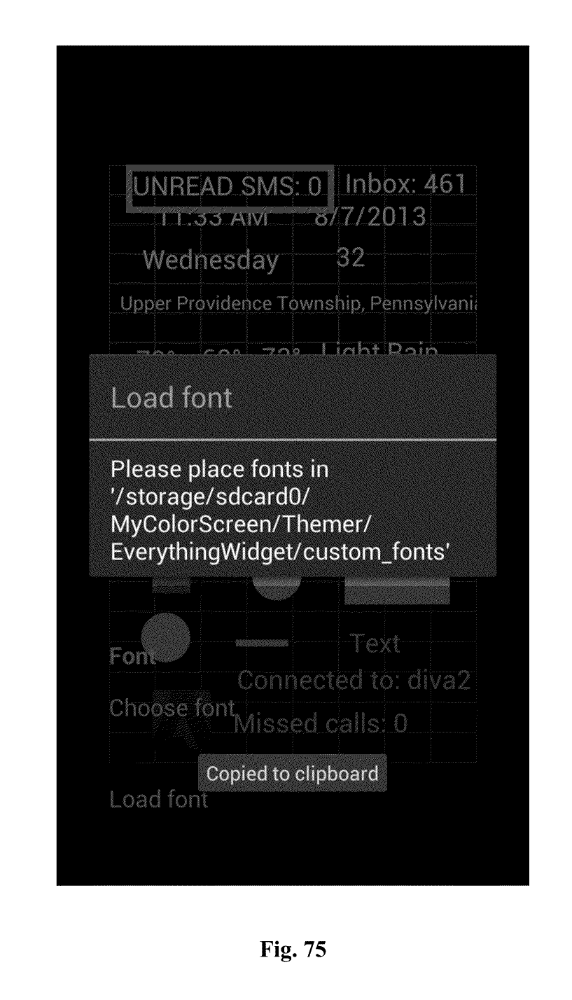

FIG. 74 illustrates one embodiment of a font-selection menu for a displayed data provider. FIG. 75 illustrates one embodiment of a font loading screen for a displayed data provider, which may allow the user to select the location from which font data may be loaded.

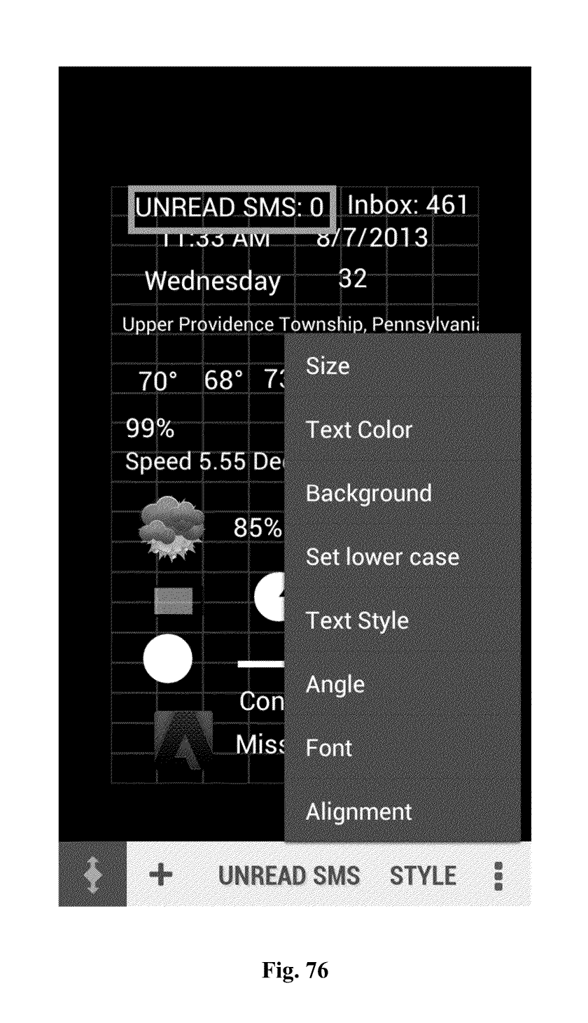

FIG. 76 illustrates one embodiment of a style-related options menu for a displayed data provider, including, for example, the Size, Text Color, Background, Set lower case, Text Style, Angle, Font, and Alignment options.

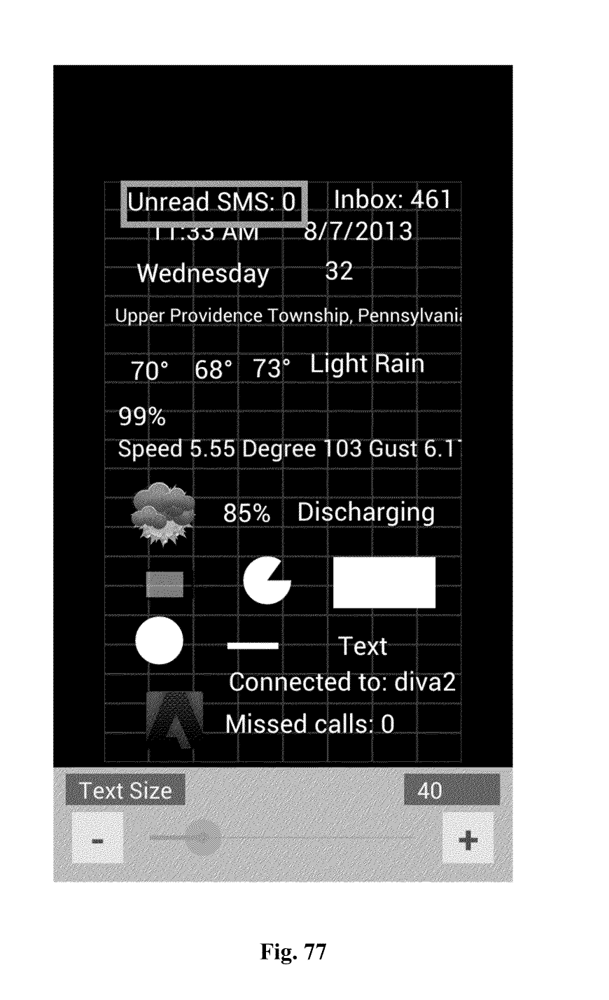

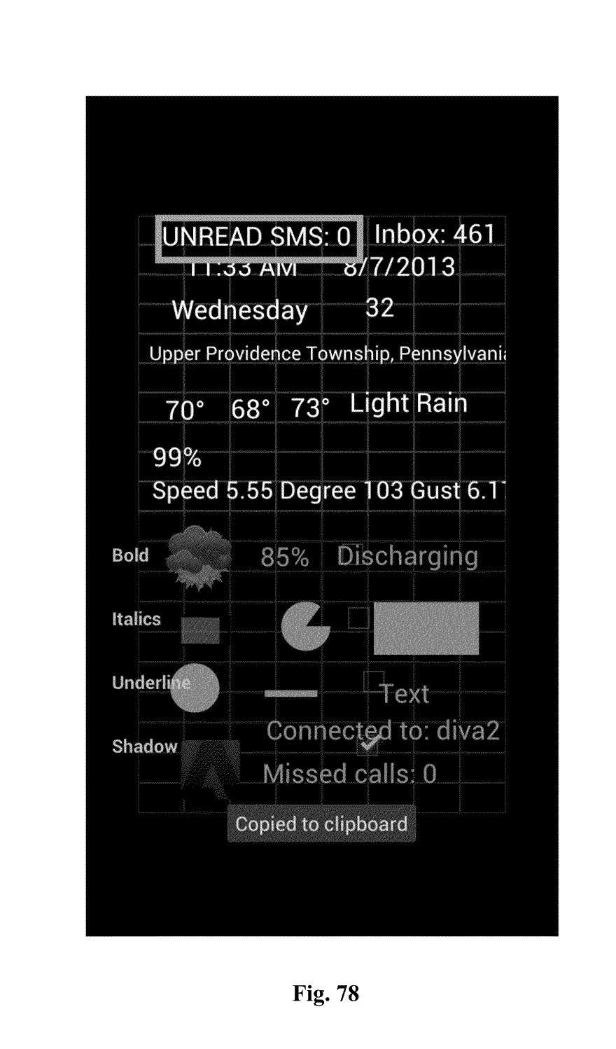

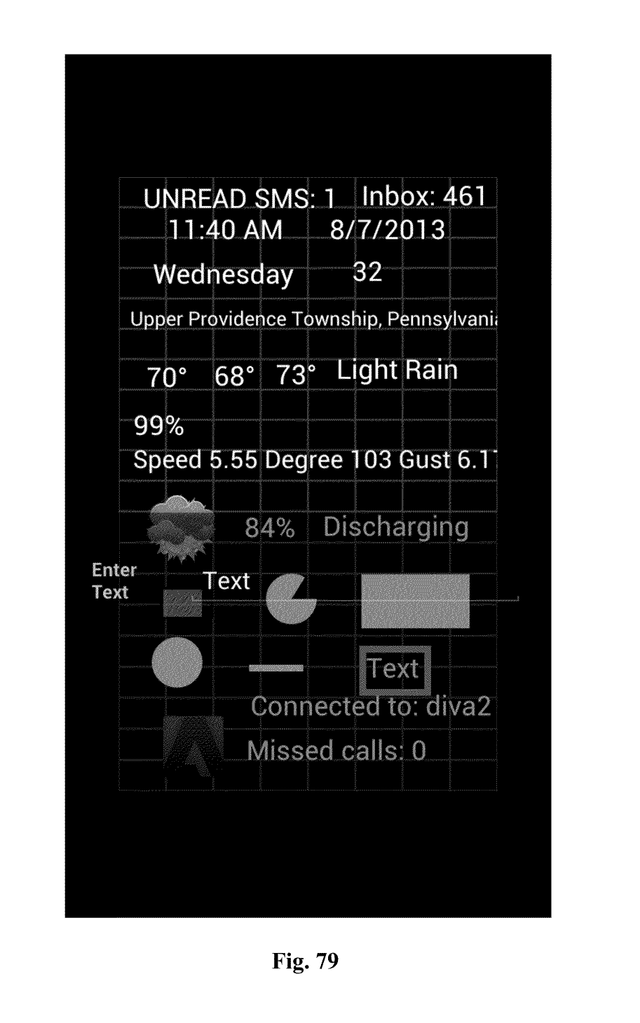

FIG. 77 illustrates one embodiment of available settings for selecting the text-size of a displayed data provider. FIG. 78 illustrates one embodiment of available settings for selecting the text style of a displayed data provider, such as, for example, bold, italics, underline, or shadow styles. FIG. 79 illustrates one embodiment of a text-entry interface for a displayed data provider.

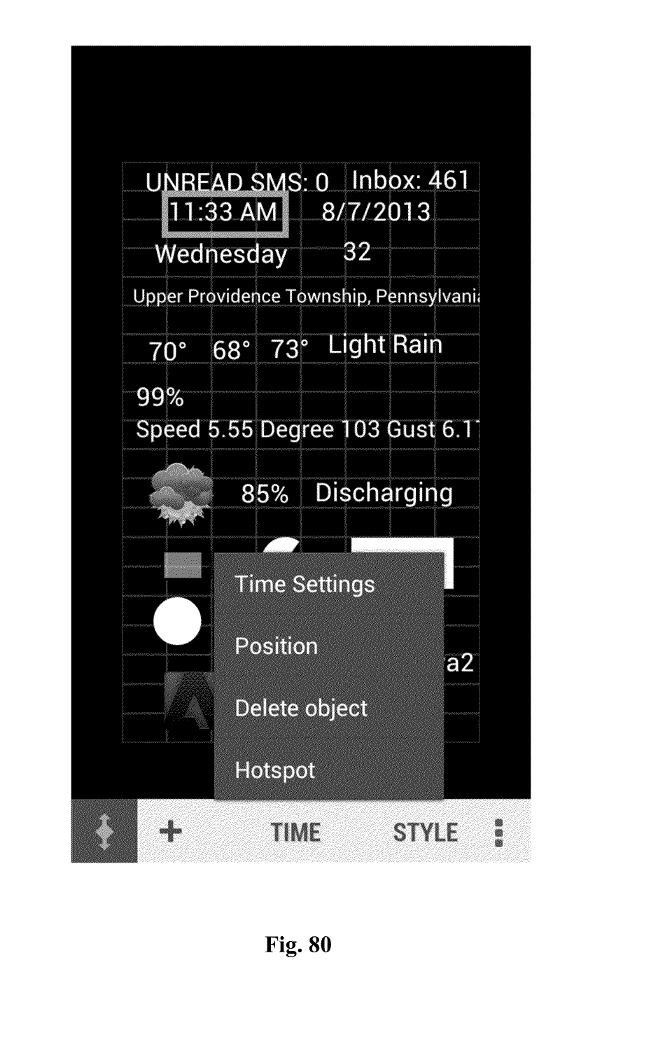

FIG. 80 illustrates one embodiment of an options menu for a displayed time data provider, including Time Settings, Position, Object deletion, and Hotspot options.

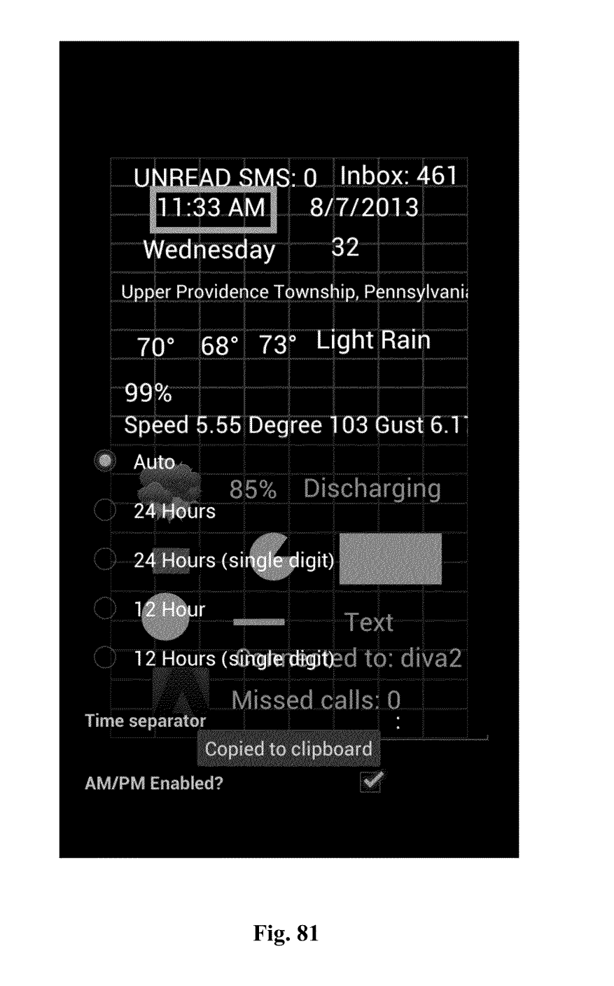

FIG. 81 illustrates one embodiment of available settings for a displayed time data provider, such as, for example, the format of the displayed time as standard or military time, and the number of displayed digits.

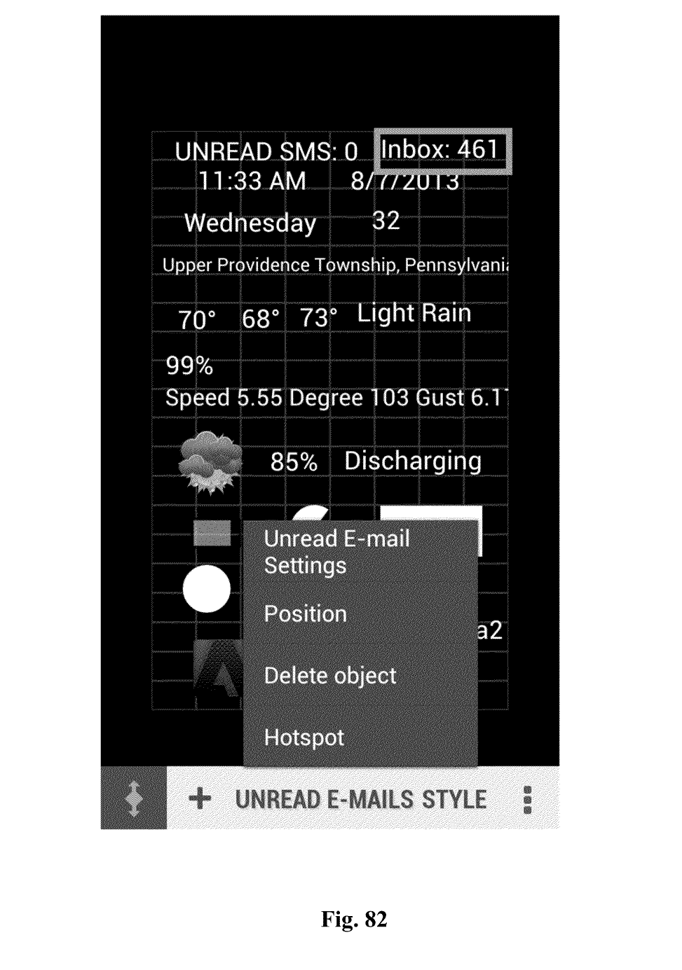

FIG. 82 illustrates one embodiment of an options menu for a displayed unread e-mails data provider, including Unread E-mails, Position, Object deletion, and Hotspot options.

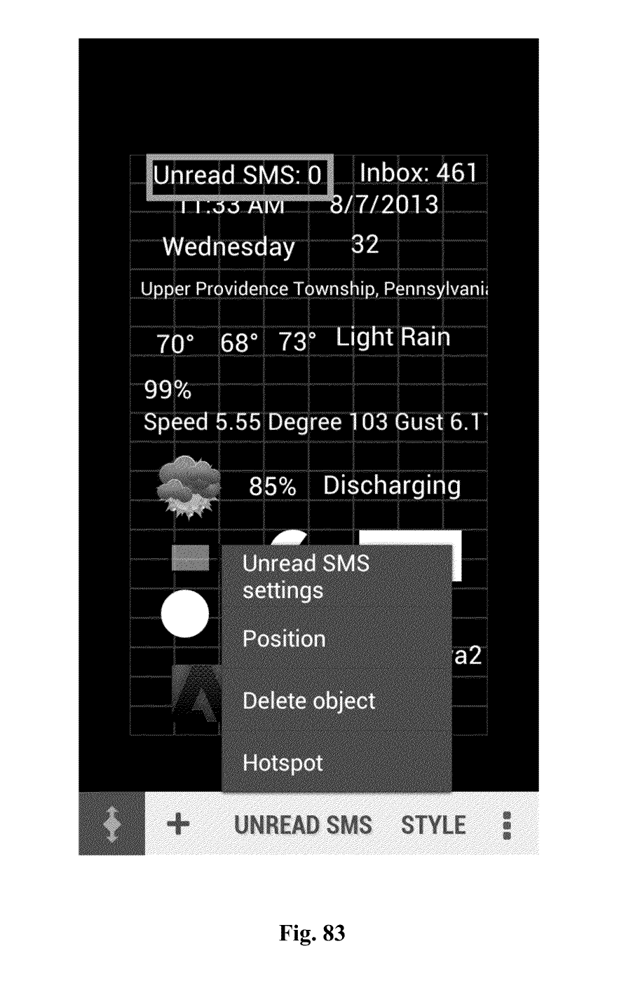

FIG. 83 illustrates one embodiment of an options menu for a displayed unread SMS data provider, including Unread SMS settings, Position, Object deletion, and Hotspot options.

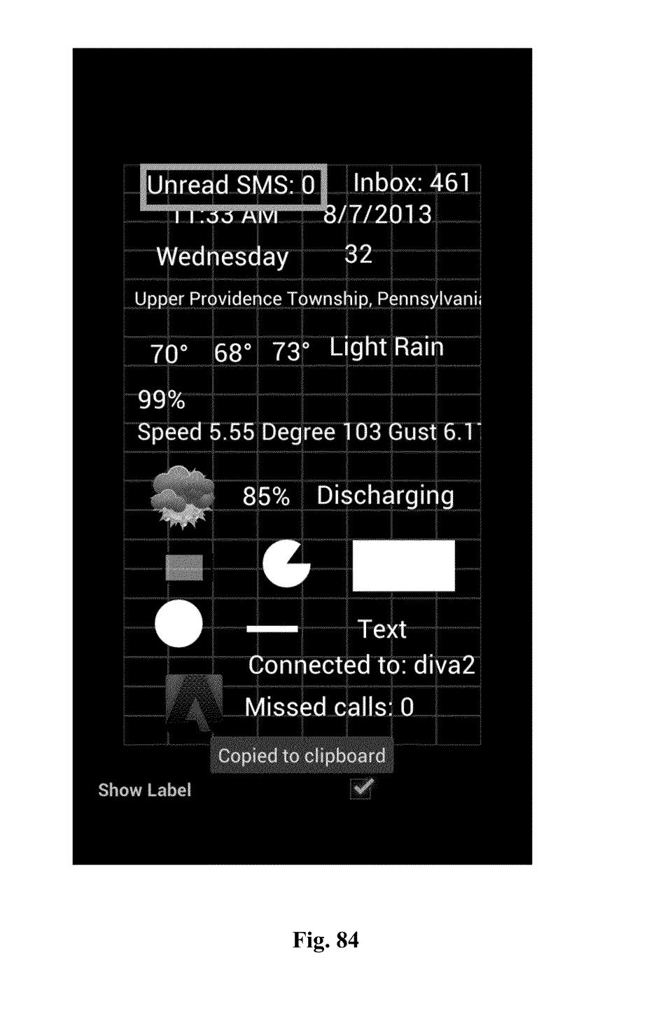

FIG. 84 illustrates one embodiment of available settings for a displayed unread SMS data provider, such as, for example, the show label checkbox.

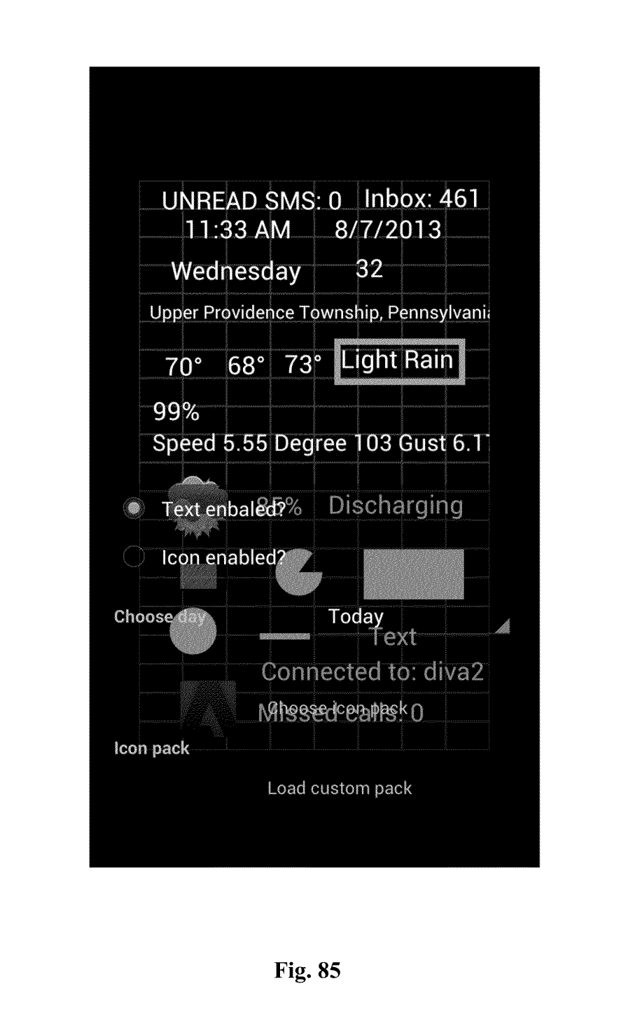

FIG. 85 illustrates one embodiment of available text settings for a displayed weather conditions data provider, such as, for example, whether the weather conditions should be indicated with an icon or text, the applicable day, and which icon pack should be used.

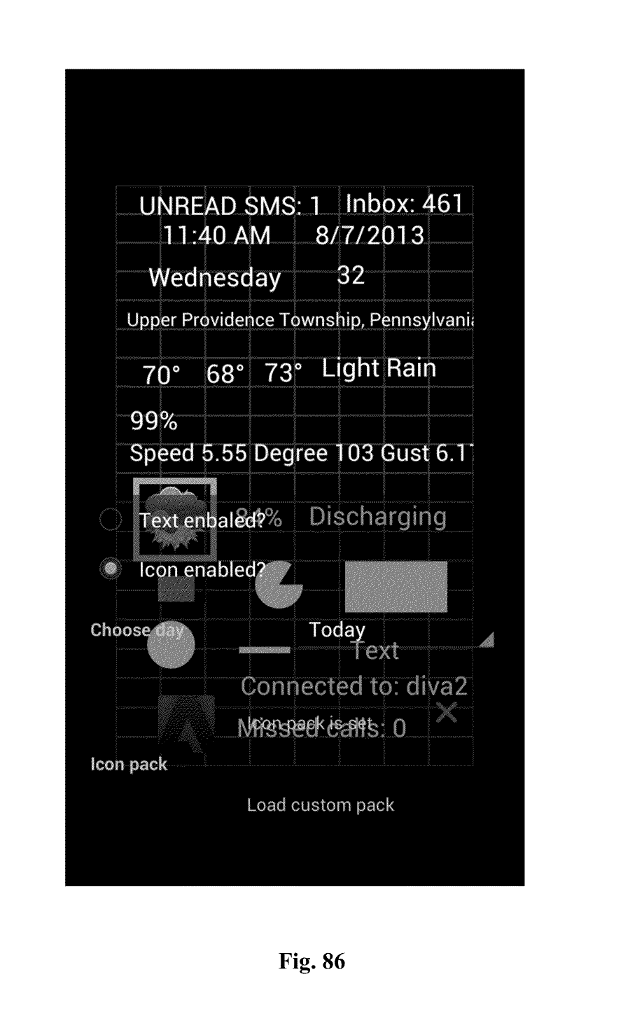

FIG. 86 illustrates one embodiment of available icon settings for a displayed weather conditions data provider, such as, for example, whether the weather conditions should be indicated with an icon or text, the applicable day, and which icon pack should be used

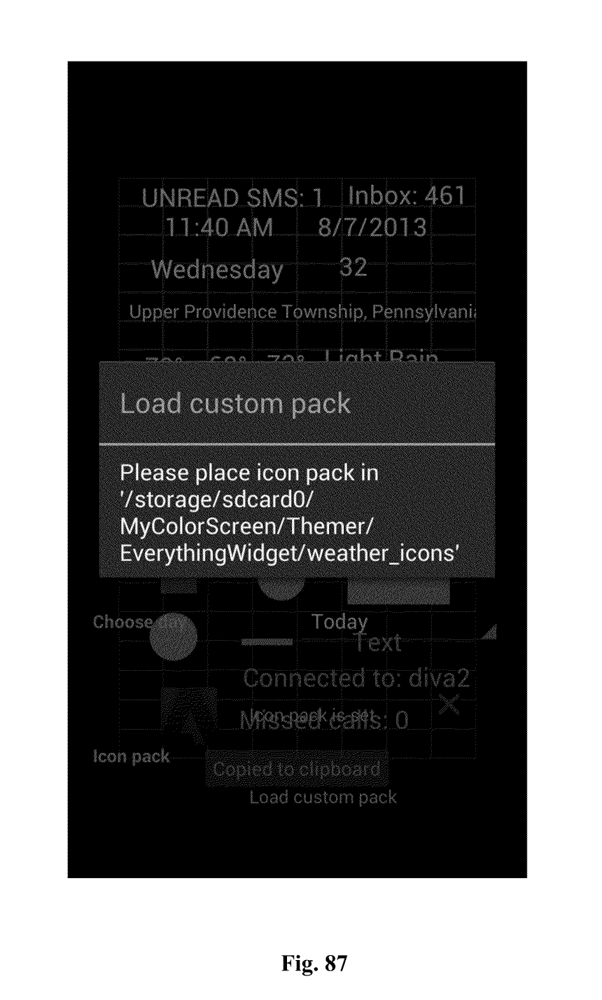

FIG. 87 illustrates one embodiment of a custom pack loading interface for a displayed weather conditions data provider, which may provide the user with the ability to enter the location of the weather conditions custom pack.

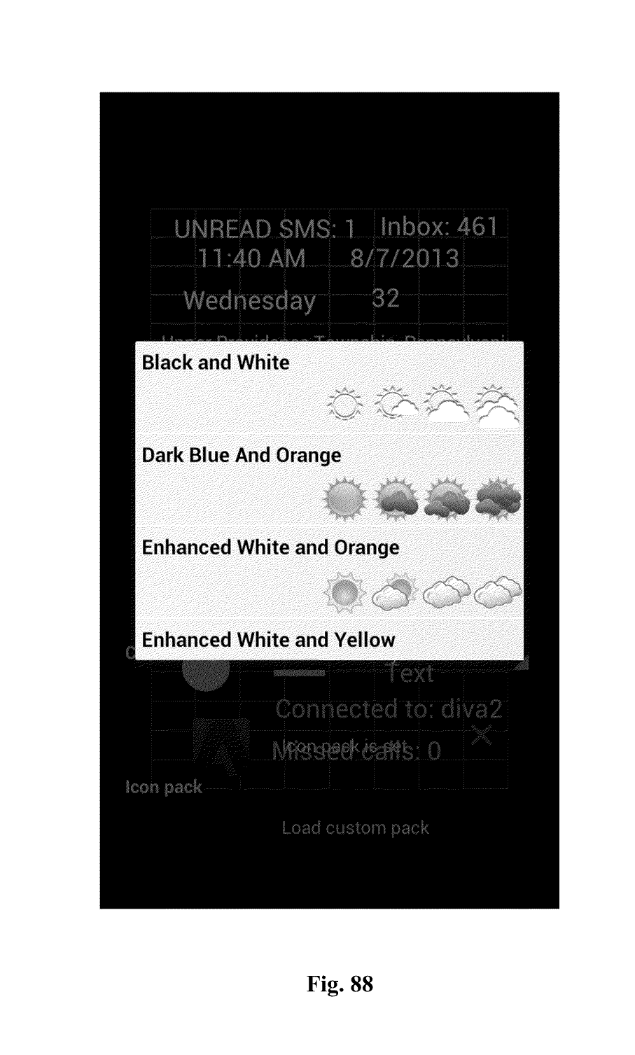

FIG. 88 illustrates one embodiment of an icon set pack selection interface for a displayed weather conditions data provider, which may present the user with several visual options for displaying weather conditions.

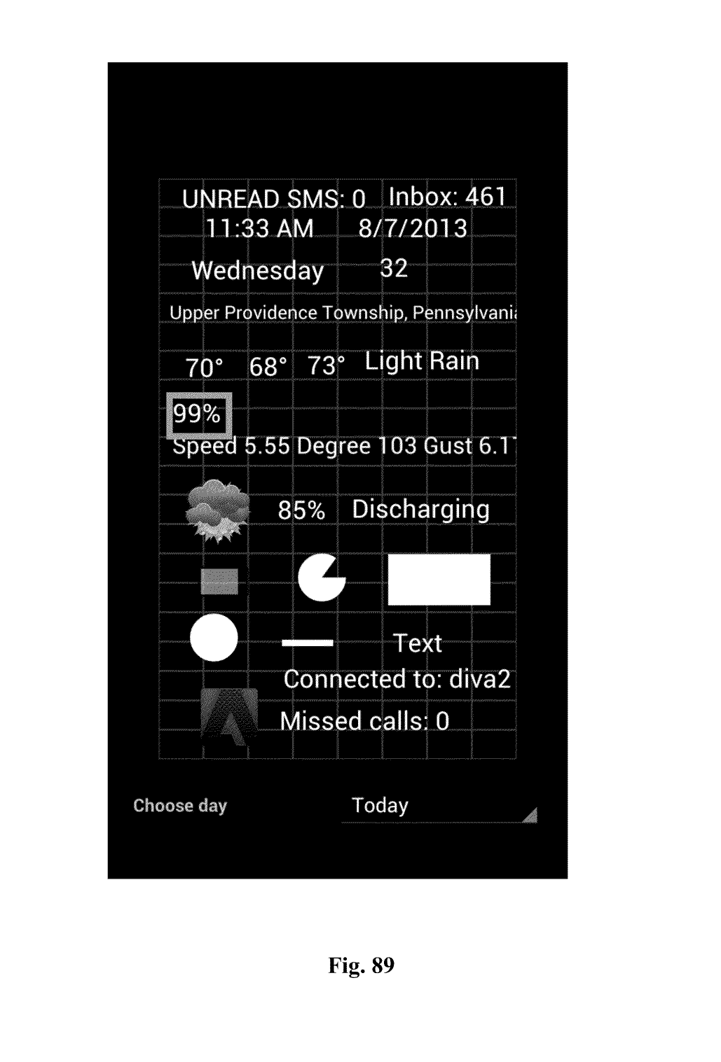

FIG. 89 illustrates one embodiment of available settings for a displayed humidity indication data provider, such as, for example, the applicable day.

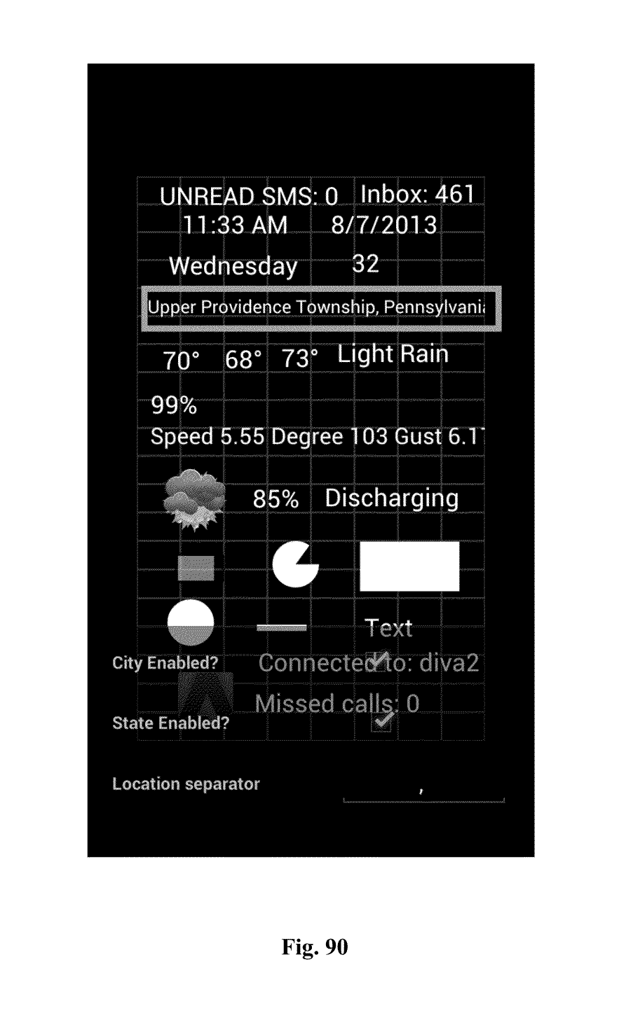

FIG. 90 illustrates one embodiment of available settings for a displayed weather location data provider, such as, for example, whether to display the city and/or state, and whether to display a location separator between the two and of what type.

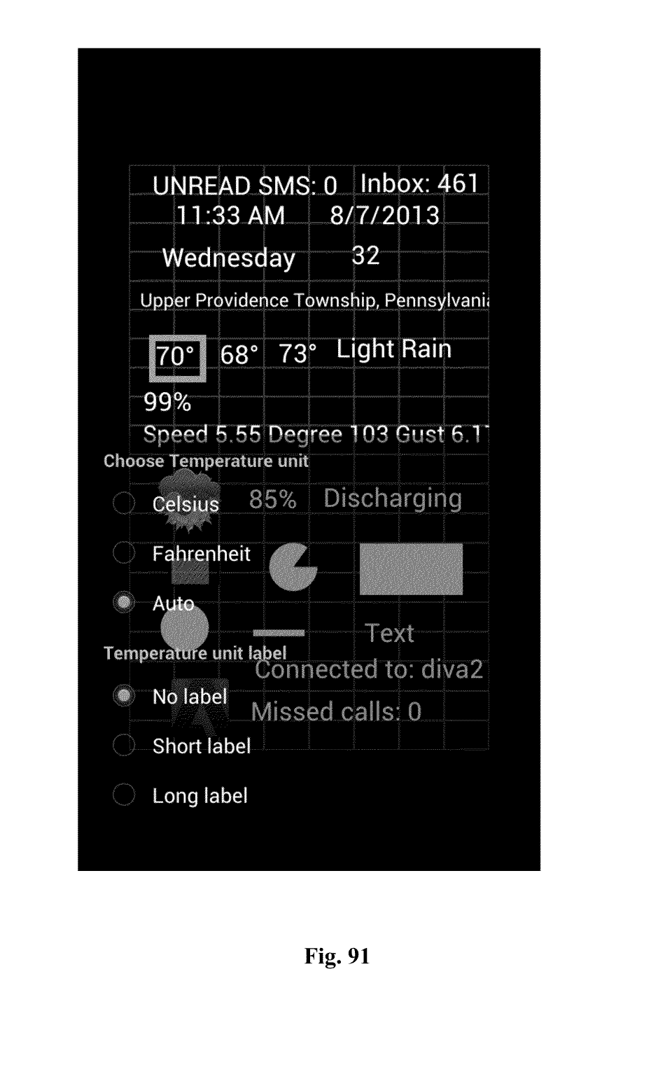

FIG. 91 illustrates one embodiment of available settings for a displayed temperature data provider, such as, for example, Celsius or Fahrenheit, and whether to use short unit labels, long unit labels, or no labels at all. In other embodiments, other temperature units, such as Kelvin, may be used.

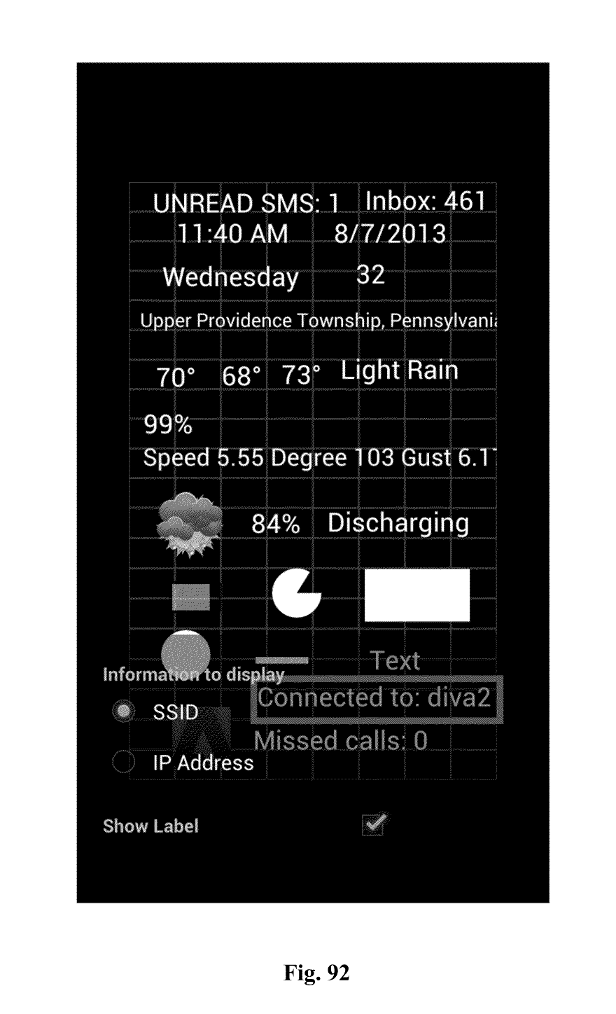

FIG. 92 illustrates one embodiment of available settings for a displayed WiFi data provider, such as, for example, whether to show the label, and whether to display the SSID or IP address.

### Other Widgets and Integration

As mentioned above, the disclosed invention may be used to combine various GUI elements, such as widgets, into a theme, thereby alleviating the need for users to spend significant time on theme and GUI configuration. Several examples of such GUI integration are described below.

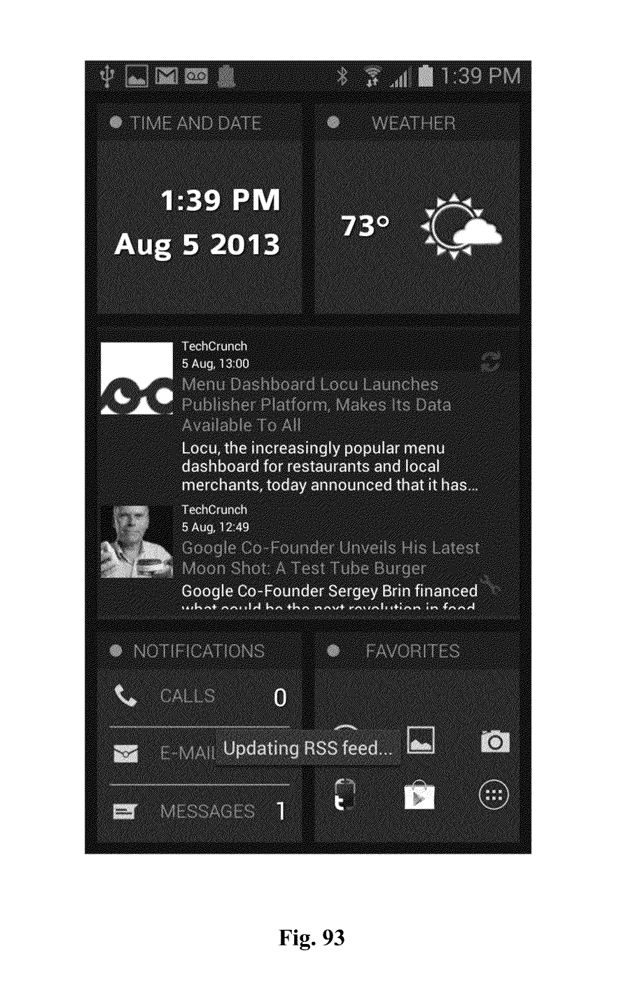

FIG. 93 illustrates one embodiment of a theme including several Everything Widgets and a Simple RSS Widget. Here, the Simple RSS Widget appears in the middle of the screen, displaying RSS feeds that have been obtained from various sources. Various embodiments and settings of the Simple RSS Widget are described further below. In FIG. 93, the Simple RSS Widget is surrounded by several Everything Widgets at the top and bottom.

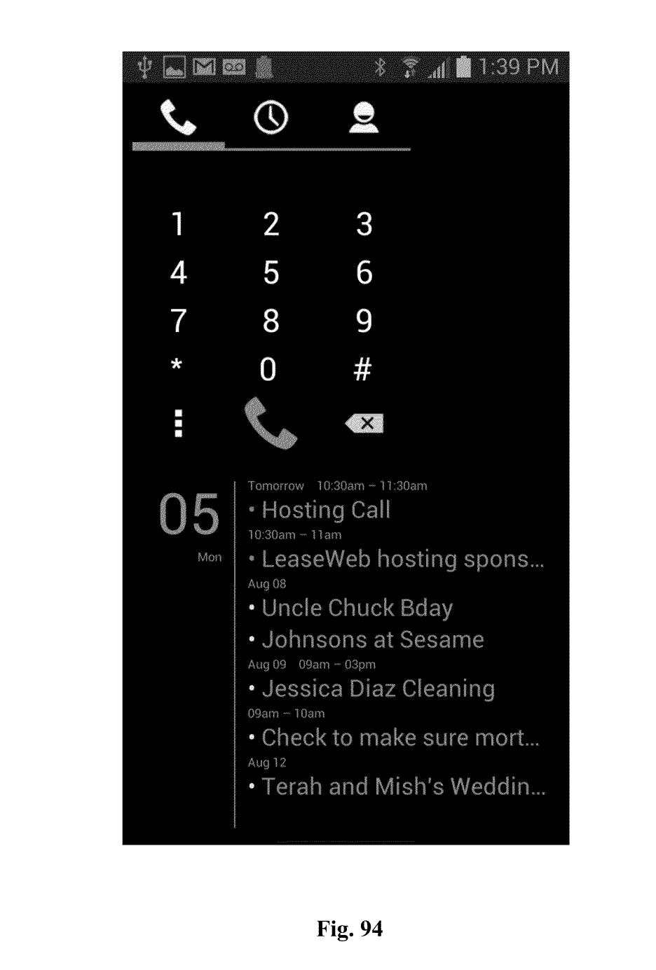

For another example of widget integration, FIG. 94 illustrates one embodiment of a theme including a Simple Calendar Widget located at the bottom of the screen, and a Simple Dialer Widget located at the top.

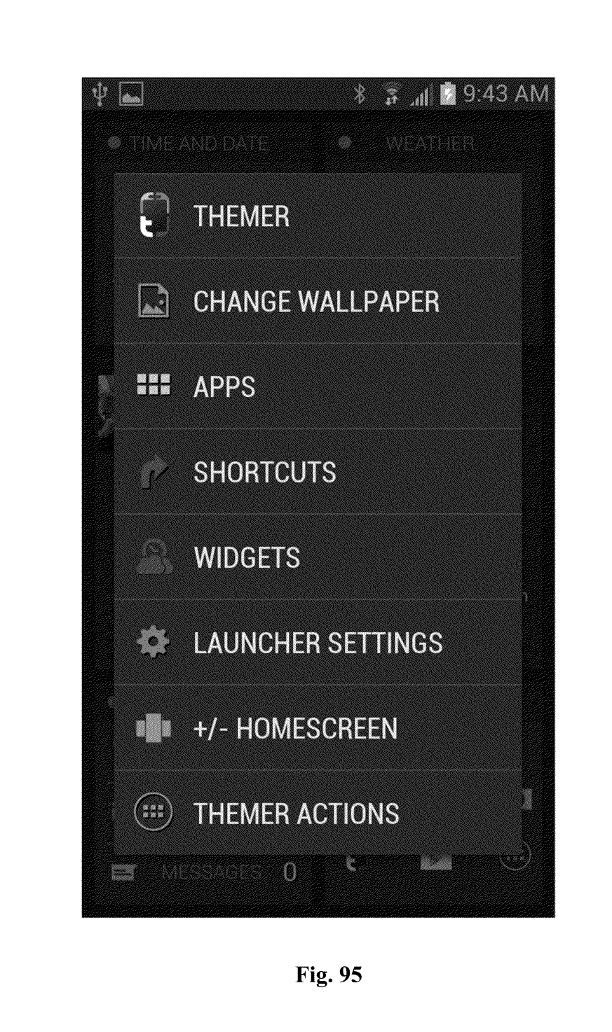

FIG. 95 illustrates one embodiment of a general in-theme menu that in some embodiments becomes available for access once a theme has been applied. The menu provides access to the Themer App, Change Wallpaper, Apps, Shortcuts, Widgets, Launcher Settings, +/−Homescreen, and Themer Actions.

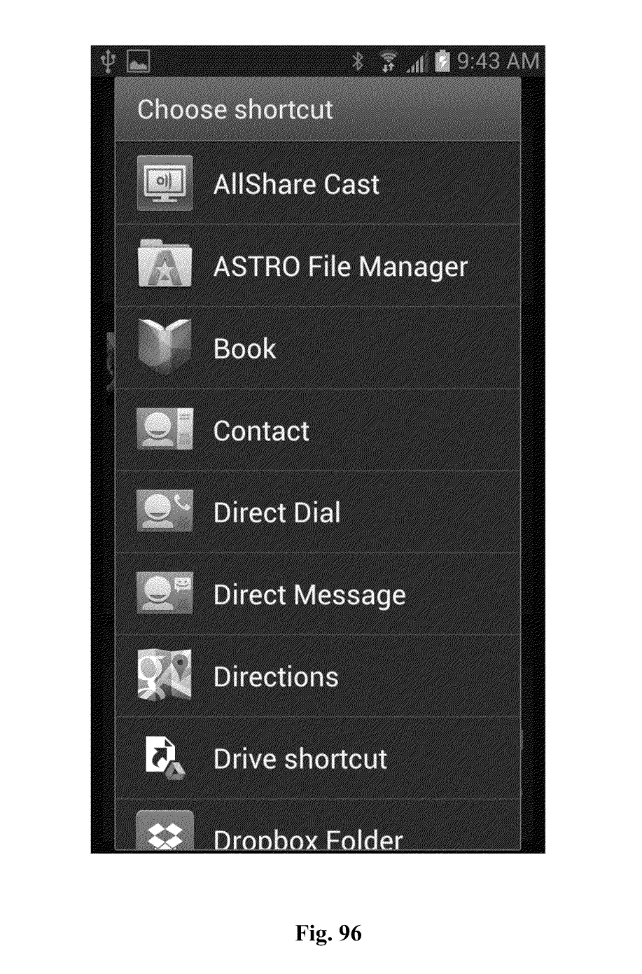

FIG. 96 illustrates one embodiment of an in-theme Shortcuts menu, which presents shortcuts available to the theme, launcher, and/or the OS.

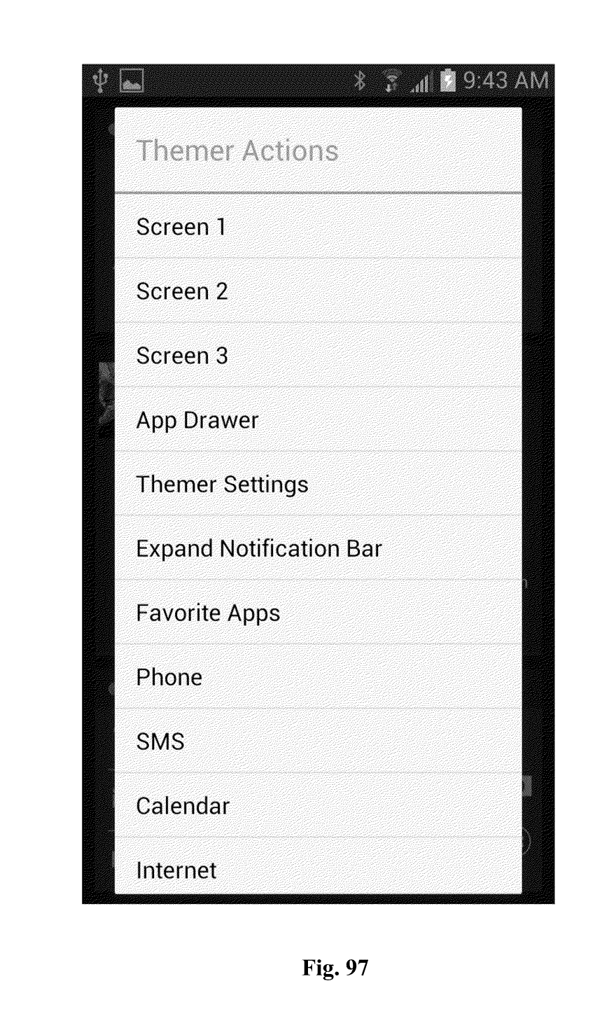

FIG. 97 illustrates one embodiment of an in-theme Themer Actions menu, which provides access to various Themer actions, including those listed in the figure.

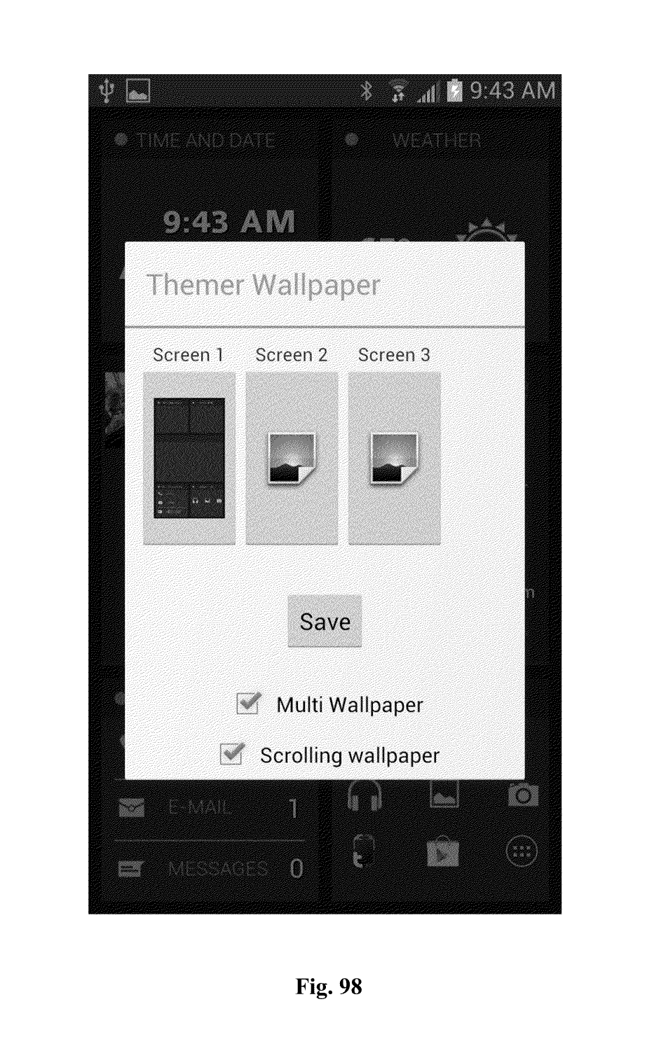

FIG. 98 illustrates one embodiment of an in-theme Wallpaper options menu, which enables the usage of different wallpapers for different screens, and usage of scrolling wallpaper if desired.

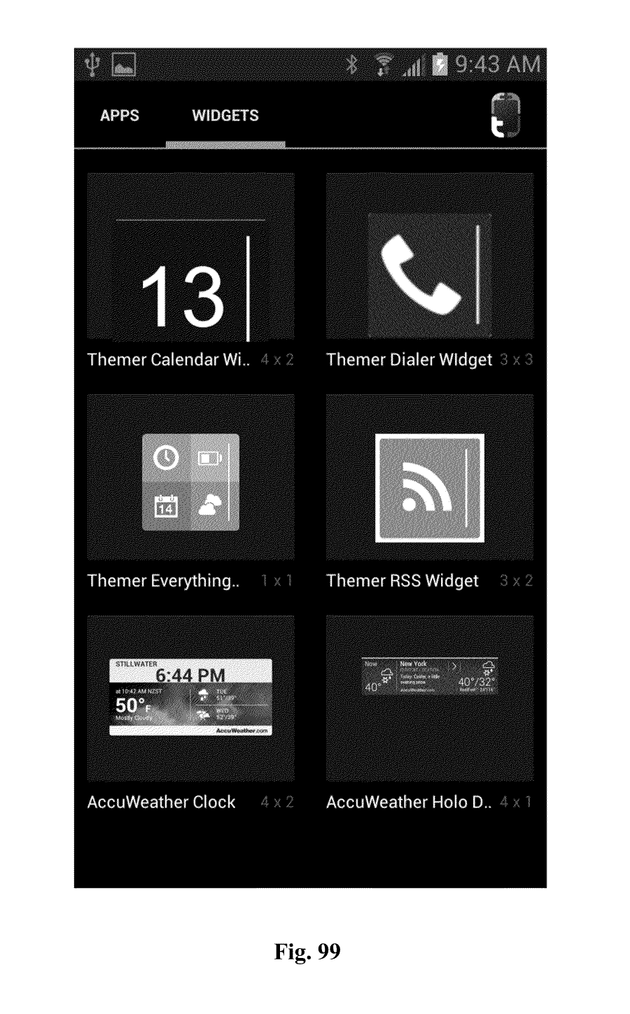

FIG. 99 illustrates one embodiment of an in-theme Widgets menu, showing various available widgets.

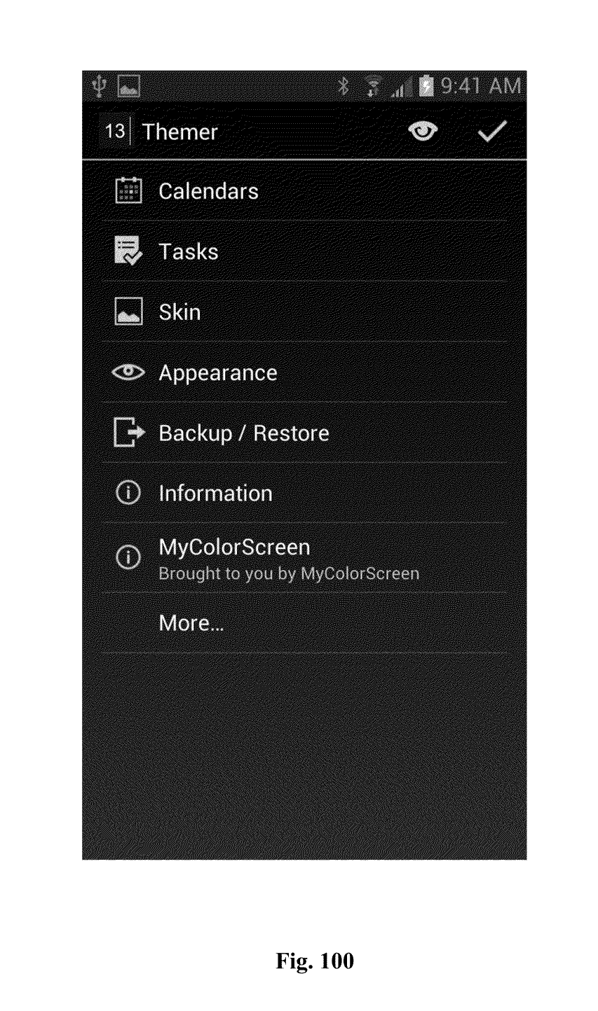

FIG. 100 illustrates one embodiment of a settings menu for a Simple Calendar Widget, including options to adjust the settings for the calendars, tasks, skin, appearance, or to backup/restore the configured widget.

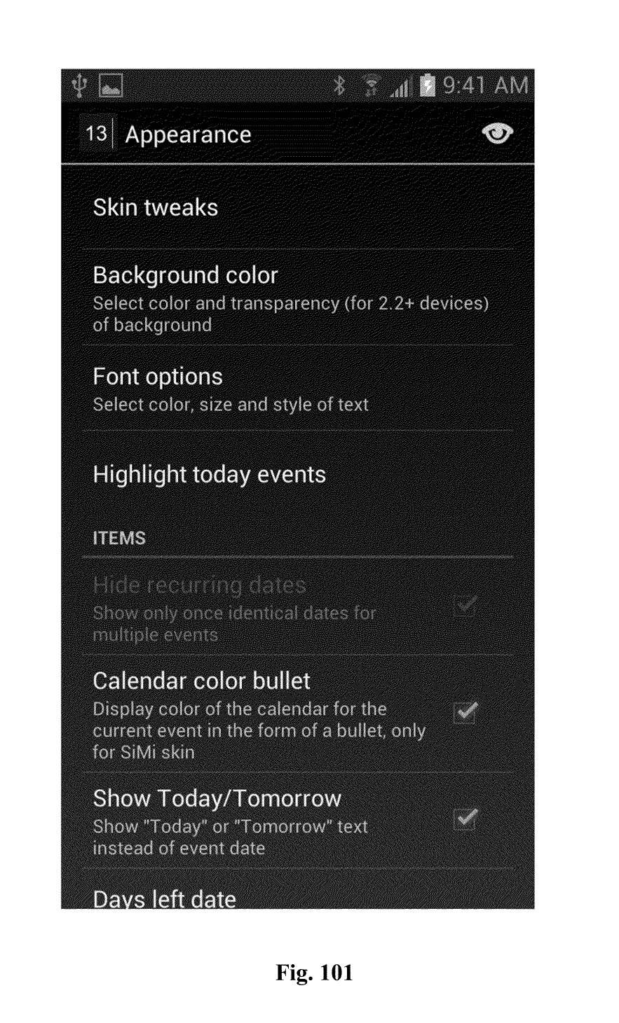

FIG. 101 illustrates one view of an appearance configuration menu for a Simple Calendar Widget, including options for skin tweaks, background color, font options, highlight today events, hide recurring dates, calendar color bullet, and show today/tomorrow.

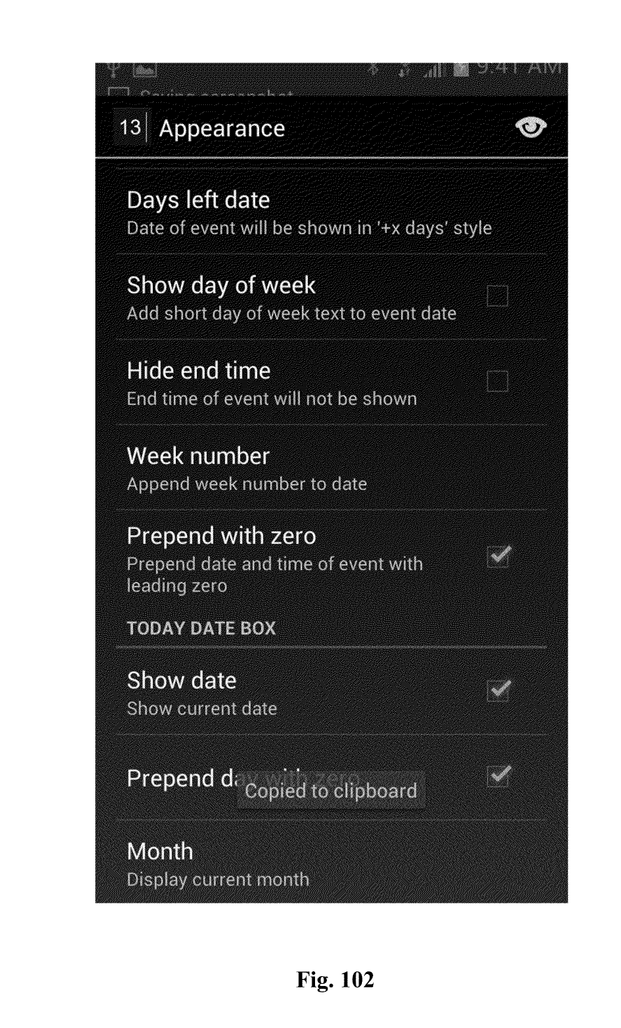

FIG. 102 illustrates a second view of an appearance configuration menu for a Simple Calendar Widget, including options for days left date, show day of week, hide end time, week number, prepend with zero, show date, prepend day with zero, and the month.

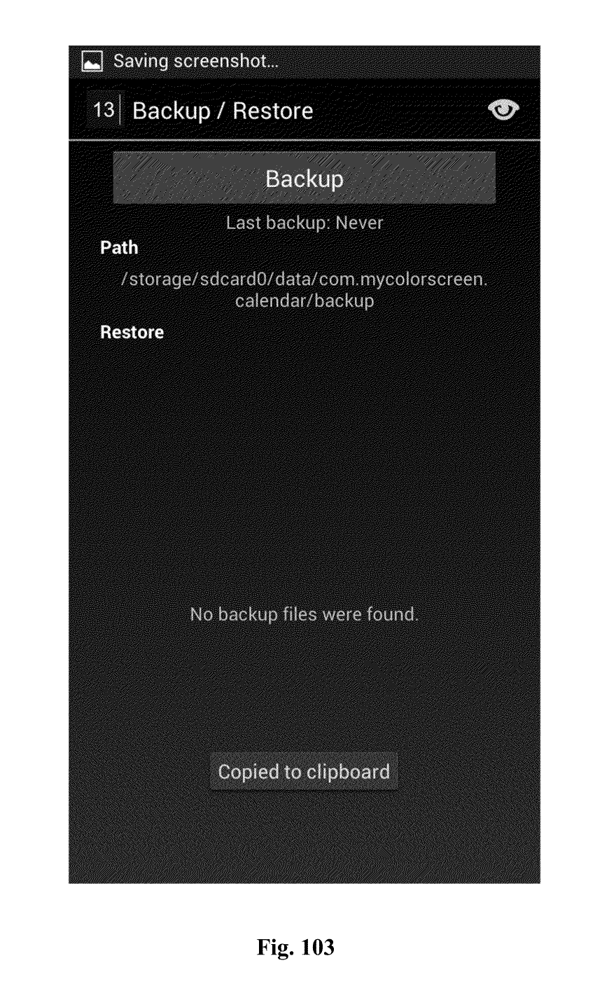

FIG. 103 illustrates one embodiment of a widget backup interface, which allows the user to back up the configured widget, and to select a location for the backed up copy.

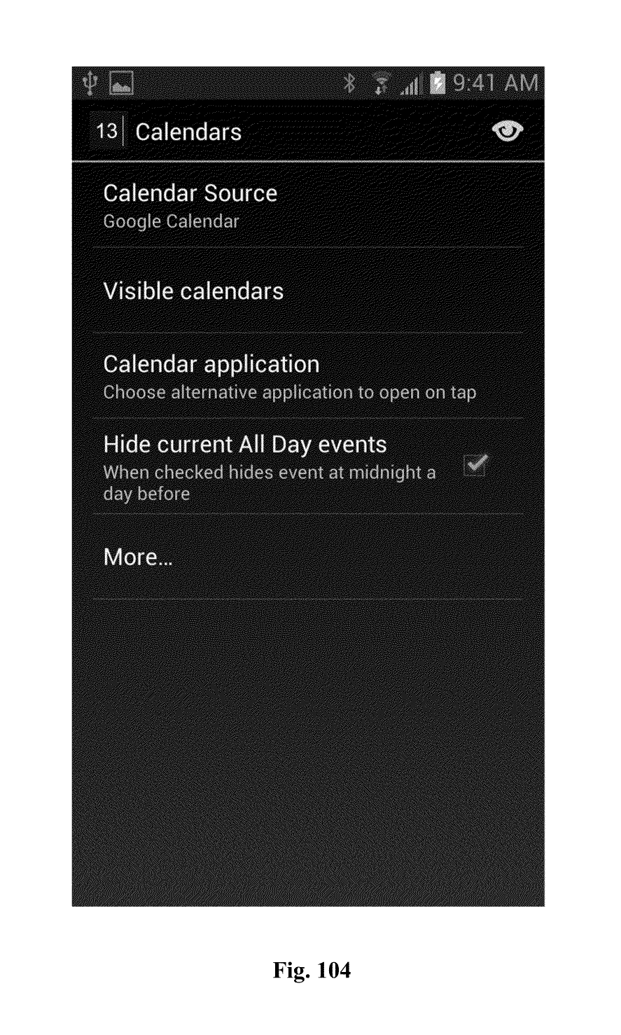

FIG. 104 illustrates one embodiment of a calendar configuration menu for a Simple Calendar Widget, including options for the calendar source, visible calendars, the used calendar application, and an option to hide all day events.

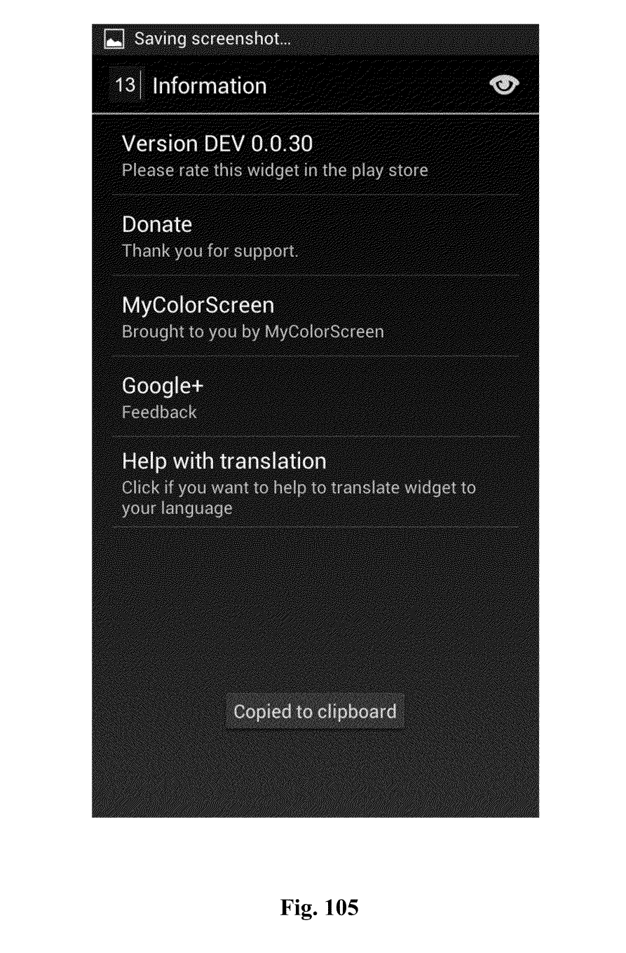

FIG. 105 illustrates one embodiment of an information provision and request interface for a Simple Calendar Widget.

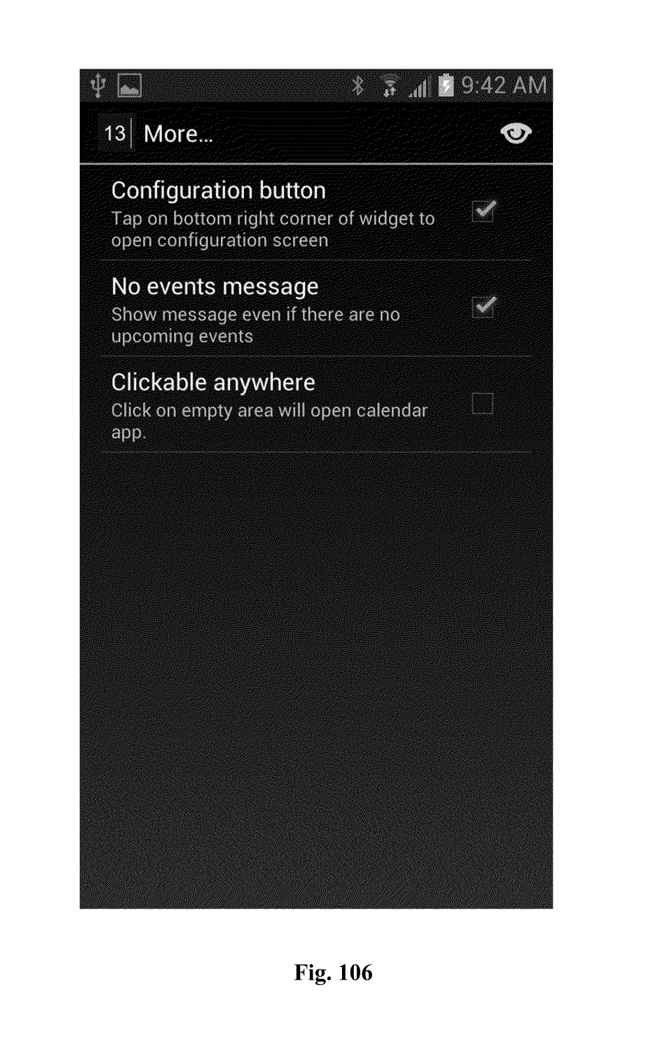

FIG. 106 illustrates one embodiment of an additional settings menu for a Simple Calendar Widget, including options for a configuration button, a no events message, and to make the widgets clickable everywhere.

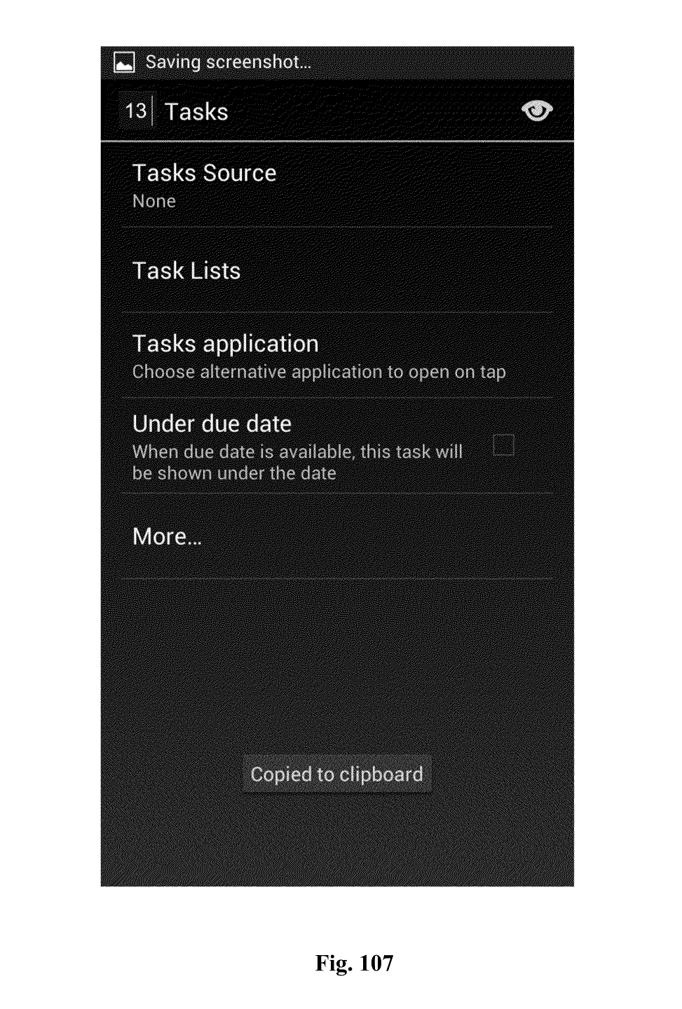

FIG. 107 illustrates one embodiment of a tasks settings menu for a Simple Calendar Widget, including options for the sources of tasks, task lists, the used tasks application, and a due date indicator.

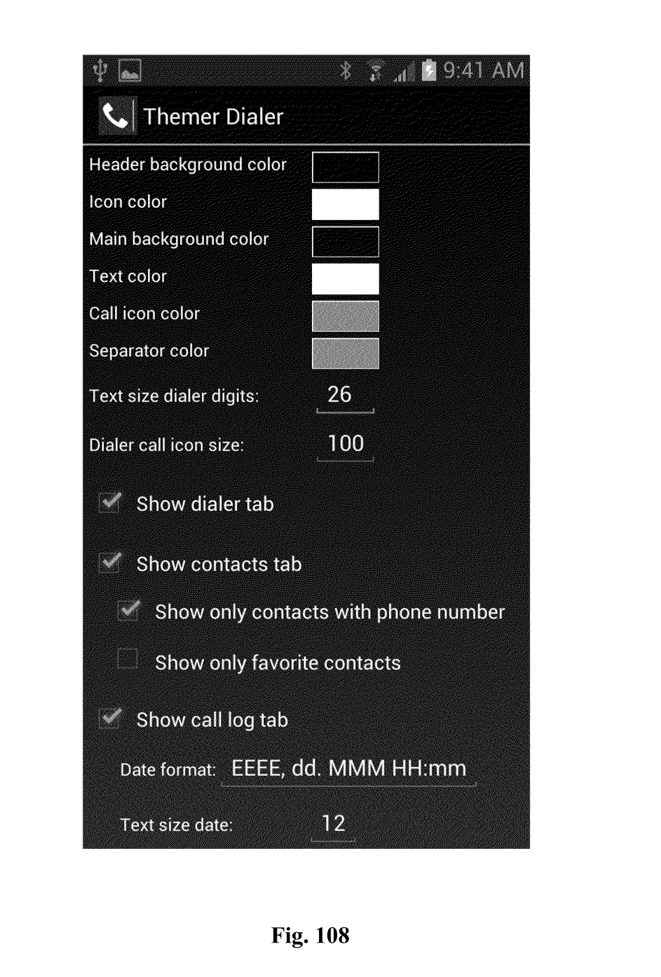

FIG. 108 illustrates one embodiment of a configuration menu for a Simple Dialer Widget, including options for colors used for various elements of the dialer, text and icon size, and options relating to dialer, contacts, and call log tabs.

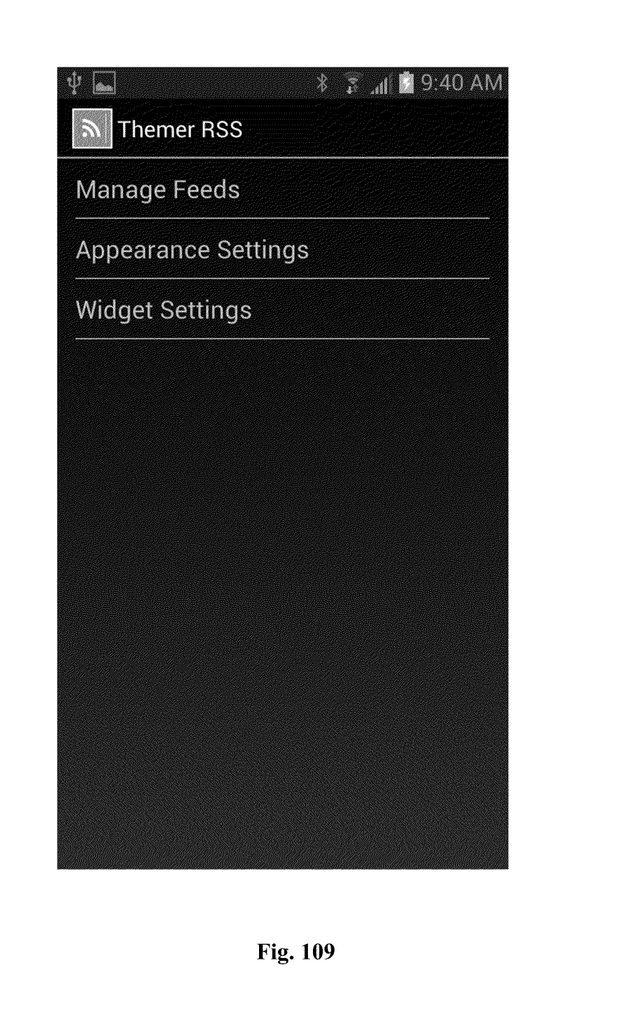

FIG. 109 illustrates one embodiment of a general settings menu for a Simple RSS Widget, including options to Manage Feeds, adjust Appearance Settings, and access Widget Settings.

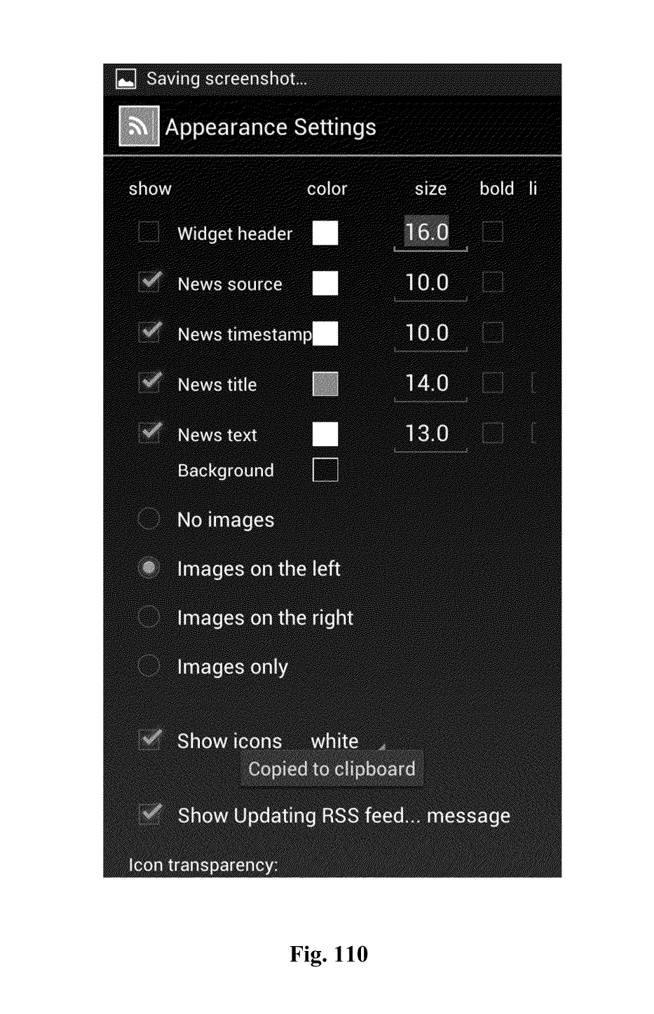

FIG. 110 illustrates one embodiment of an appearance settings menu for a Simple RSS Widget.

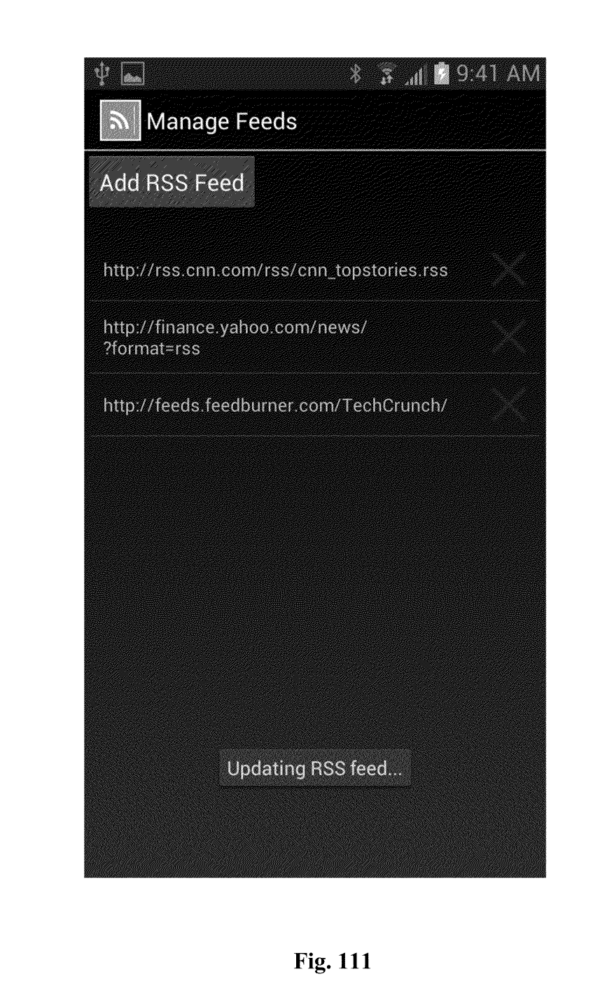

FIG. 111 illustrates one embodiment of an RSS feed management interface for a Simple RSS Widget, which enables users to add or remove RSS feeds.

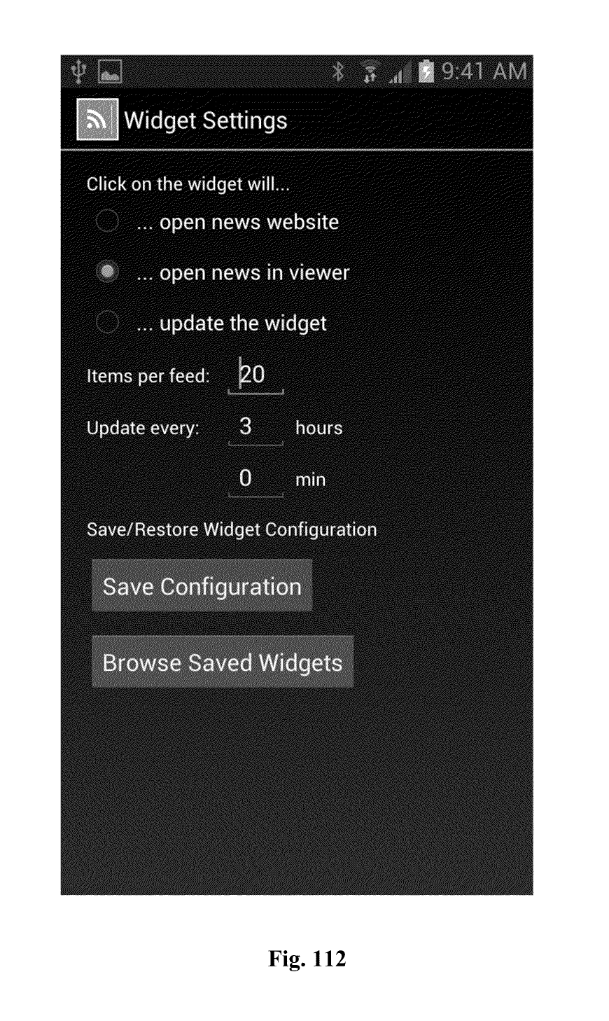

FIG. 112 illustrates one embodiment of a widget settings menu for a Simple RSS Widget, including options to adjust widget actions, feed display, and updating options.

### Additional Data Providers

In addition to the data providers disclosed above, the Everything Widget and other embodiments of the disclosed system may utilize other data providers, such as, for example, data providers for the next alarm time; data providers from other widgets, such as, for example, an upcoming calendar event from another widget; a ‘series’ clock with options to break down the individual hour, minute, date, day of week, month, and year into elements; week bar, showing several or all days of the week with selective highlighting; custom text files for weather forecasts and conditions, which may alter the text as displayed in a widget; the current WiFi network; WiFi vs. Cellular connection indicator; WiFi signal strength; cellular signal strength; cellular network type, latitude and/or longitude, country, time zone, current cellular provider and/or operator; local IP address; WiFi speed; battery voltage; battery time left; data usage for cellular and/or WiFi usage based on today, week, month, and/or year; memory data, such as free memory, used memory, and/or total memory; time since last boot; SD card info; internal storage info; OS version; phone model name; and/or CPU data. With respect to data providers that require refreshing, in the preferred embodiment the disclosed system provides the ability to adjust the refresh interval.

### Additional Graphical Elements and Effects

In addition to the various graphical elements disclosed above, the Everything Widget and other embodiments of the disclosed system may utilize other graphical elements and effects, such as, for example, a see-through effect that makes the homescreen wallpaper to be visible underneath the widget; a template for multi-day weather forecasts; rounded rectangles; various polygon shapes, with options to select the number of sides; linear and radial gradients, including optional gradient angles; overlapping widgets, icons, shortcuts, and links; color selections based on remaining battery life; timestamps; displaying or applying formatting based on certain conditions, such as time, weather condition, and system toggles. In other embodiments, the various themes, homescreens, widgets, and icons described herein may be configured to react to the detected location of a user (by WiFi location, GPS, network, or other means), movement (walking, jogging, or driving), time of day, and other context. In addition, in certain embodiments of the disclosed system the device's lockscreens may also be customized, in addition to the homescreens and widgets. Lockscreen configurations may also be prepackaged into theme files.

### Theme Marketplace

In one embodiment of the present invention, an online repository of themes, also referred to as a Theme Store, or a Theme Marketplace, acts as a distribution hub for configured themes. The Themer Store or Marketplace may be accessible through an application, a URL, or other method. In certain embodiments, the Themer App may provide an option to save the theme settings, package them with the required font and graphics assets, and transmit them to the repository. This functionality may also be applied to various widgets, including the Everything Widget. The online repository may also include a backend management system used to evaluate and approve or disapprove themes, and to make the themes available for distribution. The evaluation process may be done manually or automated based on certain criteria. In other embodiments, the Themer Store or Marketplace may provide the ability for users to select specific homescreens within a theme based on their interests. In another embodiment, the Themer Store or Marketplace may determine the contents of themes based on prior user behavior and other metrics.

In another embodiment, a web-based theme designer is provided, where users may design icons, backgrounds, widgets, and configure themes. The web-based theme designer is preferably preconfigured to open and save themes in accordance with the format used by the Themer App and related widgets. The theme designer may also provide an option to ‘push’ themes directly to the Themer Store or a specific device. Similar functionality may be provided with an app on a mobile device.

### Additional Widgets

It will be understood that the systems and methods described herein, including the ability to configure widgets, save and export their configurations, providing live previews, prepackaging widgets with themes, and/or integrating them with OS data sources may be applied to other widgets. For example, the Themer App may include functionality to provide widgets for music, with the ability to control any provider of audio, such as Pandora, Spotify, Last.fm, Google Music, and others; social media, such as Facebook, Twitter, Instagram, and other platforms; email, such as Gmail, with the ability to read and search email directly from a homescreen; analog and digital clocks; sports, with the ability to display scores, schedules, standings, and other information; messaging, such as SMS and MMS; search, with the ability to use different search providers; gallery; commercial deals; stocks; various system on/off toggles; note taking; and blogs and other information providers.

### Theme Conversion

Certain embodiments of the disclosed system may include a theme conversion tool, which may be used to automatically convert themes prepared for use on a specific device or screen size to use on a different device or screen. In one such embodiment, the theme conversion tool may adjust the margins, icon size, color, resolution, and other aspects of themes, icons, and widgets. The theme conversion tool may be integrated into the Themer App, Themer Store/Marketplace, a web-based interface, or may be provided as a stand-alone application.

### Configuration

In the preferred embodiment, settings for the disclosed system, including the Themer App and the Everything Widget embodiments, are stored as configuration files. The configuration files are preferably structured files, but may in certain embodiments be machine readable objects. Sample configuration files are provided as Appendices A and B to this specification. The provided appendices should not be construed as limiting the disclosed invention. Rather, the appendices are provided as examples of various embodiments of the disclosed systems and methods.

Appendix A is a sample configuration file for one embodiment of the Themer App. The configuration file in Appendix A is provided as a structured XML file, including settings for launcher application preferences, launcher user interface settings, launcher shortcuts settings, database schema, and exported widget configuration files. When applied to a device running a mobile operating system such as Android, certain portions of the settings may be stored in the OS Preferences, the SQLite database, or as separate xml files.

Appendix B is a sample configuration file for one embodiment of the Everything Widget. The configuration file in Appendix B is provided as a structured JavaScript Object Notation (“JSON”) file, with a preamble describing possible storage locations and examples of folder contents for the widget. One of ordinary skill in the art will recognize that Appendices A and B are not meant as exclusive depictions of configuration files for the disclosed system, and that numerous other configuration settings and configuration arrangements are possible.

The foregoing description of the various and preferred embodiments of the present invention has been presented for purposes of illustration and explanation. It is not intended to be exhaustive nor to limit the invention to the specifically disclosed embodiments. The embodiments herein were chosen and described in order to explain the principles of the invention and its practical applications, thereby enabling others skilled in the art to understand and practice the invention. However, many modifications and variations will be apparent to those skilled in the art, and are intended to fall within the scope of the invention.

What is claimed is:

1. A method for managing graphical user interfaces on a mobile device, the method comprising:
providing a user with an interface configured to select a graphical user interface theme;
receiving a selection of a graphical user interface theme from a user;
accessing one or more data objects comprising the selected graphical user interface theme, wherein the selected graphical user interface theme comprises a widget and a background image; and
applying the graphical user interface theme to the mobile device.

2. The method of claim 1, further comprising:
accessing an online repository of graphical user interface themes.

3. The method of claim 2, further comprising:
providing a preview of one or more graphical user interface themes to a user.

4. The method of claim 3, wherein the one or more data objects are packaged into a single computer file.

5. The method of claim 4, further comprising:
extracting data files corresponding to the selected graphical user interface theme from the single computer file.

6. The method of claim 1, further comprising:
providing a widget customization screen, wherein the widget remains visible while the widget is being customized.

7. A method for generating customized graphical user interfaces on mobile devices, the method comprising:
receiving user input to create a graphical user interface theme;
receiving user input to include one or more visual data objects into the theme;
providing a user with one or more graphical user interface theme customization screens;
receiving one or more user customization requests for the graphical user interface theme;
applying the one or more user customization requests;
receiving user input to store the graphical user interface;
generating a graphical user interface theme package; and
storing the graphical user interface theme package in a computer memory.

8. The method of claim 7, wherein the one or more visual data objects comprises a widget.

9. The method of claim 8, further comprising:
presenting the user with a widget customization interface, wherein the widget remains visible while the user is presented with the widget customization interface.

10. The method of claim 7, further comprising:
transmitting the graphical user interface theme package to an online repository.

11. A method for enabling customization of a graphical user interface on a mobile device, the method comprising:
receiving a user command to add a widget to an interface screen on the mobile device;
generating a widget on the interface screen;
receiving a user command to customize the widget; and
presenting the user with a widget customization interface, wherein the interface screen and the widget remain visible while the user is presented with the widget customization interface.

12. The method of claim 11, wherein the widget remains visible with a 1:1 aspect ratio as compared to its appearance without the customization interface.

13. The method of claim 11, wherein the widget customization interface is movable on the display of the mobile device.

14. The method of claim 11, wherein the widget customization interface is a graphical overlay.

15. The method of claim 14, further comprising:
adjusting visual parameters of the widget in response to user interaction with the widget customization interface.

16. The method of claim 15, further comprising:
displaying visual transitions corresponding to the adjusting visual parameters in real time.

17. The method of claim 14, further comprising:
adjusting information displayed by the widget in response to user interaction with the widget customization interface.

18. The method of claim 11, further comprising:
accessing information provided by the mobile device's operating system; and
presenting the information on the widget.

19. The method of claim 18, further comprising:
providing an area on the widget that is responsive to user interaction.

20. The method of claim 19, wherein the responsive area on the widget is smaller than the area of the entire widget.
